(19) United States
(12) Patent Application Publication
(10) Pub. No.: US 2005/0031137 A1
(43) Pub. Date: Feb. 10, 2005

(54) Calibration of an actuator

(75) Inventors: Raymond Browning, San Carlos, CA (US); George Anwar, Hercules, CA (US); Shahar Ben-Menahem, Menlo Park, CA (US); Ali Jabbari, Oakland, CA (US); Lawrence A. Leske, Belmont, CA (US); Hakim M. Mesiwala, Cupertino, CA (US)

Correspondence Address: David W. Heid;MacPHERSON KWOK CHEN & HEID LLP, Suite 226, 1762 Technology Drive, San Jose, CA, 95110, US

(73) Assignee: Tymphany Corporation

(21) Appl. No.: 10/638,198

(22) Filed: Aug. 7, 2003

(51) Int. Cl. H04R 29/00; H04R 3/00; H04R 1/00

(52) U.S. Cl. 381/96; 381/59; 381/400

(57) ABSTRACT

Control system for devices such as an audio reproduction system, an actuator device, an electromechanical device and a telephony device. The system includes control circuitry which receives an input signal and a signal indicative of a position of a portion of the controlled apparatus. The control circuit provides an output signal to the controlled apparatus to affect an operation of the controlled apparatus. The output signal provides control of the apparatus to compensate for one or more of: motor factor; spring factor; back electromotive force; and impedance of a coil in a driver of the controlled apparatus. The signal indicative of position is derived by one or more position indicator techniques such as an infrared LED and PIN diode combination, position dependent capacitance of one portion of the controlled apparatus with respect to another portion of the controlled apparatus, and impedance of a coil in the controlled apparatus. The control circuitry is configurable to control transconductance and/or transduction of the system being controlled. A technique is disclosed to detect and measure a cant of a voice coil transducer, the technique including measuring a capacitance between one portion of the voice coil transducer with respect to another portion of the voice coil transducer over a range of movement of the voice coil during operation.

### COMPUTER PROGRAM LISTING APPENDIX

The computer program listing appendix attached hereto consists of two (2) identical compact disks, copy 1 and copy 2, each containing a listing of the software code for embodiments of components of this invention. Each compact disk contains the following files (date and time of creation, size in bytes, filename):

Directory of D:\

| | | | |
|---|---|---|---|
| 05/30/2003 | 09:09 AM | 1,188 | 0711115B.txt |
| 05/30/2003 | 09:11 AM | 7,671 | 0711115C.txt |
| 05/30/2003 | 09:12 AM | 1,021 | 0711115D.txt |
| 05/30/2003 | 09:18 AM | 1,361 | 0711115E.txt |
| 05/30/2003 | 09:19 AM | 335 | 0711115F.txt |
| 05/30/2003 | 09:20 AM | 649 | 0711115G.txt |
| 05/30/2003 | 09:08 AM | 3,989 | 071115A.txt |
| 05/30/2003 | 09:05 AM | 38,253 | 071119.txt |

| | |
|---|---|
| 8 File(s) | 54,467 bytes |
| 0 Dir(s) | 0 bytes free |

The contents of the compact disk are a part of the present disclosure, and are incorporated by reference herein in their entireties.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates generally to audio reproduction systems, and more particularly to an integrated system and methods for controlling the processes in the system.

### BACKGROUND OF THE INVENTION

Audio reproduction systems are used in a variety of applications including radio receivers, stereo equipment, speakerphone systems, and a number of other environments. Audio reproduction systems take signals representing audio information and convert them to sound waves. It is important to control the processes in the system so that the sound provided is of high quality, that is to say, as close as possible to the original sound source. FIG. 1 is a block diagram illustrating a typical audio reproduction system 100. As is seen in step 101, an electrical audio signal, which may be digital or analog, is provided to a signal analysis shaping system 102. In a conventional system, signal analysis shaping system 102 is based on a speaker enclosure and a preference model. Thereafter, a modified version of the analog signal 103 is provided to a power switch or switches 104 that activate a transducer 105 contained in the speaker enclosure 106. In a conventional speaker assembly, there are generally a plurality of transducers which are typically voice coil transducers. Transducers are also commonly referred to as drivers. However, many types of devices can be utilized as transducers in a speaker system. A conventional signal processing system also provides for standard audio amplification.

Signal analysis shaping system 102 can be described functionally as illustrated in FIG. 2, which is a flow chart thereof for standard audio amplification. The input signal, which may be in either analog or digital format, is provided to the signal processing system via step 201. The signal is adjusted to correct for speaker enclosure effects, via step 202. This may comprise correctional adjustments for frequency response due to resonances, anti-resonances and phase errors created in multi-transducer systems within speaker enclosures.

Conventional approaches may also include correctional adjustments of frequency response due to resonances, anti-resonances and phase errors arising from room and environmental distortions, which is accomplished in step 203. For example, adjustments may involve de-peaking of resonances to try to flatten the frequency response.

Conventionally the input signal is also adjusted for user preferences, in terms of frequency amplitude adjustment, which is accomplished in step 204. Finally, step 205 may be performed, in which the input signal may be adjusted for each transducer of the speaker system, for example, sending only the high frequency signal to the tweeter, and the low frequencies to the woofer or subwoofers. Following the completion of all correctional adjustments, the signal is sent to an output amplifier in step 206.

A problem with the foregoing system is that there are frequency dependent errors as well as phase dependent errors which are not corrected, as well as errors due to the non-linear distortion of the transducer which reduce the effectiveness of the other corrections.

FIG. 3 is an illustration of a typical voice coil transducer 300. The frame 301 holds the cone, or diaphragm 302. The diaphragm 302 is acted upon by voice coil 303 which acts as a motor, causing the diaphragm 302 to vibrate and create pressure waves in the ambient air. Voice coil 303 is comprised of a coil of wire wound around a tube or former. Voice coil 303 receives an electrical current, which is acted upon by the static magnetic field developed by the permanent magnet 304 and iron assembly 305 in the annular gap 306 in which voice coil 303 rides. The additional magnetic field from voice coil 303, which is induced by the external current driven through voice coil 303, interacts with the static magnetic field due to the permanent magnet 304 and iron assembly 305 within the annular gap 306, causing the voice coil 303 to move forward (toward the listener, to the right in FIG. 3) or backward (away from listener, to the left in FIG. 3). Two concentric springs, the spider 307 and surround 308, provide suspension for the voice coil/diaphragm assembly, holding it in place in a concentric position and pulling it back to an equilibrium position when there is no signal applied to voice coil 303. A dome 309 acts as a dust cap and as a diffuser for high frequency sound.

There are a number of causes of audio distortion which involve the structure and operation of the voice coil transducer 300. At high signal levels, voice coil transducers become very distorting. This distortion is largely caused by the nonlinearities in the coil motor factor, in the restoring force of the coil/diaphragm assembly suspension, and the impedance of the coil. Other nonlinear effects also contribute to the distortion. Nonlinear effects are an intrinsic part of the design of voice coil transducers.

Nonlinearities in the motor factor in a voice coil transducer result from the fact that the coil and the region of uniform static magnetic field are limited in size, coupled with the fact that the coil moves relative to the static field. The actual size of the static magnetic field region, and its size relative to the voice coil, represent engineering and economic compromises. For a voice coil in a transducer, a stronger field results in a larger motor factor, and hence a larger motive force per given coil current magnitude. As the field falls off away from the annular gap 306, the motive force is reduced. The motive force per unit coil current is defined as the motor factor, and depends on the geometry of the coil and on the shape and position of the coil with respect to the static magnetic field configuration, the latter being generated by the permanent magnet or magnets and guided by the magnetic pole structures. This motor factor is usually denoted as the Bl factor, and is a function of x, the outward displacement of the coil/diaphragm assembly away from its equilibrium position (which the transducer relaxes to after the driving audio signal ceases). We adopt the common sign convention, according to which x is positive when the coil/diaphragm assembly is displaced from equilibrium in the direction of the listener, i.e. towards the front of the speaker.

FIG. 4 represents data for actual large signal (LS) parameters of a transducer from a small desktop stereo system, model name: Spin70, manufactured by Labtec. The large signal parameters shown in FIG. 4 were obtained using a commercially available laser metrology system (Klippel GMBH). The magnitude of Bl is shown by curve 401 as a function of the displacement x of the coil/diaphragm assembly from the no-signal equilibrium position, which is indicated in FIG. 4 by a zero on the horizontal axis; at that position, no elastic restoring force is applied to the coil/diaphragm assembly. The unit for Bl is Newton/Ampere (or N/A). The highly non-constant nature of the Bl factors of commercial voice coil transducers is recognized in the current art. As the audio signal increases in magnitude, the coil tends to move away from the region of maximal static magnetic field, and the motor factor decreases, thus effecting a less uniform coil movement and distorting the sound wave.

Referring to FIG. 3, as pointed out above, the cone suspension is axially symmetric and typically includes two parts: a corrugated suspension near the coil, typically referred to as the spider 307, and the surround 308 connecting the large end of cone 302 to the frame 301 of the speaker. These two suspensions together act as an effective spring, which provides a restoring force to the coil/diaphragm assembly and determines the equilibrium position of the assembly to which it relaxes when not being driven. This effective spring restoring force is again a highly non-constant function of coil/cone axial position x; that is to say, the effective spring stiffness varies significantly as a function of x. In FIG. 4 curve 402 shows a plot of K, the spring stiffness, as a function of x for the speaker transducer mentioned above. Spring stiffness K is expressed in units of N/mm (i.e. Newtons per millimeter)

The mechanical equation of motion for the transducer can be approximated as a second order ODE (ordinary differential equation) in the position x of the coil/diaphragm assembly, treated as if it were a rigid piston. This is the electromechanical (or current-to-displacement) transduction equation:
m\ddot{x}+Rₘₛ\dot{x}+xK(x)=Bl(x)i(t) (1)

where m is the mass of the assembly plus a correction for the mass of air being moved; Rₘₛ represents the effective drag coefficient experienced by the assembly, mainly due to air back pressure and suspension friction; K(x) is the position dependent effective spring stiffness due to the elastic suspension; Bl(x) is the position dependent motor factor; and i(t) is the time dependent voice-coil current, which responds to the input audio signal and constitutes the control variable. These terms are related to the industry standard linear model (small signal) parameters—namely, the Thiele-Small parameters, which are as follows:
Mₘₛ=m is the effective mechanical mass of the driver coil/diaphragm assembly, including air load;

$${C}_{m s} = \frac{1}{K ( x )}$$
is the mechanical compliance of the driver suspension; and
Rₘₛ is the effective mechanical drag coefficient, accounting for driver losses due to friction (including viscosity) and acoustic radiation.

In the above equation, and in others used herein, \ddot{x} is used as the term for acceleration and \dot{x} is used as the term for velocity.

The second order differential equation (1) would be straightforward to solve, but for the nonlinearities in the elastic restoring force and in the motor force terms; these nonlinearities stem from the x dependence of K(x) and Bl(x), and they preclude a closed-form analytical solution in the general case. Although approximations can be made, it difficult to predict the response of a system under all conditions, and thus to create a robust control system.

Further nonlinearities arise due to other electrodynamical effects caused by the application of the audio signal to the transducer voice-coil. Typically, current is supplied to the coil by converting the audio information into a voltage, V(t), which is imposed across the terminals of the voice coil. However, the resulting coil current varies both out of phase and nonlinearly with this voltage. The phase lag arises both because the voice coil's effective impedance has a reactive component, and because the electromechanical transduction of the coil current into coil motion through the static magnetic field induces a Back-ElectroMotive Force (BEMF) voltage term in the coil circuit.

The imposed voltage gives rise to the drive (coil) current, which is determined by it via the transconductance (voltage-to-current) process, conventionally expressed by the following approximate circuit equation:

$$V ( t ) - Bl ( x ) \dot{x} = i ( t ) {R}_{e} + {L}_{e} ( x ) \frac{ⅆ i}{ⅆ t} + \frac{ⅆ {L}_{e} ( x )}{ⅆ x} i ( t ) \dot{x} \qquad ( 2 )$$

Where the BEMF is represented by the second term on the left hand side (a product of Bl(x) and coil velocity). The Ohmic resistance of the coil is Rₑ. The coil's effective inductance, Lₑ(x), is a function of x because it depends upon the instantaneous position of the coil relative to the magnetic pole structure and its airgap. In FIG. 4 curve 403 shows a typical plot of the position dependence of coil inductance Lₑ(x) at low audio frequencies. The units of Lₑ are mH (milli-Henries), and the values of Lₑ shown in curve 403 have been multiplied by a factor 10 to render the graph more readable.

Prior art includes a number of approaches for controlling the nonlinearities in audio transducers. These approaches include classic control methods based on negative feedback of a motional signal, as well as more recent methods based on system modeling and state estimation.

It may seem apparent that a negative feedback system would be advantageous for reducing the nonlinear response of a voice coil transducer, and descriptions of several examples of such feedback systems do exist. Nevertheless, none of these prior techniques appear to have made any significant impact on commercial audio practice. Such feedback systems include ones based upon signals from microphones (U.S. Pat. No. 6,122,385, U.S. Patent Application 2003/0072462A1), extra coils in the speakers (U.S. Pat. Nos. 6,104,817, 4,335,274, 4,243,839, 3,530,244 and U.S. Patent Application 2003/0072462A1), piezoelectric accelerometers (U.S. Patent Application 2002/015906 Al, U.S. Pat. Nos. 6,104,817, 5,588,065, 4,573,189) or back EMF (BEMF) (U.S. Pat. Nos. 5,542,001, 5,408,533). The key focus of these methods has been to linearize the control system by means of negative feedback, often with a large open loop gain in the drive system amplifier. However, problems with noise and stability have prevented these systems from being widely used.

Estimation methods for state observables and parameters have been recently described in several patents such as (U.S. Pat. Nos. 6,058,195, 5,815,585) and in the literature (Suykens et al. J. Audio Eng. Soc. Vol 43 no 9 1995 p 690; Schurer et al. J. Audio Eng. Soc. Vol 48 no 9 1998 p 723; Klippel J. Audio Eng. Soc. Vol 46 1998 p939).

Following the Suykens et al. approach, the state feedback law which linearizes the transduction process of equation (1), is:
u=[ψ(x)]⁻¹[−φ(x)+w] (3)
in which

$$\begin{matrix}ϕ ( x ) = - \frac{K ( x )}{m} x - \frac{{R}_{m}}{m} \dot{x} & ( 4 ) \\ ψ ( x ) = \frac{Bl ( x )}{m} & ( 5 )\end{matrix}$$

and where w is the generator or reference, and u is the current in the voice coil. Further, more complicated control equations are derived by Suykens et al. for the purpose of linearizing the transconductance dynamics governed by equation (2).

In order to be effective, however, this and similar methods require several factors that are not easily provided.

Firstly, an accurate model of the system must be provided, so that the parameters can be extracted. Secondly, the measurements of system response must be at a high rate compared to the changes in the drive input, so that parameter estimation can be of low order and thus not noisy. Thirdly, a high-speed control loop is required for accurate compensation of even quite low-frequency distortions, imposing considerable constraints on the estimation algorithms. Fourth, positional information is not easily obtainable from standard sensors such as microphones and accelerometers, because these sensors measure motional variables such as coil/diaphragm velocity or acceleration, and the integration of motional variables to estimate position is fraught with systematic errors due to changing average offsets of the coil/diaphragm from its no-drive equilibrium position.

None of the above methods have been shown to lead to a successful approach and, ipso facto, none of these methods has made a significant difference to the commercial art. Thus, control of voice-coil speaker transducers in a typical prior art application is open loop; that is to say, there is no feedback from the output signal to the amplifier to provide an error signal for correction, nor is there a control loop based on the estimated state of the system.

It is further apparent that in prior art, each step in the audio reproduction process is treated independently—by concentration on either amplifier design (drive), transducer design, or enclosure design—because there is little point in having a full-system control loop with such a large non-linear element, the transducer, running open-loop within the system.

Accordingly, there are several factors described above that significantly affect the ability to provide accurate sound from a conventional audio reproduction system. Some of the issues can be addressed by improving the circuitry through digital means; but even with the digital circuitry to handle the signal shaping, the transducer itself has significant nonlinearities that can never be addressed adequately by shaping the input signal to the transducer. Therefore, what is needed is a system that controls the transducer in such a manner that optimum linear sound is provided. Such a system should also be easy to implement, cost effective, and easily adaptable to existing systems. The present invention provides a control system for a transducer to provide linear sound, and the present invention also provides an integrated audio reproduction system.

### SUMMARY OF THE INVENTION

In accordance with the present invention, a process is provided for characterizing a control-model of a parameter of a voice coil audio transducer. The process comprises applying to the voice coil drive voltages having a plurality of magnitudes; generating data from measurements performed during the application of the drive voltages; and converting the generated data into estimates of a functional dependence of the control-model parameter with respect to one or more position-indicator transducer generalized coordinates. These generalized coordinates depend upon a position of a first portion of the transducer with respect to a second portion of the transducer.

In accordance a further aspect of the invention a process is also provided for the calibration of metrology-system measurements of a position of a first portion of a voice coil audio transducer with respect to a second portion of the voice coil audio transducer. Further with respect to corresponding measurements, a co-varying position-indicator transducer generalized coordinate is utilized. In this process, voice coil drive voltages are applied, the voltage is having a plurality of magnitudes; a first and second measurements for each of the applied voltages are made with one of the measurements being of the metrology system and the other measurement being the position-indicator generalized coordinate. The data has been generated from the first and second measurements and the generated data is converted into estimates of functional dependencies between the position-indicating generalized coordinate and a corresponding relative position value measured by the metrology system.

In another embodiment of the present invention, a process is provided for calibrating large-signal transducer-model and control-model parameters of an audio transducer. The process comprises providing a first function encoding a dependence of a large-signal parameter upon a metrology-system measurement of a position of a first portion of the audio transducer with respect to a second portion of the audio transducer. The process further includes providing a second function encoding a metrology-system measurement of the position of the first portion of the audio transducer with respect to a second portion of the audio transducer as a function of a position-indicator transducer generalized coordinate. Finally, the process is completed by deriving from the first and second functions a calibration of the large-signal parameter against the position-indicator generalized coordinate.

In another embodiment of the present invention, a process is provided for calibrating an external infrared optical position-indicating detector device for an audio transducer having a diaphragm. The process comprises illuminating a region of the diaphragm with infrared light; detecting and measuring a portion of the infrared light scattered from the diaphragm; converting the detected infrared light into a signal and calibrating the value of the signal as a function of the position of the diaphragm with respect to another portion of the audio transducer.

In a further embodiment of the present invention, a process is provided for generating polynomials encoding the approximate interpolated functional dependencies of large signal transducer-model in control-model parameters upon position-indicator generalized coordinates for an audio transducer which includes a voice coil. The process comprises providing data generated in one or more voice coil drive sweeps, and converting the data into polynomials where independent variables of each polynomial are generalized coordinates which vary with the position of a first portion of the audio transducer with respect to a second portion of the audio transducer.

In another embodiment of the present invention, a process for calibrating a spring factor of an actuator is provided. The process comprises applying a drive voltage having a first magnitude to the actuator, determining a value of a parameter which is indicative of position of the actuator after the application of the voltage of the first magnitude, applying a drive voltage of a second, different magnitude to the actuator and determining a value of a parameter which is indicative of a position of the actuator after application of the voltage of the second-different magnitude. The process may also include generating a table of values of applied voltages and corresponding parameter values. In one embodiment, the parameter value which is determined is an impedance value of a circuit parameter of the actuator. The impedance measurement may be that of an impedance of a voice coil associated with the actuator. In another embodiment, the parameter value determined is a capacitance value of a movable portion of the actuator with respect to an associated stationary portion of the actuator.

In a further embodiment of the present invention, a motor factor of an actuator is calibrated. In this process, a polynomial fit of the motor factor function for a range of movement of the actuator is generated; a ratio function of the motor factor of a rest position of the actuator and at a plurality of other positions of the actuator is generated; a polynomial fit of the results of the ratio function is generated; a plurality of voltages of differing magnitudes are applied to the actuator; and it is determined for each of the voltages a value of a parameter which is indicative of a position of the actuator while simultaneously measuring a position of the actuator.

### BRIEF DESCRIPTION OF THE DRAWINGS

Other advantages of the invention will become apparent from a study of the specification and drawings in which:

FIG. 1 is a block diagram illustrating a typical audio reproduction system;

FIG. 2 is a flow chart depicting the functionality of a signal analysis shaping system;

FIG. 3 is an illustration of a typical voice coil transducer;

FIG. 4 graphically illustrates curves of Large Signal (LS) data for the actual parameters of the transducer from a Spin70 desktop stereo system manufactured by Labtec;

FIG. 5 illustrates relationships between the main areas of the present invention, grouped under three different headings: control systems, instrumentation, and audio reproduction;

FIG. 6 is a block diagram of an audio reproduction system in accordance with the three processes identified in the context of the present invention;

FIG. 7 is a flow chart illustrating the process of feedback linearization in accordance with the present invention;

FIG. 8 is a block diagram of the main portion of a sound reproduction system, including a control system for controlling the operation of the sound reproduction system in accordance with the present invention;

FIG. 9 is a block diagram of the feedback linearization process using the control law of equation (34), which only linearizes the transduction component of the signal conditioning process, and without an electronically restored linear restoring force;

FIG. 10 is a block diagram of the feedback linearization process using the control law given by equation (38) which provides transduction corrections along with a linear spring constant (suspension stiffness) which is electronically added;

FIG. 11 is a block diagram of the feedback linearization process for the control law correcting for spring, motor factor and BEMF nonlinearities, including an electronically restored linear spring and an electronically restored contribution to the linear drag force term;

FIG. 12 is a block diagram of the feedback linearization process for the control law implementing all four corrections: spring, motor factor, BEMF and inductive, and also implementing two numerical Low Pass Filters: one between the position-indicator variable measurement and the sensor inversion, and another after the computation of the fully corrected coil voltage and before it is fed as input to the coil;

FIG. 13 illustrates a process of applying a state variable feedback law based on a plurality of measurements of one or a plurality of state variables;

FIG. 14 illustrates Power Spectrum Distribution simulation curves showing the effect of the transduction corrections (spring stiffness and motor factor correction) upon harmonic distortion for a single 100 Hz tone input, both with and without BEMF and nonlinear inductance in the physical model of the Labtec Spin 70 transducer;

FIG. 15 illustrates Power Spectrum Distribution simulation curves for a single 100 Hz tone input, showing the reduction in distortion as a function of the delay in the correction loop;

FIG. 16 illustrates waveforms of the coil/diaphragm axial position versus time in the presence of a single-tone excitation, both with and without electronically restored effective spring stiffness, showing that without such restoration the cone may drift from its equilibrium position and reach its limit of excursion;

FIG. 17 is a graph of suspension restoring force due to an electronically implemented linear spring without including the effect of the transducer motor-factor, Bl(x);

FIG. 18 is a graph of the simulated phase lag between coil voltage and coil current as function of audio frequency at low frequencies, which is almost entirely due to BEMF;

FIG. 19 illustrates the simulated power spectrum distribution curves for the two-tone (60 Hz and 3 kHz) intermodulation and harmonic distortion test for the 3″ Audax speaker transducer, showing the forest of intermodulation peaks near the 3 kHz main peak. Curves are shown for the uncorrected case with no simulated delay, as well as for the corrected case with all four feedback linearization terms and for two different values of simulated delay: 10 μsec and 50 μsec;

FIG. 20 is a block diagram of a control loop, including a digital controller, an amplifier, and a transducer with position sensor;

FIG. 21 is a flow diagram of an offline calibration process for determining S as a function of position for an audio transducer using a ramped DC-voltage drive;

FIG. 22 illustrates voltage plotted versus time for two full sweeps of the S calibration ramped DC voltage drive, including thirty-two steps of equal duration per sweep from highest to lowest or lowest to highest voltage value;

FIG. 23 is a general block diagram depicting an audio transducer with a controller;

FIG. 24 illustrates a plot of suspension stiffness K in Newtons/mm together with a plot of Bl in Newtons/amp, both of which are plotted against Lₑ for the same Labtec Spin 70 transducer data;

FIG. 25 illustrates the S parameter plotted as a function of Lₑ for the same Labtec Spin 70 transducer data;

FIG. 26 shows a curve which illustrates the variation of Lₑwith position at 43 kHz for a Labtec Spin70 transducer;

FIG. 27 and FIG. 28 illustrate, respectively, magnitude and phase parts of Bode plots of Vᵣₐₜᵢₒ for progressively larger values of Lₑ;

FIG. 29 and FIG. 30 illustrate, respectively, magnitude and phase parts of Bode plots of Vᵣₐₜᵢₒ for progressively larger values of Rₑ;

FIG. 31 is a block diagram for a circuit which, together with parameter estimation, measures transducer coil inductance via a supersonic probe tone and reference RL circuit;

FIG. 32 shows a curve illustrating the functional relation C_{parasitic}(x) for the mechanically moved, non-driven set of measurements of a speaker transducer;

FIG. 33 shows a curve which illustrates the variation of C_{parasitic} with V_{coil} for driven measurement; C_{parasitic} is measured in arbitrary units obtained using the method described in Detail 12;

FIG. 34 illustrates in cross-section a cell-phone speaker transducer;

FIG. 35 shows a cross-section of a portion of a speaker transducer and illustrates geometrical details of voice coil undergoing canting and its associated magnetic assembly;

FIG. 36 illustrates an audio transducer undergoing canting;

FIG. 37 is a cross-sectional view of a speaker transducer which includes an IR-LED diode and an associated PIN diode, mounted on the back side of an audio transducer of the type shown in FIG. 3, as part of an optical position detection system;

FIG. 38 is a block diagram showing in more detail an embodiment of the generalized control system shown in FIG. 8;

FIG. 39 is a block diagram of an embodiment of an audio reproduction system in accordance with one aspect of the present invention;

FIG. 40 illustrates a process flow used to linearize the transconductance component of the signal conditioning process and the transduction process of an audio transducer;

FIG. 41 illustrates the structure, in one embodiment, of the Software Control Program that is used both for obtaining data during calibration and for operating in normal mode;

FIG. 42 shows an overall flow diagram of a calibration of S and x versus ƒ(x);

FIG. 43 shows the details of HW and ISR operations for the S calibration in step 11504 of FIG. 115;

FIG. 44 shows a flow chart detailing the steps of mainline S calibration loop 11505;

FIG. 45 illustrates an overall flow diagram of normal mode of operation (NM, module 111104 of FIG. 41);

FIG. 46 illustrates the operations of process 11203 of FIG. 45 that are spawned as a result of enabling sampling clock and ISR in step 11202 of FIG. 112;

FIG. 47 shows a flow diagram of the ISR 11303 of FIG. 113;

FIG. 48 shows the operation of the Wait Loop and Command Parser 11204;

FIG. 49 shows a flow chart of offline preliminary curve fitting, and a subsequent reduction of the order of the polynomials, for S, x, Bl, and Lₑ as functions of xᵢᵣ=ƒ(x);

FIG. 50 shows a flow chart illustrating the details of operations performed by the DSP software in program 111208 in order to reduce the order of the approximate polynomial interpolating functions for S, x, Bl, and Lₑ as functions of xᵢᵣ for the specified rms and maximum error values, while maintaining ‘Best Fit’;

FIG. 51 shows the details of the operations within step 111305 of FIG. 50;

FIG. 52 shows a block diagram of a potential divider circuit;

FIG. 53 shows a block diagram of the Zₑ(x) detection system using the probe tone 12101;

FIG. 54 shows a block diagram of a control circuit for transducer linearization, which includes the Zₑ(x) detection circuit 12200;

FIG. 55 shows a circuit diagram of the summing circuit 12202;

FIG. 56 shows a circuit diagram of the potential divider 12203 and the high pass filter 12204;

FIG. 57 shows a circuit diagram of the full wave bridge detector circuit 12205;

FIG. 58 shows a circuit diagram of the low pass filter 12206;

FIG. 59 shows the details of the circuit of the audio amplifier 12303;

FIG. 60 shows a partial schematic and a partial block diagram of the capacitance detector and speaker arrangement, together with the DSP used for correction;

FIG. 61 shows the input from speaker 13100 and details of the oscillator circuit 13208;

FIG. 62 shows the detailed circuitry of the frequency to voltage converter 13210;

FIG. 63 shows an overall block diagram of the IR-LED method for detecting a position-indicator state variable;

FIG. 64 shows a schematic diagram of IR-LED detection circuit 14400;

FIG. 65 shows a portion near 3 kHz of the FFT power spectrum distribution of the SPL (sound pressure level) wave-pattern picked up by a microphone in the acoustic near-field, with both corrected and uncorrected spectra depicted; and

FIG. 66 shows a low-frequency portion of the same power spectrum distribution shown in FIG. 65, displaying multiple harmonics of the 60 Hz tone, with spectra depicted both with and without correction.

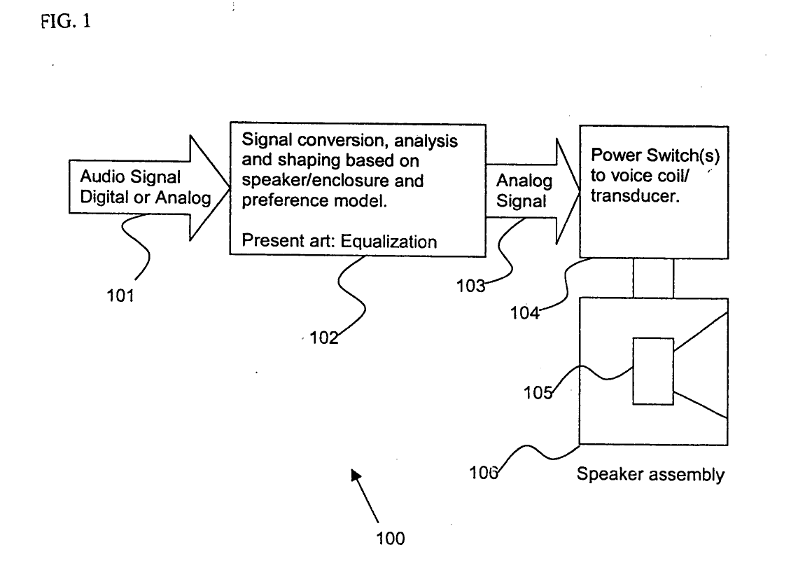

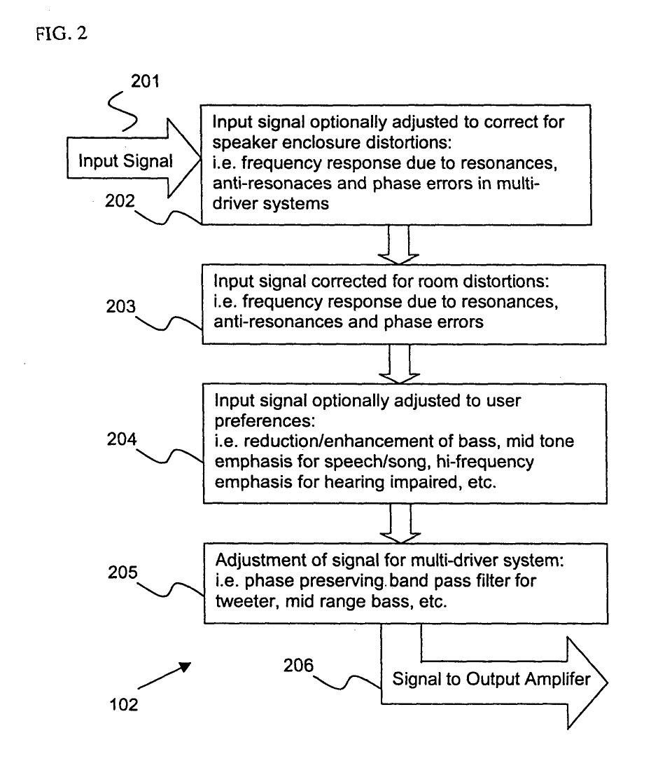

### DETAILED DESCRIPTION OF THE EMBODIMENT(S)

### Detailed Description 1

### System

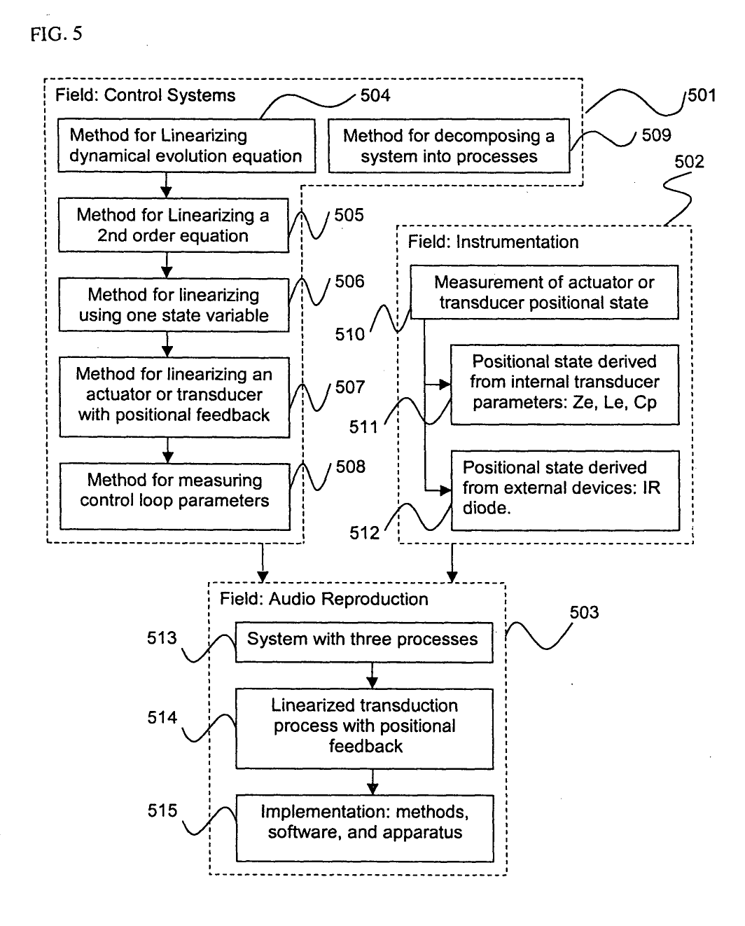

Many control engineering problems require input from several fields: mathematics, physics, systems engineering, electronic engineering, and, for this disclosure, acoustics. There are a number of key concepts developed in these different fields that were required to produce the final embodiment. The relationships between the main areas of invention are illustrated in FIG. 5. To assist understanding, the areas of invention have been grouped under three different headings: control systems engineering 501, instrumentation 502 and audio reproduction 503. FIG. 5 shows how the concepts and inventions in control engineering 501 and instrumentation 502 are linked to audio reproduction 503, and how the inventions have been reduced to practice using the audio reproduction field.

An enabling invention in the area of control engineering 501 was the linearization method for dynamical equations 504 used in modeling physical systems to be controlled, such as actuators and transducers. This method relies on finding the control equation for the non-linear part of the dynamical equation and substituting this into the full equation. The application of this method to a second order differential equation 505 shows that a non-linear second order ordinary differential equation can be linearized by solving the control equation for the non-linear first order differential equation, provided the second order and first order differential terms are linear. This is a general method for linearizing such differential equations, and covers the application to the control of all actuators and transducer systems that can be modeled in full, or in part, by such an equation. The application of the linearizing method 505 to an equation with nonlinearities dependent on one state variable 506 shows that only one state variable is required for linearization. The application of 506 relies on positional sensing. That is to say, neither the velocity, nor the acceleration, nor the instantaneous driving force state variables are required in order to linearize the process. Position dependent sensing and feedback linearization can be used with many classes of a non-linear motors and actuators.

In the present work it was discovered that there are multiple processes in a sound reproduction system, that each process can influence the performance of other process, that each process has non-linearities that must be considered in a control paradigm, and that each control paradigm must have a sufficient number of state measurements which must be measured with sufficient discrimination against noise and with sufficient speed to control the process. It was further discovered that control of one process must be stable in the presence of other processes.

Control of multiple processes with multiple control paradigms can be affected if the criteria for sufficiency is met for each control paradigm. It has been discovered that for the correction of non-linear transduction a necessary condition for control is a positional state measurement, in distinction to the motional measurements of prior art. The positional state measurement must be low-noise and of sufficient speed, or bandwidth, to effect the control while not adding unacceptable noise to, nor engendering instability in, the sound output. Multiple positional measurements can be used to estimate the positional state for the purpose of transducer linearization.

In the present invention a control system approach that is based on measurement of the state of the processes in the time domain is utilized. The sufficiency of state measurements is based on modeling and measurement of the processes. Modeling of the processes in the frequency domain can also give parameters that can be reduced to the time domain.

According to the present invention, time domain methods can be used to measure the state of the system at each instant in time, even as the system becomes very non-linear. No assumptions need be made about the relationships of the transfer function, the input and the output. The signals that are used to measure state variables can come from a plurality of sensors throughout the system. Multiple state measurements are used to estimate the state of the overall system, not just the state of the output. Then, for example, amongst other properties, the instantaneous forward transduction can be estimated from a model and a measurement of the state. Thus the measurement of signals from different parts of the system is used for modeling the system response.

The method and system comprise providing a model of at least a portion of the audio transducer system and utilizing a control engineering technique in the time domain to control an output of the audio transducer system based upon the model. In the present invention a method to determine, in real-time, the nonlinear parameters of the transducer from measurement of internal state parameters of the transducer is provided. In particular the electrical properties of the voice coil can be used as a measure of positional state and a predictor of the major non-linearities of the transducer. Real-time in this context means with sufficient bandwidth to effect control.

The present invention relates generally to an audio reproduction system. Various modifications to the embodiments and to the principles and features described herein will be readily apparent to those skilled in the art. Thus, the present invention is not intended to be limited to the embodiments shown.

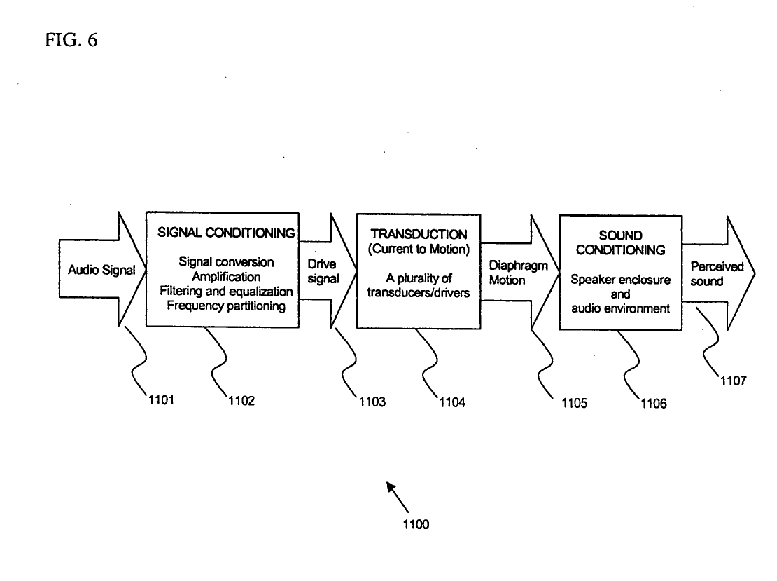

It has been discovered that in an audio reproduction system, the overall process of converting audio information into sound can be considered as consisting of three processes. First, conditioning of the audio signal to produce the transducer drive signal; second, the transduction of the drive signal into a diaphragm motion moving an air mass; and third, the conditioning of the moving air mass to provide an output sound. Thus, an audio transducer can be defined as: signal conditioning/transduction/sound conditioning. FIG. 6 illustrates a block diagram of audio reproduction system 1100 in accordance with these processes. As is seen, a signal conditioning process 1102 takes an audio signal 1101 (digital or analog) and performs signal conversion, amplification, filtering and frequency partitioning to provide a drive signal 1103. The drive signal 1103 is provided to a transduction process 1104. The transduction process 1104 typically utilizes a plurality of transducers, and results in diaphragm motion 1105 which drives an air load. A sound conditioning process 1106, which may include effects from a speaker enclosure and an extended audio environment, acts on the air load driven by the diaphragm motion 1105 to provide the perceived sound 1107.

Distorting factors due to nonlinear effects influence all of these processes. These factors arise in the relationship between the audio signal as a voltage and the drive current in the coil (transconductance), and in the electro-magneto-mechanical (henceforth abbreviated “electromechanical”) effects involving the moving-coil motor. Nonlinear effects resulting from sound conditioning are much smaller in normal operating conditions, and are thus neglected in the physical model described in this section, and in the control model based upon it and described in Detail 2. But these nonlinear acoustical effects, along with other higher-order effects described and then neglected in this section, can in principle also be linearized, via separate control laws according to the ‘modular’ approach to linearization disclosed as part of this invention.

All of the effects mentioned above vary with time and circumstances. They are nonlinear and thus distort the sound wave shape, in both amplitude and phase, relative to the input audio information. Furthermore, due to the inherently bi-directional nature of the transconductance and the electromechanical transduction, and of the coupling between them, distortions in any one process are mirrored in any of the other processes. Most importantly, it is the nonlinearities inherent in the electromechanical transduction which make the linearization and control of the overall process very difficult in prior art.

While the functional division of the overall process into sub-processes, as indicated in FIG. 6, does not correspond exactly to the just-described division into physical processes, it is shown below that the decomposition of the audio reproduction system into processes allows treatment of the different processes approximately independently, making the mathematical treatment tractable. This decomposition of the overall problem is an important part of the present invention.

In the signal conditioning process, which may be accomplished in a digital or analog form, the common method is to convert the audio signal to a voltage level, and then use this voltage to drive the impedance of the voice coil, providing current through the coil. This current then results in coil/diaphragm motion (electromechanical transduction). The signal conditioning may utilize a linear amplifier, in which one voltage signal is converted to another with greater driving power. Other options include converting the audio signal into a pulse width modulated (PWM) drive signal; thus a drive voltage is produced only during the pulse time period, thereby modulating the average current flow.

There are well-recognized nonlinearities in the drive current as function of voltage, caused by the dependence of effective coil impedance and of the motor's BEMF upon coil position relative to the magnet assembly. The effective spring stiffness of the coil/diaphragm assembly, likewise dependent on coil position, as is the motor factor, result in well-recognized sources of nonlinearity. Additionally, more gradual changes of coil impedance due to Ohmic and environmental heating cause the drive-current response to vary over time. All these effects cause power and frequency dependent distortions of the audio signal.

Further nonlinearities are introduced by various other electrodynamical effects, such as the modulation of both the airgap magnetic field and effective complex coil impedance by the coil current. The latter, the modulation of coil impedance by coil current, is caused by the nonlinear ferromagnetic response of the materials comprising the magnetic pole structures. It is also to be noted that the BEMF itself is not only dependent upon coil position, but also modulated by coil current, which introduces yet another type of nonlinearity.

Other nonlinear response effects arise when a plurality of transducers are employed to cover a wide frequency range and the drive signal is partitioned by filters into low, medium, and high frequency ranges.

The sound conditioning process includes the radiation of sound waves (pressure waves) from the diaphragm; reflections of the support and enclosure system (speaker enclosure) which generate multiple interfering pressure waves; and the effects of room acoustics, including noise, furniture, audience and other sound sources. The pressure waves present in the enclosure influence the motion of the diaphragm and the attached voice coil, thereby influencing also the signal conditioning by back-reacting upon the coil circuit. This back-reaction arises because the coil motion feeds into the BEMF, as well as into the coil impedance (through the latter's dependence upon coil position).

The three processes can be described by a mathematical model, comprising a system of coupled equations specifying the rate of change (evolution) of each of a complete set of state variables, such as coil current and coil position, at any given time, in terms of the state vector at the same and all previous times. Such equations are termed “integro-differential equations”, and are nonlinear in the case at hand. In the prior art, the model equations are usually approximated as having no “memory”, in the sense that the rates of change of state variables are taken to be wholly determined by (generally nonlinear functions of) state variables at the same instant of time; such memory-less evolution equations are simply termed “differential equations”. The mathematical model according to the present invention, however, includes memory effects, as it has been discovered that they cannot, in general, be entirely neglected in modeling the audio reproduction system.

Memory in an audio reproduction system arises from many sources, but mainly from three broad categories of effects: (i) electromagnetic effects, specifically, induced eddy currents and quasi-static hysteresis in the transducer's magnetic pole structure; (ii) acoustic effects (reflection delays and dispersion); and finally, (iii) thermal and stress effects in the magnetic structure and in the diaphragm assembly.

A nonlinear process can be very complex, and the number of terms kept in the evolution equations, as well as the decision whether or not to include memory effects, and if so which ones, can vary depending on the degree of approximation required in the control methodology. In the explanation which follows, it will be seen that simplifying the approximations to the most basic mechanisms of the three processes yields several coupled “ordinary” nonlinear differential equations. Anyone skilled in the art will appreciate that using approximations is a compromise, and that beyond a certain point, enlarging or truncating the list of modeled effects does not alter the fundamentals of the invention.

The most basic functionality of the signal conditioning process 1102 is transconductance, that is to say: the conversion of a voltage signal 1101 containing the audio information (audio program) into a current 1103 in the voice coil. For the second functional process, the transduction process 1104, the basic functionality is the conversion of coil current to diaphragm motion (or motions) 1105; this conversion includes both electrodynamic and elasto-acoustic aspects. Finally, the basic functionality of the sound conditioning process 1106 is the conversion of diaphragm motion into acoustic radiation and subsequently perceived sound 1107. This can be thought of as the acoustic side of the “elastoacoustic transduction”.

The overall sequence of the three processes, involving electromagnetic, mechanical, elastic, thermal and acoustic effects, can be modeled by a system of coupled evolution equations. In the approximation in which memory effects due to thermal, stress-related and quasi-static magnetic hysteresis are ignored, the only memory effects included in the evolution equations are those due to acoustic reflections and dispersion, as well as those due to eddy currents in the magnetic structure. Upon invoking this approximation, assuming a “rigid piston” model for the coil/diaphragm mechanical assembly, and simplifying the acoustic modeling to the most basic form recognized in prior art, the following system of coupled evolution equations is derived according to the present invention.

The main (transconductance) component of the signal-conditioning process is governed by the coil-circuit electrical equation based on Kirchoff's laws and all relevant electrodynamical effects. This circuit equation is:
V_{coil}(t)=Rₑi(t)+\dot{x}(t)Φ_{dynamic}(t)+V_{efield}(t) (6)

Where

$${Φ}_{dynamic} ( t ) = Bl ( x ( t ) ) + {\int }_{- ∞}^{t} ⅆ τ {g}_{1} ( t - τ , x ( τ ) ) i ( τ ) + {\int }_{- ∞}^{t} ⅆ {τ}_{1} {\int }_{- ∞}^{{τ}_{1}} ⅆ {τ}_{2} {g}_{2} ( t - {τ}_{1} , t - {τ}_{2} , x ( {τ}_{1} ) , x ( {τ}_{2} ) ) i ( {τ}_{1} ) i ( {τ}_{2} ) \qquad ( 7 )$$

is the motor factor due to the airgap magnetic field, including contributions from the coil current and its interaction with the magnetic pole structures, and

$${V}_{efield} ( t ) = {\int }_{- ∞}^{t} ⅆ τ {g}_{3} ( t - τ , x ( τ ) ) i ( τ ) + {\int }_{- ∞}^{t} ⅆ {τ}_{1} {\int }_{- ∞}^{{τ}_{1}} ⅆ {τ}_{2} {g}_{4} ( t - {τ}_{1} , t - {τ}_{2} , x ( {τ}_{1} ) , x ( {τ}_{2} ) ) i ( {τ}_{1} ) i ( {τ}_{2} ) \qquad ( 8 )$$

is an EMF voltage term described in more detail below.

The transduction process is governed by the mechanical equation of motion for the coil/diaphragm assembly treated as a rigid piston; including friction, acoustic loss and magnetic (Lorentz) force terms. It reads as follows:
m\ddot{x}(t)+Rₘₛ\dot{x}(t)+x(t)K(x(t))=i(t)Φ_{dynamic}(t) (9)

And finally, the acoustic transduction of diaphragm motion into pressure (sound) waves, which belongs to the sound conditioning process, is described by the following equation:

$$p ( r , t ) = \frac{1}{r} {{ρ}_{0} ( {c}_{sound} )}^{2} {\int }_{- ∞}^{t} ⅆ τ h ( t - τ - r / {c}_{sound} ) \dot{x} ( τ ) \qquad ( 10 )$$

In equations (6)-(10), t denoted the present time; τ,τ₁ and τ₂ denote past times influencing the present via memory effects; p(r,t) is the far-field air pressure wave at a distance r from the speaker, along the symmetry axis; ρ₀ and c_{sound} are the air mass density and the speed of sound in air, respectively, at standard temperature and pressure; h(t) is a dimensionless acoustic transfer function, encoding reflections in the enclosure and environment and depending on the geometry of enclosure and diaphragm assembly; V_{coil}(t) is the voltage signal connected across the voice coil; i(t) is the current in the voice coil; x(t) is the coil's axial outwards displacement relative to the mechanical equilibrium position; \dot{x}(t) is the coil/diaphragm assembly's axial outwards velocity; Rₑ is the coil's Ohmic resistance; Rₘₛ is the suspension mechanical resistance (including acoustic load); Bl(x) and K(x) are the position-dependent motor factor and suspension stiffness, respectively; \dot{x}(t)Φ_{dynamic}(t) is that part of the back-EMF due to coil motion through the airgap magnetic field; while V_{efield}(t) is the EMF due to lab-frame electric fields induced in the coil by the time-variation of magnetic flux threading through the coil's turns. The two-variable functions g₁ and g₃, as well as the four-variable functions g₂ and g₄, are determined and parameterized by detailed electromagnetic modeling, including analytic modeling and numerical simulations. These functions depend on the geometry and on the electromagnetic properties of the magnetic materials comprising the particular speaker transducer being modeled.

Most of the parameters and parameterized functions appearing in equations (6) through (11), specifically Rₑ, Rₘₛ, Bl(x), K(x), h(t) and the functions g₁ through g₄, depend on temperature, which is assumed to vary slowly as compared with timescales characterizing audio response. For the approximation to be fully self-consistent, the acoustic-load part of Rₘₛ should actually be replaced with a memory term related to h(t); the fact that a constant Rₘₛ is instead used in equation (9) is a further, non-essential approximation.

The time integrals in equations (7), (8) encode memory effects due to eddy currents, while the integral in the pressure equation (10) encodes memory effects due to acoustic reflections and dispersion. All of these integrals represent the dependence of the rate of change of state variables at any given time, upon the history (past values) of those same state variables. Although effects from the infinitely remote past are in principle included in these integrals, in practice the memory of past positions and currents fades eventually, because the audio signal is band limited.

It has been found that, while the memory effects encoded in equations (7), (8), (10) are important for modeling the dynamics of an audio reproduction system, they are second-order in the context of a distortion-correction controller.

The spectral contributions to the dynamic coil excursion x(t) are dominated by low frequencies, a fact well recognized in prior art. In consequence, it is often a reasonable approximation to replace the delayed positions x(τ), x(τ₁) and x(τ₂) in the memory integrals of equation (7)-(8) with low-order Taylor expansions about the present time (i.e. about τ=t, τ₁=t and, τ₂=t respectively.) In this way, positional memory effects are neglected; while the more important memory effects involving delayed response to current and velocity, are still included. If this further approximation is implemented, and terms quadratic and higher in coil velocity are neglected, the electromechanical and elastic parts of the above system of evolution equations, equations (6) through (9), simplify to the following form.

The coil-circuit equation (governing the transconductance component of the signal conditioning process) becomes:
V_{coil}(t)=Rₑi(t)+\dot{x}(t)Φ_{dynamic}(t)+V_{efield}(t) (11)

Where now Φ_{dynamic}(t) and V_{efield}(t) simplify to

$$\begin{matrix}{Φ}_{dynamic} ( t ) = Bl ( x ( t ) ) + {\int }_{- ∞}^{t} ⅆ τ {g}_{1} ( t - τ , x ( t ) ) i ( τ ) + {\int }_{- ∞}^{t} ⅆ {τ}_{1} {\int }_{- ∞}^{{τ}_{1}} ⅆ {τ}_{2} {g}_{2}^{( 0 )} ( t - {τ}_{1} , t - {τ}_{2} , x ( τ ) ) i ( {τ}_{1} ) i ( {τ}_{2} ) & ( 12 ) \\ and & \\ {V}_{efield} ( t ) = {\int }_{- ∞}^{t} ⅆ τ {g}_{3} ( t - τ , x ( t ) ) i ( τ ) + {\int }_{- ∞}^{t} ⅆ {τ}_{1} {\int }_{- ∞}^{{τ}_{1}} ⅆ {τ}_{2} {g}_{4}^{( 0 )} ( t - {τ}_{1} , t - {τ}_{2} , x ( t ) ) i ( {τ}_{1} ) i ( {τ}_{2} ) + {\int }_{- ∞}^{t} ⅆ τ {g}_{5} ( t - τ , x ( t ) ) \dot{x} ( τ ) i ( τ ) & ( 13 )\end{matrix}$$

respectively.

In equations (12)-(13), g₅, g₂⁽⁰⁾ and g₄⁽⁰⁾ are new two- and three-variable parameterized functions.

A further possible approximation, which is almost always assumed in prior art publications but rarely made explicit or justified, consists of ignoring the magnetic nonlinearities in the pole materials, as well as all remaining eddy-current-related memory effects in equations (7)-(8), and eddy-current losses too. These assumptions are questionable in many cases. Many speaker transducers have significant delay and loss-effects caused by eddy currents in the pole structures, and it has been found from the present work that magnetic nonlinearities cannot always be neglected, either. However, if these prior-art approximations are adopted, and if one furthermore ignores the non-uniform acoustic spectral response due to the transfer function h(t), the following set of coupled ordinary differential equations, well recognized in prior art literature, are obtained.

The coil-circuit electrical equation, governing the transconductance component of the signal conditioning process 1102 is:

$${V}_{coil} ( t ) - Bl ( x ) \dot{x} ( t ) = {R}_{e} i ( t ) + {L}_{e} ( x ) \frac{ⅆ i}{ⅆ t} + \frac{ⅆ {L}_{e} ( x )}{ⅆ x} i ( t ) \dot{x} \qquad ( 14 )$$

The mechanical equation governing the transduction process 1104 is:

$$m \ddot{x} + {R}_{m s} \dot{x} + x K ( x ) = Bl ( x ) i ( t ) + \frac{1}{2} \frac{ⅆ {L}_{e} ( x )}{ⅆ x} {i ( t )}^{2} \qquad ( 15 )$$

Also, the far-field sound wave pressure field in terms of diaphragm motion is expressed by the following equation governing the sound conditioning process 1106:

$$p ( r , t ) = \frac{1}{r} {k}_{1} \ddot{x} ( t - r / {c}_{sound} ) \qquad ( 16 )$$

Where k₁ is a constant. Since all memory and eddy-current effects have been suppressed in equations (14)-(16), parameter estimation of Lₑ(x), Rₑ and k₁ from empirical data will show that they are frequency-range dependent; and, that, furthermore, Rₑ actually depends upon x(t) since it includes the resistive counterpart to effective coil reactance Lₑ(x) caused by eddy currents.

Equation (14) is an oversimplification. As recognized in the audio industry, a transducer voice coil is characterized by a frequency dependent complex effective impedance, which we denote Zₑ(ω,x) to indicate that it also depends upon coil position; it also implicitly depends upon other, more slowly varying parameters, such as temperature. The effective coil impedance Zₑ(ω,x) characterizes one aspect of the relation between voltage signal V_{coil}(t) applied to the voice-coil circuit on the one hand, and the coil current i(t) caused by this voltage, on the other. This voltage-current relation, or functional, as it is known mathematically, is nonlinear, and furthermore involves electrodynamical memory effects (distributed delays) as described above. In general this relation can be expanded in a functional series of the type known in the literature as a Volterra series. The multivariate coefficient-functions of this Volterra series depend on coil position and motion within the magnetic-circuit airgap.

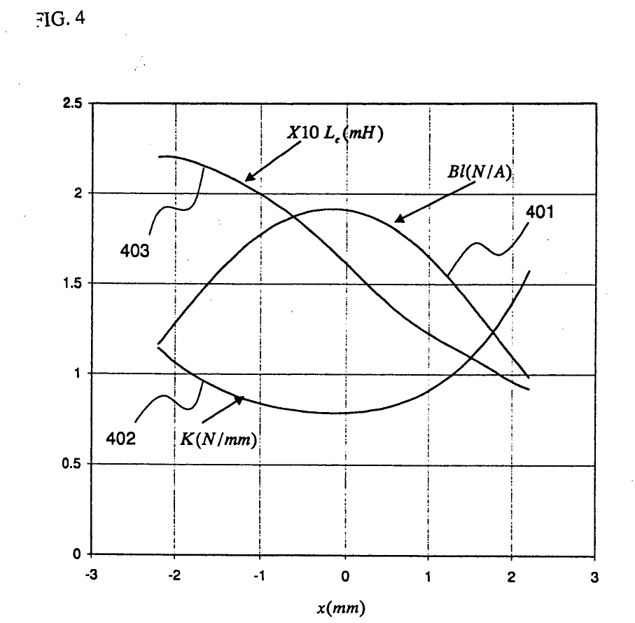

Current-nonlinear effects, i.e. deviations from linearity of the voltage-current functional, were found to be measureable. For the Labtec Spin70 speaker transducer, one of the large signal data parameters which are illustrated in FIG. 4, namely Lₑ was found to vary with i(t) as the coil neared its negative excursion. However, it was also found through modeling, simulation and measurements that current-nonlinear effects in speakers are typically small (at the few percent level), although they can become important for woofers played at high volumes. Thus, for many transducers, the full complexity of the current response i(t) to a given applied voltage V_{coil}(t) can often be usefully approximated by a linear functional relation, in which memory effects (due to eddy currents in the magnetic pole structures, and in the aluminum coil former if any) are still included. This approximate linear relation can be derived from equations (11)-(13) and is expressed as follows:

$${V}_{coil} ( t ) = {R}_{e} i ( t ) + v ( t ) Bl ( x ( t ) ) + {\int }_{- ∞}^{t} ⅆ t {g}_{3} ( t - τ , x ( t ) ) i ( τ ) \qquad ( 17 )$$

In deriving equation (17) an approximation was made, namely, only linear terms in velocity \dot{x}(t) were retained. This is a reasonable approximation for the physical regimes in which most speakers operate. In the context of the general theory presented above, equation (17) was obtained from equations (11)-(13) by dropping all EMF terms that are quadratic in the state-vector components (i(t), \dot{x}(t)).

The second (velocity dependent) term on the right hand side of equation (17) is the BEMF due to coil motion; the other two terms comprise the EMF due to the overall effective coil impedance. Within the approximation, invoked above, of a slowly changing (low frequency) position x(t), the Fourier transform of g₃ with respect to time is simply the subtracted effective coil impedance in frequency domain, i.e. the coil impedance with the Ohmic coil term subtracted. We denote this subtracted coil impedance as Z^{sub}ₑ(ω,x). More precisely, when a probe voltage signal at a typical audio (or supersonic) frequency is applied to the voice coil and the attached diaphragm is mechanically held (blocked) at a fixed position x, the effective impedance, due to the coil's inductance and its interaction with eddy currents and magnetization within the magnetic poles, is by definition Zₑ(ω,x)=Z^{sub}ₑ(ω,x)+Rₑ, where the Rₑ term is added in series and represents the coil's Ohmic resistance (see Equation (17)). Note that the subtracted impedance Z^{sub}ₑ(ω,x) has both resistive and reactive components; the former is attributable to eddy-current dissipation inside the magnetic poles (and also in the coil former, in case that is made of aluminum). The reactive component of Z^{sub}ₑ(ω,x) is known in prior art as Lₑ(x), with the frequency dependence often left implicit, as it was in equations (14)-(15) above.

The subtracted effective coil impedance Zₑ^{sub}(ω, x) is determined by the geometries of coil solenoid, metallic former (if any) and pole structure, as well as by the material composition within the magnetic structure (which includes the poles as well as one or more permanent magnets). The prior art for the most part ignores the resistive component of Zₑ^{sub}(ω, x), but the model of the present invention includes it.

For sufficiently high frequencies, and in the case of non-metallic former, the subtracted impedance Zₑ^{sub}(ω, x) arises from currents and EMF's induced in the coil and within a narrow skin layers, within the pole structures and adjacent to the coil. For a simple cylindrical geometry with infinite axial extent, Z^{sub}ₑ(ω,x) is independent of x; in that approximation, Vanderkooy [J. Vanderkooy, J. Audio Eng. Soc., Vol. 37, March 1989, pp.119-128] has shown that the (complex plane) phase angle of the subtracted impedance begins to approach an asymptotic value of 45° once the frequency increases well above the normal modes of mechanical resonances. Measurements for actual speaker transducers yield a range of possible asymptotic phase angles, both above and below this value [J. D'Appolito: “Testing Loudspeakers”, Audio Amateur Press; 1998.] For the LabTec Spin 70 speaker transducer analyzed in the present study, the asymptotic phase angle was measured to be approximately 70°, varying little with coil/diaphragm position x.

As noted above, nonlinearities (thus distortions) arise in all of the processes involved in converting audio information into a sound wave. A control system, such as the one described in the present invention, corrects for these distortions by applying a linearizing filter that predistorts the voltage V_{coil}(t) applied across the coil so that it is no longer linear with the audio program signal V_{audio}(t). It will be appreciated that a control system based on linearizing the entire process would be very complicated. The control paradigm used in accordance with the present invention seeks to simplify the control system by decomposing the overall control problem into reasonably independent modular parts, each of which controls a single process or sub-process. Any set of sub-processes which has already been controlled (i.e. linearized), is then combined with other processes, and/or with new, previously neglected terms in the physical model of the already-controlled processes. This permits designing and implementing the next-tier control module, which removes a further set of previously uncorrected nonlinearities. Such an iterative correction procedure is systematic and robust, since:

(I) At each stage of the iteration, the already-linearized processes act as a linear filter, which may be taken into account in designing the next linearizing filter; thus the design of a given control module depends on the tiers beneath it, but not on the modules in the tiers above it.

(II) Progressively smaller nonlinear effects can be corrected by applying successive new linearizing filters, and this progression of successive corrections will often converge in the sense of perturbation theory.

It should be noted that the ability to systematically apply more and more modular control tiers, can be useful even if a higher-tier correction is larger than a lower-tier one.

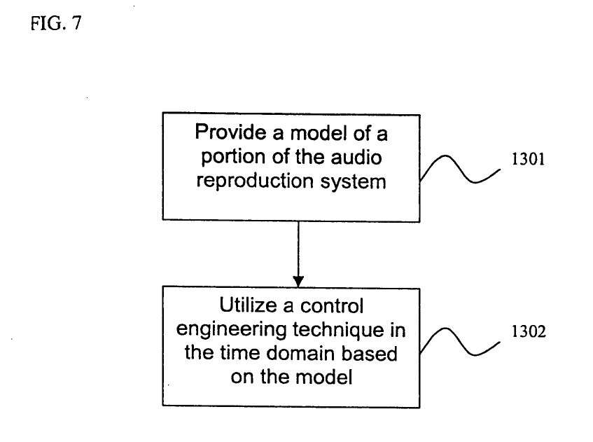

FIG. 7 is a flow chart which illustrates the process of linearization in accordance with the present invention. First, a model of a portion of the audio reproduction system is provided in step 1301. Next, a control engineering technique is utilized in the time domain to control an output of the audio transducer system based upon the model, via step 1302.

The present invention controls an audio reproduction system including all three processes shown in FIG. 6. But it is not necessary that the method and system be applied to each process, but rather, that the method be available for control as the need arises. Thus the model provided in step 1301 covers those processes that are appropriate to any particular implementation of the audio reproduction system.

It will be further appreciated that given the uncertainties in any model of a physical system, a high loop gain in any control feedback system may lead to instabilities. A feature of the present invention is that linearization is achieved by modeling using measured state variables, rather than a high-gain closed loop system for correcting an error signal.

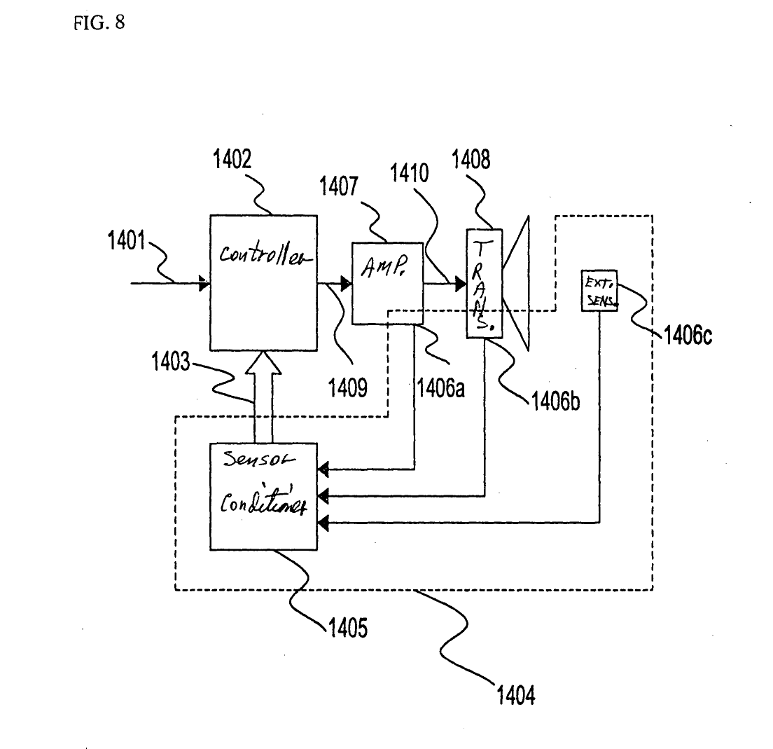

FIG. 8 is a block diagram of the main portion of a sound reproduction system and a control system for controlling the operation of the sound reproduction system in accordance with the present invention. An audio signal 1401 is input to a controller 1402, which contains algorithms based on a control model, which in turn is based on a physical model (such as the one described by equations (6)-(16) of this section) of the processes within the audio transducer system. These algorithms may be functions of state variables such as acceleration, velocity, and position of the coil/diaphragm assembly. With reference to FIG. 6, the modeled processes may include the signal conditioning process 1102, the voice coil transduction process 1104, and the sound conditioning process 1106, as discussed above. The state variables 1403 from the sound reproduction processes are input to the controller 1402 from a measurement system 1404. The measurement system 1404 consists of a sensor conditioner 1405 and a plurality of sensors, 1406a, 1406b, and 1406c, which take measurements of variables from the sound reproduction system. The sensor conditioner 1405 amplifies and converts the signals from the sensors 1406a, 1406b, and 1406c to the state variables 1403, which are provided to the controller 1402. Sensor 1406a may, for example, measure a variable such as current from the drive amplifier 1407. Sensor 1406b may, for example, measure an internal circuit parameter, such as parasitic capacitance, of the transducer 1408. Alternatively, sensor 1406b could electronically measure the impedance of one of the voice coils of transducer 1408, or it could optically measure an indicator of voice coil position. Sensor 1406c may, for example, measure a variable from the acoustic environment, such as sound pressure by using a microphone. By digitizing both the state variables 1403 and the audio signal 1401, and combining them via a DSP, the controller 1402 modifies the audio input 1401, converts it back to an analog voltage, and thus outputs a compensated analog audio signal on line 1409 to the amplifier 1407. The amplifier 1407 outputs a drive signal on line 1410 to the transducer 1408.

The audio transducer state variables which are measured and fed back to controller 1402 are generalized coordinates of the transducer dynamical system. These generalized coordinates usually vary nonlinearly with the position of the voice coil/diaphragm assembly with respect to the transducer frame, and thus, with suitable calibrations, serve to provide controller 1402 with estimates of recent values of that position. Controller 1402 then uses these real-time position estimates to suitably modify the input audio voltage signal before applying it across the voice coil. Multiple position-indicating signals can be fed to the controller, as depicted in FIG. 8; they are derived from one or more position-indicating generalized coordinates. It may be useful to measure more than one position-indicating generalized coordinates, because in some portions of the range of coil/diaphragm excursions, it could happen that a given generalized coordinate may not be a monotonic function of coil/diaphragm position, while another generalized coordinate is monotonic in that portion of the range. Thus, the advantage of measuring and feeding back values for multiple generalized coordinates, is that these coordinates may be chosen in such a way that the configuration space of their joint values is approximately a one dimensional differentiable manifold, where the coil/diaphragm position is a continuous and differentiable function on this manifold. And if each of the selected generalized coordinates is also a continuous and differentiable function of coil/diaphragm position, the mapping between a tuple of simultaneously measured generalized coordinates and the corresponding position, is both invertible and differentiable, allowing the use of the tuple to compute the audio signal modification within the controller DSP. One embodiment of this computation, based on a single generalized coordinate which is derived from infrared optical measurements, is described in detail in Detail 10.

It will be readily apparent to those skilled in the art that additional and different sensors may be utilized, and different signal conditioners may be used to recover state variables and internal parameters from the sensor signals and provide control signals to the system. Additional sensors may include, for example: accelerometers, additional transducer coils, or new coil-circuit elements. Such sensors can provide analog measurements of various voltages appearing in the transconductance equation (14), or of other voltages which allow the estimation of various terms and state variables in either equation (14) or the mechanical (transduction process) equation (15). State variables and parameters must be identified for each of the sound reproduction processes, and a sufficient set of them must be measured to effect control.

It has been discovered that measurements not usually regarded as state variables can be used effectively in controlling the audio reproduction processes. In the prior art systems, the following variables are typically considered as defining state:
x axial position of coil/diaphragm assembly,
\dot{x} axial velocity of coil/diaphragm assembly,
\ddot{x} axial acceleration of coil/diaphragm assembly
i voice-coil current.

What follows is a list of other measurable variables, among them internal parameters characterizing the processes which are considered constants in small signal analysis, as well as state variables, such as pressure, which would be externally measured (using a microphone in this case). The variables and parameters on this list can all be used in practicing the present invention. Control systems using one or more of these variables and parameters are described below. Some measurable variables can be measured by reference to other variables through known functional dependencies; for instance, temperature can be inferred from coil resistance and a lookup table. Internal parameters and other variables not listed in the above list include, for example:
V(t) voice coil voltage,
i(t) voice coil current,
Rₑ voice coil resistance,
Lₑ voice coil inductance,
Zₑ complex voice coil impedance,
C_{parasitic} voice coil/magnet parasitic capacitance,
BEMF back-EMF,
φ complex phase angle of voice coil impedance,
Tₑ voice coil temperature.

There are other internal parameters such as Bl and K, respectively the motor factor and suspension stiffness. These parameters may be difficult to measure directly, although they can be extracted from measurements of other variables via parameter estimation methods. The voice-coil voltage V(t) and voice coil current, i(t) are considered as internal variables, rather than stimuli, because the full audio transduction process according to the present invention includes creating V(t) and i(t) as internal variables.

### Detailed Description 2

### Control Model

The present invention is described in the context of controlling part of or all of an audio reproduction system using a control model. The control model is based upon the physical models for one or more of the three processes in the audio reproduction system; these processes, and physical models for their main components, were described above (Detail 1). In one embodiment, the control model is based on the physical models expressed by the electromechanical evolution equations (14) and (15), but with terms non-linear in velocity and/or current neglected. In this approximation, equations (14) and (15) become, respectively:

$${V}_{coil} ( t ) - Bl ( x ) \dot{x} = {R}_{e} i ( t ) + {L}_{e} ( x ) \frac{ⅆ i ( t )}{ⅆ t} \qquad ( 18 )$$

m\ddot{x}+Rₘₛ\dot{x}+xK(x)=Bl(x)i(t) (19)

In terms of the three processes identified in Detail 1, the electrical circuit equation (18) describes the transconductance component of the signal conditioning process; whereas the mechanical equation of motion (19) describes the transduction process.

A modular control model was developed in the context of the present invention, including separate corrections of nonlinearities in the transduction and signal-conditioning processes based on the measurement of a minimum of one position-indicator state variable during operation.

In one embodiment, an implementation of this control model removes a significant and adjustable portion of the audio distortions caused by the nonlinearities in equations (18) and (19). Furthermore, the control model removes nonlinearities in a modular way. Specifically, as described in the remainder of this section, this control model linearizes either the BEMF voltage term in the transconductance equation (18), or it linearizes the effective voice-coil inductance term in equation (18), or it linearizes the suspension stiffness and/or motor drive factor in the mechanical transduction equation (19); or it linearizes any combination of these. The particular combination of modular control laws implemented in the controller, is determined by user preferences. And all modular control laws are based upon a single state measurement of position, or of a position-indicating variable. In one embodiment of the present invention the linearizations are performed in a controller, such as that described in connection with FIG. 8.

The control model treats the motor factor Bl(x), the effective coil inductance Lₑ(x), and the suspension stiffness K(x) as functions of x(t), the current axial position of the coil/diaphragm assembly. These three functions cause most of the nonlinearities, and thus distortions, of audio transducers, as explained above. The motor factor Bl(x) determines the motive force term in equation (19) as well as the BEMF term in equation (18); Lₑ(x) determines the inductive EMF term in equation (18); while K(x) determines the elasto-acoustic restoring force in equation (19). In the context of the present invention, these three functions are derived from calibration measurements on the system, which yield the functional dependence of Bl, Lₑ and K upon x; these functions can, for instance, be obtained from commercially available transducer test equipment such as a Klippel GMBH laser metrology system. In one embodiment of this invention, the functional dependences Bl(x) and Lₑ(x) are entirely obtained from such a laser metrology system, while K(x) is obtained by combining knowledge of Bl(x) and Lₑ(x) with ramped DC-drive calibration runs, as fully described in Details 5 and 10 below.

In transducer operation, the three functions Bl(x), Lₑ(x) and K(x) must be combined with approximants to a function mapping the measured position-indicator state variable onto the actual position x, as described in Details 4,5, and 10 below, in order to provide the controller DSP with an estimate for the values of Bl, Lₑ and K(x) at the current moment t.

The controller then estimates the BEMF term by multiplying the estimated present value of Bl(x(t)) by an estimate for the present velocity \dot{x}(t); the latter may be obtained either from a numerical differentiation of the recent history of discrete position measurements, or from an independent velocity measurement. In one embodiment of the present invention, velocity is estimated via numerical differentiation of estimated position, as described in Detail 10 below. Simulations of the BEMF correction shows that it can be usefully filtered in frequency domain, as this correction has its greatest effect over a limited frequency range. Such filtering reduces the noise due to the numerical differentiation of position. Once the nonlinear BEMF term Bl(x)\dot{x} in equation (18) is thus estimated, it is corrected for by being added by the control circuit to the voltage representing the audio information. A linear BEMF term can also be calculated and subtracted from the voltage representing the audio information, in order to provide damping if required. The subtracted linear part of the BEMF is chosen such that the effect of the subtraction is to electronically add back a positive constant to the mechanical drag coefficient Rₘₛ in equation (19). This positive constant is some adjustable fraction, p, of the Thiele-Small small-signal BEMF contribution to the drag coefficient that would arise due to the equilibrium value Bl(0) without any correction. Thus, the voltage signal that is output from the control circuit to the voice coil in order to compensate for the nonlinear BEMF is:
V_{coil}=V_{audio}+(Bl(x)−p Bl(0)²/Bl(x))\dot{x} 20)

Where V_{audio} is the voltage representing the audio signal before the BEMF correction. Note that other modular corrections may be included in V_{audio}, as described below.

We next turn to describing another type of modular control law in the context of the present invention, a control law correcting for the inductive EMF term in equation (18). Like the BEMF control law described above, the inductive control law partially linearizes the transductance sub-process. Specifically, the inductive control law addresses the nonlinearity, and thus distortion, caused by the position dependence of the effective coil inductance Lₑ(x). In order to derive the inductive control law in as simple a manner as possible, the BEMF term is temporarily ignored in the transconductance equation (18); later in this section, all four of the modular control laws described in the context of this invention (BEMF, inductive, spring and motor factor) will be combined.

Since the embodiment described below for the correction of the inductive EMF term

$${L}_{e} ( x ) \frac{ⅆ i}{ⅆ t}$$

in equation (18) has no history in prior art, the derivation of this correction is presented in some detail here. For simplicity, noise is ignored in this derivation, as is the deviations of the in-operation digital signal processor (DSP) estimates for Lₑ(x(t)) from the actual values of this variable.

Beginning from equation (18) and dropping the BEMF term, the equation becomes:

$${V}_{coil} ( t ) = {R}_{e} i ( t ) + {L}_{e} ( x ) \frac{ⅆ i ( t )}{ⅆ t} \qquad ( 21 )$$

Assuming the idealized situation that the DSP has access to perfectly accurate, real time knowledge of Lₑ(x(t)) at any moment during transducer operation, a full correction for the inductive EMF term in equation (21) would result if the following corrected voltage were to be input across the voice coil:

$${V}_{coil} ( t ) = {V}_{audio} + \frac{{L}_{e} ( x )}{{R}_{e}} \frac{ⅆ {V}_{audio}}{ⅆ t} \qquad ( 22 )$$

This is mathematically demonstrated as follows. Substitution of equation (22) into equation (21) yields,

$${V}_{audio} + \frac{{L}_{e} ( x ( t ) )}{{R}_{e}} \frac{ⅆ {V}_{audio}}{ⅆ t} = {R}_{e} i ( t ) + {L}_{e} ( x ( t ) ) \frac{ⅆ i ( t )}{ⅆ t} \qquad ( 23 )$$

If V_{audio}(t), Lₑ(x) and x(t) are treated as known functions, equation (23) can be viewed as a linear first-order ordinary differential equation for the unknown function i(t). It is a well known mathematical fact that this differential equation admits a unique solution i(t) for any given causal signal V_{audio}(t), i.e. for an audio input signal that begins at some definite time in the past. The latter condition can safely be assumed, since any real-life signal is causal. On the other hand, it is easily verified by substitution that a particular solution of the differential equation (23) is given by
i(t)=V_{audio}(t)/Rₑ (24)
The combination of these two facts, namely, that equation (23) has a unique solution for the coil current in terms of the audio voltage input, and that equation (24) is a particular solution of equation (23)—completes the proof that equation (24) does in fact hold. In other words, it has been proven that the coil current i(t) is related to the audio signal V_{audio}(t) by a simple Ohm's law, without any inductive term, provided that BEMF is ignored and that the control law of equation (22) is implemented.

This demonstrates that by simply adding to the audio signal voltage a term that is the derivative of this same audio signal, multiplied by the ratio of the nonlinear inductance to the coil resistance, as done in equation (22), a correction for the effects of inductance alone can be made. In one embodiment of the present invention, the voltage differentiation on the right hand side of equation (22) is implemented numerically by the DSP, as fully described in Detail 10 below; this alone introduces additional terms on the right hand side of equation (24), thus making the elimination of the inductive term approximate, rather than exact. Furthermore, it will be appreciated from the detailed description of polynomial interpolations in the context of this invention (Detail 10 below) that the correction of the inductive effect by the physical controller, as opposed to the ideal one assumed in the above derivation, is approximate, rather than exact. This caveat would hold even were an exact, analog differentiation to be used by the controller. And it also holds for the numerical BEMF correction described above.

In the case of input to a voice coil which is used for audio reproduction, removing all the inductance as described in equations (21)-(24) might lead to an equalization problem, since the higher frequencies can be over-compensated. Thus, in one embodiment, an optional linear part of the inductance is added back to endow the audio system with a flatter frequency response. This is described in Detail 10 below.

In summary, the nonlinear effects in the transconductance equation (18) can be partially eliminated in a modular manner by the control laws given by equations (20) and (22), leaving approximately linear effects for the back-EMF and inductive EMF, respectively.

In practice, the BEMF and inductive EMF corrections have little overlap in frequency; that is to say, the BEMF has significantly lower frequency content than the inductive EMF. Therefore, the order of application of the two separate modular control laws thus far described in this section, equation (20) for BEMF and equation (22) for the inductive term, should not greatly matter in terms of amount of distortion reduction, in case the user elects to implement both of these control laws.

The correction of the nonlinear electromechanical effects in the mechanical (transduction) equation of motion (19) is based upon a derivation similar to, but different from, the standard control theory derivation of a control equation presented in the Background section above as prior art. One practical problem with the mechanical equation (19) as a starting point for a control model, is that the inertia term involves the coil/diaphragm acceleration \ddot{x}. This term increases rapidly with frequency, eventually becoming too large to be considered in a compensation system. However, because the acoustical radiation efficiency of the cone also increases with frequency, the inertia non-compensation is balanced by the radiating efficiency, within limits. This trade-off is known in prior art to result in a more or less constant output over a range of frequencies referred to as the ‘mass controlled’ range. Transducers are normally designed with this effect in mind.

By ignoring mass in equation (19), that is to say by neglecting inertial effects, the following first order differential equation is obtained:
Rₘₛ\dot{x}+xK(x)=Bl(x)i(t) (25)

In the general nonlinear state space form, equation (25) is recast thus:
\dot{x}=φ(x)+ψ(x)u(t) (26)
where,

$$ϕ ( x ) = \frac{- xK ( x )}{{R}_{ms}} , ψ ( x ) = \frac{Bl ( x )}{{R}_{ms}} \qquad ( 27 )$$

and:
u(t)=i(t) (28)

Following the feedback linearization approach, consecutive derivatives of the transducer output are taken until its input, u(t), appears in one of the derivatives. But that is already the case in equation (26), which when combined with equation (27), yields for the first derivative of coil/diaphragm position x(t):

$$\dot{x} = \frac{- xK ( x ) + Bl ( x ) u ( t )}{{R}_{ms}} \qquad ( 29 )$$

Note that the input, u(t), indeed appears explicitly in the first derivative of the position state variable, x.

The controller linearizing the transduction process should cause the transducer output \dot{x}(t) to be proportional to the audio input. Equating \dot{x}(t) with V_{audio}(t) in equation (26) and solving for u(t), and assuming that the function ψ(x) defined in (27) is nonsingular, we obtain:
u(t)=[ψ(x))]⁻¹[−φ(x)+w] (30)

where w(t) is the generator or reference (in our case the audio program input V_{audio}(t) to the uncorrected transducer), and Rₑu(t) is the actual voltage input to the voice coil in the controlled (corrected) transducer if the signal conditioning process is ignored. Substituting and rearranging terms in equations (27), (28) and (30), provides:

$$i ( t ) = \frac{xK ( x )}{Bl ( x )} + w \frac{{R}_{ms}}{Bl ( x )} \qquad ( 31 )$$

By applying this (ideal) control equation to the second order differential transduction equation (19), it is possible to see whether the latter is thereby linearized.

Substituting equation (31) into equation (19) provides:

$$m \ddot{x} + {R}_{MS} \dot{x} + K ( x ) x = Bl ( x ) [ \frac{xK ( x )}{Bl ( x )} + w \frac{{R}_{ms}}{Bl ( x )} ] \qquad ( 32 )$$

This leaves,
m\ddot{x}+Rₘₛ\dot{x}=wRₘₛ (33)

Equation (33) is a linear differential equation with constant coefficients. Note that from the above a general method of linearizing this form of nonlinear dynamical equation is presented, and any further linear terms can be added to the equation without changing the validity of the linearization approach.

Lumping the terms of the rearranged control equation (31) and using equation (28) provides the following form of the transduction control equation:
u(t)=S(x)+w(t)B(x) (34)

Where S(x) and B(x) are functions of position and w(t) is the audio information.

Equation (34) provides a correction for the open loop non-linear transfer function of the speaker transducer, provided that the dependencies of S(x) and B(x) on x are known and that real time measurements or estimates of x are made available to the controller during transducer operation.

The validity of equation (34) as a control law can be simulated when applied to a full physical model of an actual transducer. S and B can be calculated via polynomial approximants obtained from offline calibration runs, as described above.

Clearly, the control law given by equation (34) removes all restoring force due to the spring; a thus corrected transducer would not be stable. Thus a linear (non-distorting) restoring force must be subtracted from xK(x). The magnitude of the effective spring constant of this residual electronic linear restoring force, can be selected based on the required resonant frequency. This then in effect reduces the transducer operation to the linear case of zero motor factor and a linear (Hooke's law) elastic restoring force. A full description as to how this subtraction is implemented in one embodiment of the present invention, is presented in Details 5 and 10 below.

The problem of the measurement of x is independent of the validity of using any of the control laws derived above: equations (20), (22) or (34). As described in Details 4, 5, 6, 7, 8, 11, 12 and 13 below, feedback linearization control laws in the context of the present invention can use a multiplicity of sensors, from which positional information x for the coil/diaphragm assembly can be derived.

The control model of equation (34) applies only to the transduction process itself; i.e. it is based on a model of the current to velocity transduction process, and does not cover the process of injection of current into the coil (the signal conditioning process); nor does it cover the radiation of the sound waves out of the speaker enclosure into the acoustic environment (the sound conditioning process). Likewise, the control models of equations (20) and (22) above, suitably combined, eliminate or reduce only those nonlinearities arising from the transconductance component of the signal conditioning process, but do not correct either of the other two processes (transduction or sound conditioning). And all of the above control laws can, and have been, applied together, or in various partial combinations, in the context of the present invention.

This illustrates the modularity of the control approach described as part of the present invention, as discussed in Detail 1 above. Furthermore, the transduction control law of equation (34) can be subdivided into “spring correction” and “motor factor” modula units; e.g. if only the first term on the right hand side of equation (34) is used, this represents a control law which only linearizes the elastic restoring force. Thus, the number of modular control laws described by the above equations can actually be counted as four: BEMF, inductive, spring, and motor factor.

If a choice is made to simultaneously implement all of these modular corrections: the BEMF correction (equation (20)), the inductive correction (equation (22)), and the transduction corrections (equation (34)), this can for example be done as follows. The BEMF correction of equation (20) is added to the voltage given by the right-hand side of equation (34); and then the new overall voltage, u₁(t), still in the digital domain, is numerically differentiated (as described in Detail 10 below), and this numerical derivative is finally combined with u₁(t) itself in accordance with equation (22). The overall combined control model is thus as follows:
u₁(t)=S(x)+wB(x)+(Bl(x)−p Bl(0)²/Bl(x))\dot{x}(t) (35)

$$u ( t ) = {u}_{1} ( t ) + \frac{{L}_{e} ( x )}{{R}_{e}} {\dot{u}}_{1} ( t ) . \qquad ( 36 )$$

As explained above, the precise order in which the modular corrections are applied is not very important, as has in fact been demonstrated in the context of this invention.

In order to add back an effective electronic linear restoring force, as discussed above and in Detail 5, the term S(x) on the right-hand side of equation (35) must be replaced by the subtracted version,

$$S ( x ) - \frac{qxK ( 0 )}{Bl ( x )} \qquad ( 36 a )$$

where q is the fraction of the uncorrected suspension stiffness at equilibrium that is added back electronically. Thus equation (35) now becomes,

$${u}_{1} ( t ) = S ( x ) - \frac{qxK ( 0 )}{Bl ( x )} + wB ( x ) + ( Bl ( x ) - {pBl ( 0 )}^{2} / Bl ( x ) ) \dot{x} ( t ) , \qquad ( 37 )$$

while equation (36) remains unchanged.

In case a choice is made to implement only the transduction correction law, it is still necessary to perform the suspension stiffness subtraction, for stability purposes—as explained above. Thus, the full transduction control law in accordance with the present invention is the following modified version of equation (34):

$$u ( t ) = S ( x ) - \frac{qxK ( 0 )}{Bl ( x )} + wB ( x ) \qquad ( 38 )$$

One view of the control method described in this invention is that it belongs to the genre of feedback linearization controllers. The transconductance component of the signal conditioning process, and the transduction process, together may be thought of as a dynamic system with voltage input and displacement output. The dynamics of this system are governed by a physical model that can be represented as a three-state system with current, displacement, and velocity as its state variables. As seen above, despite the interactions among all processes comprising the audio reproduction system, various processes and sub-processes can be separately controlled according to this invention by applying only one of the separate basic linearization control laws encoded by equations (20), (22), and (34), or these control laws may be applied in various combinations—depending on user preferences. One option is to apply all of them, as encoded in equations (36) and (37), as well as in equations (56)-(59) in Detail 10 below.

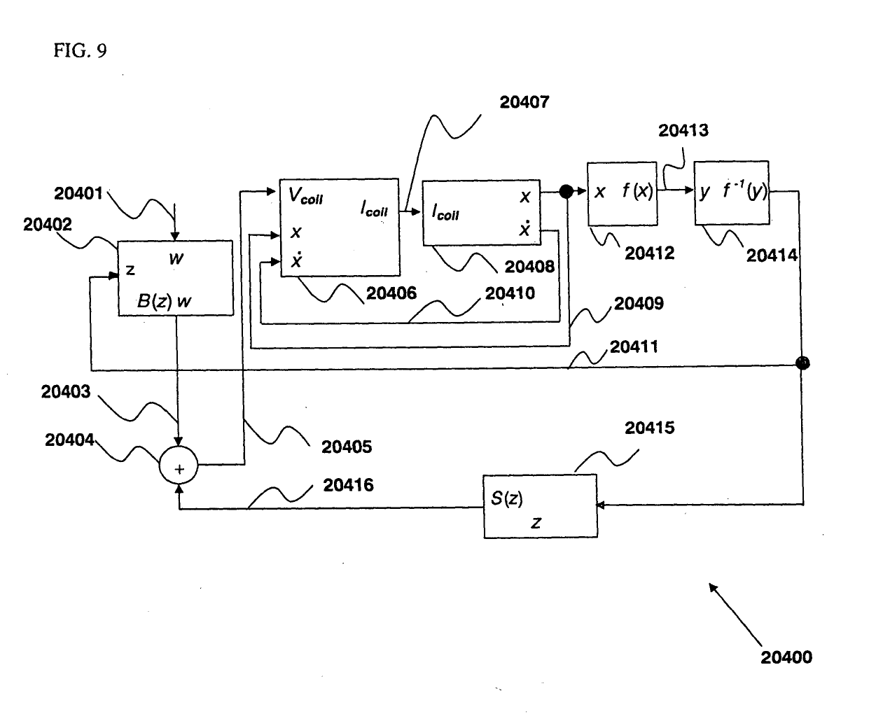

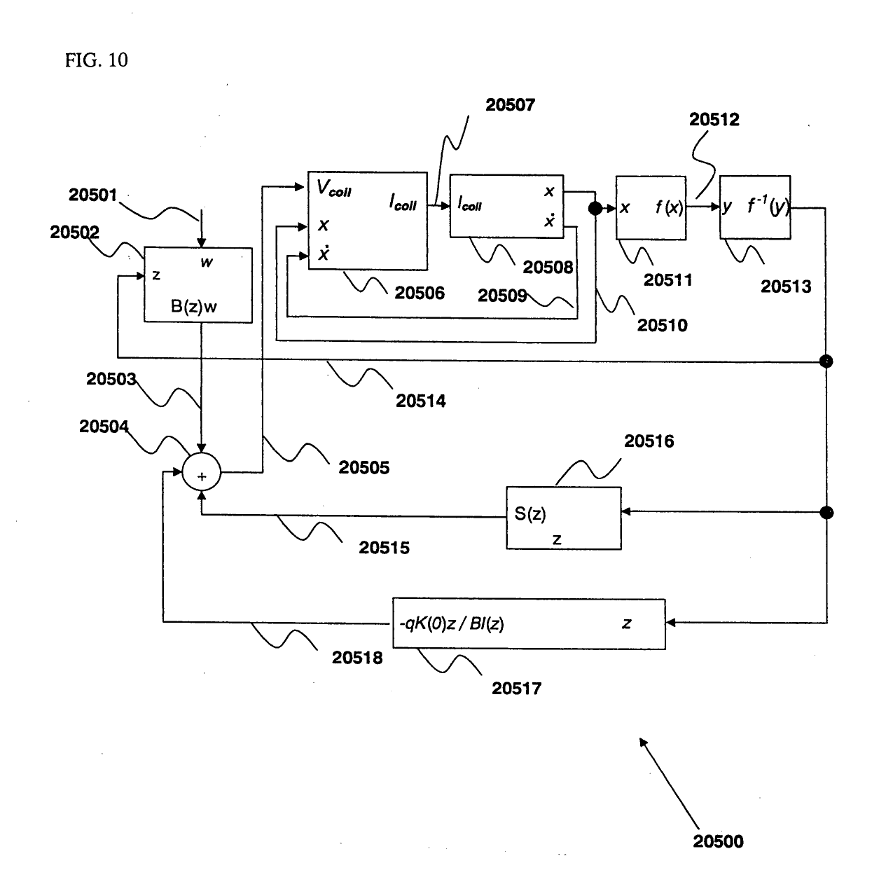

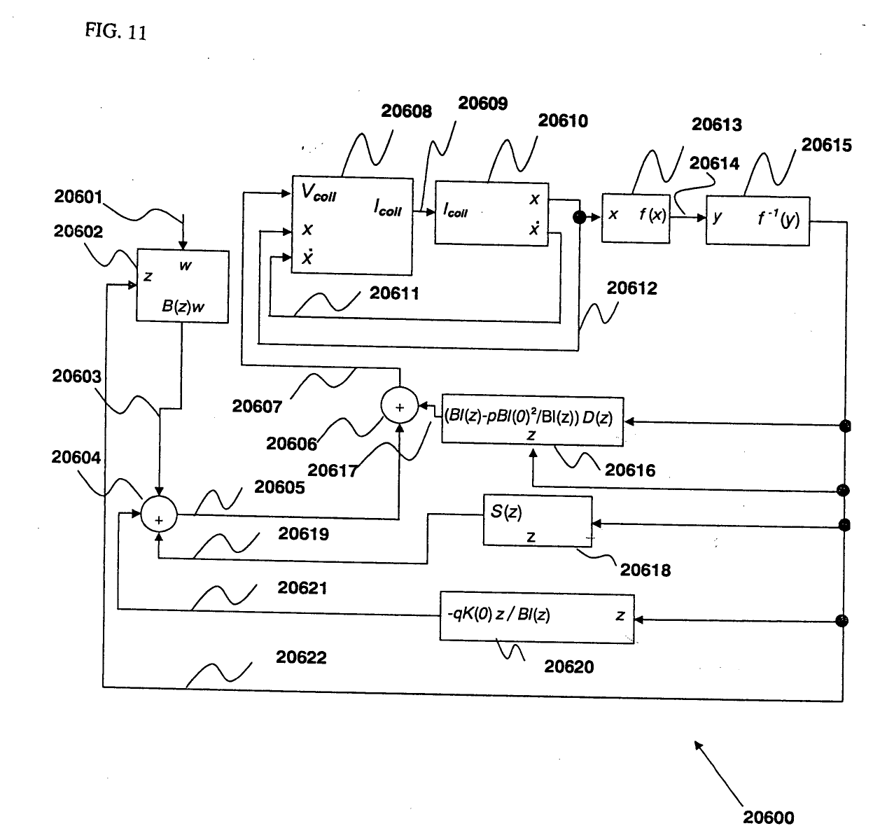

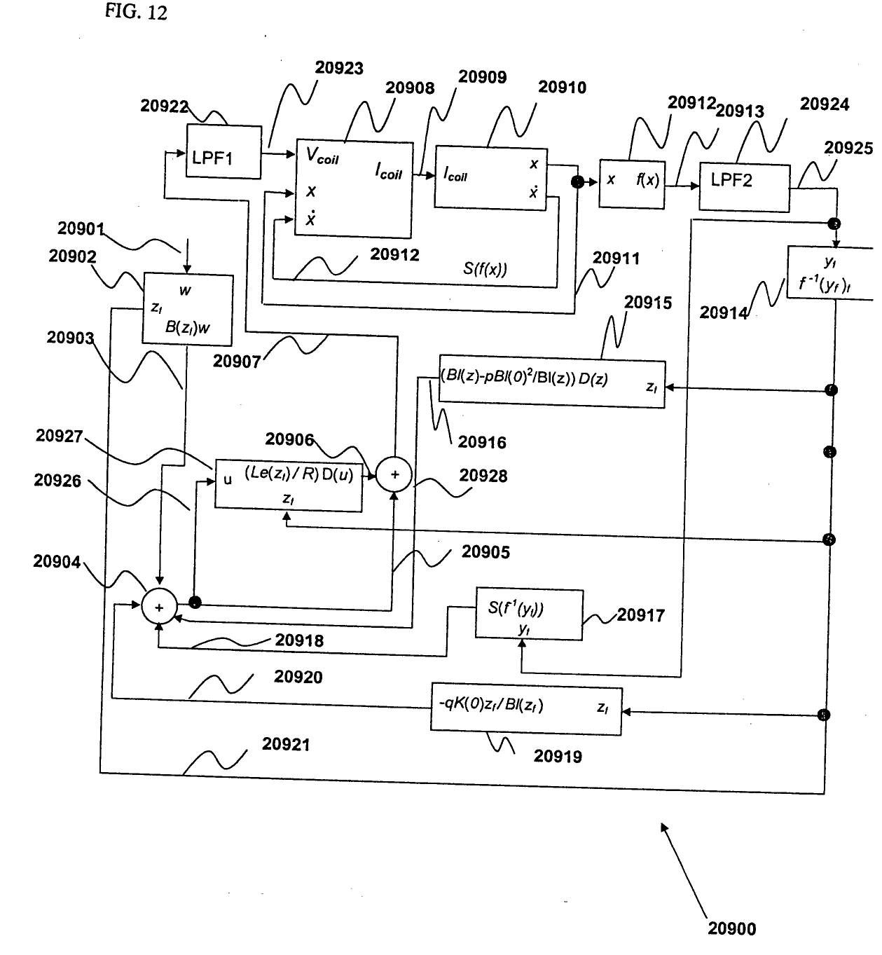

FIG. 9, FIG. 10, FIG. 11 and FIG. 12 are process block diagrams depicting the workings of various possible combinations of control laws as applied to the overall three-state system, or to parts thereof, in the context of the present invention. What follows is a detailed description of these diagrams.

FIG. 9 shows the feedback linearization process 20400 with the control law of equation (34), which only linearizes the transduction component of the signal conditioning process, without an electronically restored linear restoring force. The audio signal, V_{audio}=W 20401, is input to a Linear Compensation Process module 20402 (henceforth abbreviated as LCP). The LCP 20402 multiplies w by the compensation function B(z), where z 20411 is the estimated present value of the position variable. The present value of position variable z 20411 is obtained from the transduction module 20408 of the three-state overall transducer system, via a two step process: first the position indicator state variable ƒ(x) 20413 is measured by the positional sensor module 20412, and then the value of ƒ(x) 20413 is fed as input to a sensor inversion module 20414, which estimates actual position x via an interpolation method as described in Details 5 and 10. Actual position x 20409 and actual velocity \dot{x} 20410 are fed from the output of transduction module 20408 back into the input of the transconductance module 20406, via the physical system itself (not as measured data). The estimated x value, z 20411, is inputted to the LCP 20402 and also to an S-lookup module 20415. The output of module 20415, S(z)≈S(x) 20416, as well as the LCP output B(z)w 20403, are both fed as inputs to a summer 20404, the output 20405 of which is the corrected audio signal (V_{coil} of equation (34)). This corrected audio signal 20405 is provided as input to the transconductance module 20406 of the three-state transducer system. The current output I_{coil} 20407 of the transconductance module 20406 is provided as input to the transduction module 20408.

FIG. 10 shows the feedback linearization process 20500 for the control law given by equation (38); again only transduction corrections are made, but now a linear spring constant (suspension stiffness) is electronically added, as explained above and in Detail 5. The audio signal, V_{audio} 20501, is input to an LCP module 20502. The LCP 20502 multiplies w by the compensation function B(z), where z 20514 is the estimated current value of the position variable. Value z 20514 is obtained from the transduction module 20508 of the three-state overall transducer system, via a two step process as in FIG. 204: the positional sensor module 20511 outputs the measured position indicator state variable ƒ(x) 20512, and measured state variable ƒ(x) 20512 is fed as input to a sensor inversion module 20513, which estimates actual position x via the interpolation method. Actual position x 20510 and velocity \dot{x} 20509 are fed back from the output of the transduction module 20508 to the input of the transconductance module 20506 via the physical system itself.

The estimated x value, z 20514, is this time inputted to three modules: to the LCP 20502, to an S-lookup module 20516, and to a new ‘Electronically Restored Linear Spring’ (henceforth ERLS) module 20517. The output of module 20516, S(z)≈S(x) 20415, as well as the LCP output B(z)w 20503 and the output 20518 of the ERLS 20517, are all fed as inputs to a summer 20504, the output 20505 of which is the corrected audio signal (V_{coil} of equation (34)). The corrected audio signal 20505 is provided as input to the transconductance module 20506 of the three-state transducer system via the physical system.

FIG. 11 shows the feedback linearization process 20600 for the control law given by equation (37) alone, without the inductive correction (36); i.e. for a control law correcting for spring, motor factor and BEMF nonlinearities, including an electronically restored linear spring and electronically restored contribution to the linear drag force term, as explained above. The audio signal, V_{audio}=W 20601, is input to an LCP module 20602. The LCP 20602 multiplies w by the compensation function B(z), where z 20622 is the estimated present value of the position variable. The output B(z)w 20603 of the LCP module 20602 is provided as input to the summer 20604. Value z 20622 is obtained from the transduction module 20610 of the three-state overall transducer system, via a two step process as in the previous figures: the positional sensor module 20613 outputs the measured position indicator state variable ƒ(x) 20614, which is then fed as input to a sensor inversion module 20615. Sensor inversion module 20615 estimates actual position x via the interpolation method. And as in previous figures, the actual position x 20612 and velocity x 20611 are fed back by the actual physical system from the output of the transduction module 20610 to the input of the transduction module 20608. The estimated x value, z 20622, is now inputted to four modules: to the LCP 20602; to the S-lookup module 20618; to an ERLS module 20620; and finally, to a BEMF-computation module 20616, which applies a numerical differentiation operation D to z 20622. The output 20619 of the module 20618, as well as output 20621 of module 20620 and output 20603 of the LCP 20602, are summed in the summer 20604. The output 20605 of summer 20604, along with the output 20617 of the BEMF-computation module 20616, are provided as inputs to a second summer 20606; finally, the output 20607 of the second summer 20606 is the corrected V_{coil}, which is provided as analog input to the transconductance module 20608 of the three-state transducer system. And the analog coil current I_{coil} 20609, output by the transconductance module 20608, is provided by the physical transducer as input to the transduction module 20610.

FIG. 12 shows the feedback linearization process 20900 for the control law given by equations (36) and (37), i.e. implementing all the corrections described in this section, and also implementing two numerical Low Pass Filters: one between the position-indicator variable measurement and the sensor inversion, and another after the computation of the fully corrected coil voltage and before it is fed as input to the coil. The audio signal, V_{audio}=w 20901, is input to an LCP module 20902. The LCP module 20902 multiplies w by the compensation function B(z_{ƒ}), where z_{ƒ} 20921 is a filtered version of the estimated present value of the position variable. The output B(z)w 20903 of the LCP module 20902 is provided as input to the summer 20604. Value z_{ƒ} 20921 is obtained from the transduction module 20910 of the three-state overall transducer system, via a three step process: the positional sensor module 20912 outputs the measured position indicator state variable ƒ(x) 20913, which is then fed as input to the low pass filter LPF2 20924, the role of which is to suppress sensor noise; LPF2 would typically roll off at 1-2 kHz. The output 20925 of LPF2 20924 is fed to the sensor inversion module 20914. Sensor inversion module 20914 again estimates actual position x via the interpolation method, in the digital domain; while the actual position x 20911 and velocity x 20912 are fed via the physical transducer plant, back from the transduction module 20910 to the transconductance module 20908. The estimated x value, now called z_{ƒ} 20921, is inputted to the following three modules: to the LCP 20902, to the ERLS module 20920, and to the BEMF-computation module 20915. The S-lookup module 20917 receives its input this time from the filtered, but not inverted, positional indicator variable measurement result 20925. The outputs of the four modules 20915, 20917, 20919 and the LCP 20902, labelled respectively 20916, 20918, 20920 and 20903, are summed in the summer 20904. The output 20905 of summer 20904 is passed to an inductive-correction module 20927, which again applies a numerical differentiation operation D, this time to the numerical output voltage 20926 of the summer 20904. The output 20906 of the inductive-correction module 20927 is provided along with numerical output voltage 20926 to a second summer 20928, whose output 20907 is fed to the low pass filter LPF1 20922. The low pass filter LPF1 20922 implements a (partial) correction for the voice coil inductance at equilibrium. The output 20923 of LPF1 20922 is finally fed as the corrected analog voltage V_{coil} to the transconductance module 20908 of the three-state transducer system. As in the previous figures, the physical transducer plant provides the analog output current I_{coil} 20909, output by the transconductance module 20908, as input to the transduction module 20910.

As emphasized above, the present invention requires at least one state variable to be measured in operation for any given run. In the control diagrams depicted in FIG. 9, FIG. 10, FIG. 11 and FIG. 12, it has been assumed for convenience that only a single state variable is measured (although at least two variables, such as for example xᵢᵣ and xₗₛᵣ≈x, would need to be measured during offline calibration runs in order to derive an interpolated function ƒ(x)).

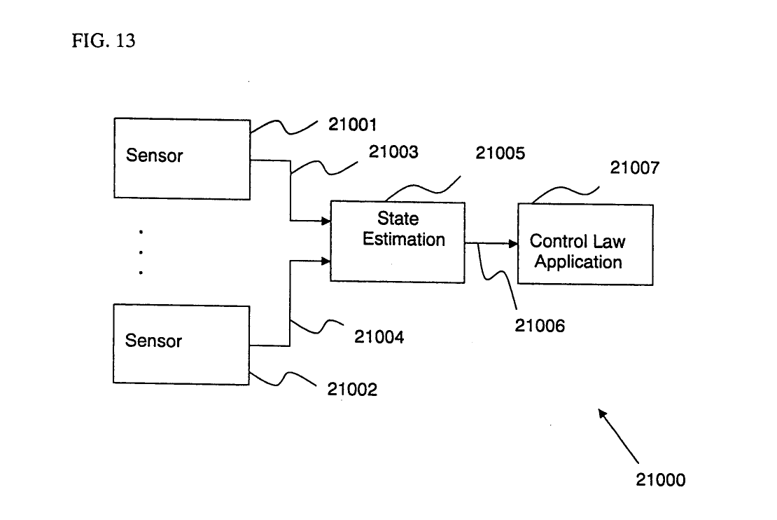

The process of applying a state variable feedback law based on a plurality of measurements of one or many state variables, is depicted in FIG. 13. The process 21000 begins with one or several measurements of a state variable or variables from a plurality of sensors, 21001 through 21002. For example a transducer's coil/diaphragm displacement, x, may be measured both via the parasitic capacitance method (Details 7 and 12 below) and the IR method (Details 8 and 13 below). The respective state variable measurement signals, 21003 through 21004, are passed from the sensors to the state estimation module 21005, which synthesizes the desired partial or full state variable estimate, 21006, which in general is a vector state variable. This state variable estimate 21006 is in turn used in the application of the control law 21007 in place of the actual state variable.

For all practical purposes, none of the sensors, 21001 through 21002, can measure its intended state variable exactly. The measurement is always corrupted to some extent by factors including nonlinearities in the measurement, measurement noise, quantization noise, systematic errors, etc. The task of the state estimation module 21005 is to mitigate these corrupting effects. This task may include all or some of the following ingredients: inverting the nonlinearities of the sensors to provide a more linear response to the measurements 21001 through 21002; adaptation to minimize the sensitivity of the state variable estimate 21006 to parametric uncertainties in the measurement, such as uncertainty in gain; filtering the measurement signals 21003 through 21004 to minimize the effects of noise; or fusing multiple measurements of a state variable into one state variable estimate 21006. In addition, many engineering objectives are taken into consideration in the design of the state estimation module 21005. The tradeoffs include such desiderata as simplicity of design, overall reduction in the effects of noise in the system, minimization of the order of the state variable estimator, and cost of implementation. For example, one possible method by which to invert the nonlinearities in any of the measurements 21001 to 21002, is via a lookup table based upon offline calibration runs; another possible method, also based upon offline calibration, is via polynomial expansion. The latter is the method used in one embodiment of the present invention, as described in Detail 10 below. Noise reduction may be accomplished by filtering, for example by using finite impulse response (FIR) or infinite impulse response (IIR) digital filters, or else analog filters. The structure of an IIR noise reduction and data fusion filter, and its coefficient values may be determined by trial and error or by analysis. For example, a positional estimation filter could be designed via Kalman filtering techniques, in which a stochastic model of the input signal and state measurement noise is combined with a model of the transconductance and transduction dynamics (such as equations (18)-(19) above) to resolve the order and coefficient values of the estimation filter. One skilled in the art will realize that various different filtering techniques can be used.

The modularity of the measurement-estimation-application approach to feedback linearization, described above, has among its objectives to make the process of measurement and estimation largely independent of the control process. Thus, the perturbation to the dynamics of the system due to the insertion of a state variable estimate into feedback laws (as opposed to the actual state variable) is minimal.

As shown above, the nonlinearities in the electromechanical equations (18) and (19), which result from the position dependence of the Lₑ(x), K(x) and Bl(x), produce a nonlinear response in the transduction output x as a functional of the voltage input V_{coil}(t). In-operation measurement of at least one position-indicator variable, together with suitable DSP computations as described above and in Detail 5 below, is used to calculate approximations to x(t), \dot{x}(t), Lₑ(x(t)), K(x(t)) and Bl(x(t)) at any given moment during transducer operation. These numbers, together with the audio program input V_{audio}(t), are then used by the controller circuit to implement a nonlinear feedback law for the transducer voltage input, V_{coil}(t), based on the physical model of the system, as described by the control models given in equations (20), (22) and (38). The overall control model obtained by combining the three control laws given by equations (20), (22) and (38), namely that given by equations (36) and (37) above, was implemented in one embodiment of the present invention; the measured power spectrum distribution for a standard two-tone test, both with the combined correction and with no correction at all, are presented for this embodiment in Detail 14 below. It is seen that the effect of this combined feedback law is to eliminate or greatly reduce the distortions of the 3″ Audax speaker transducer for which the data of Detail 14 were taken. Both intermodulation and harmonics peaks were significantly reduced.

In the course of the derivation of the control laws in this section, it was noted that the physical audio transducer parameters Lₑ(x), K(x) and Bl(x), as well as the position state variable x, are not perfectly known, and that for that reason, full correction as it appears in the equation of this section, will not in fact occur. The equations were derived assuming perfect knowledge by the controller; this was done to make the derivation of the control laws more transparent. In practice, however, these physical parameters and state variables are close estimates of their actual values. The attendant errors in modeling and measurement—both systematic and noise errors—introduce a small amount of unmodeled dynamics in the system.

It is a well known result in control theory that under certain conditions, unmodeled dynamics can lead to instabilities in a dynamical system under feedback. Care has been taken in the implementation of the feedback laws of this section to reduce the sensitivity of the electromechanical system to these unmodeled dynamics, thus preventing the possibility of dynamic instability in the electromechanical system, provided the coil/diaphragm excursion is not too high.

Anyone skilled in the art will realize that other processes and process-components can be included in the transducer physical model, in addition to the transconductance and transduction which are respectively encoded in the electric and mechanical equations (18)-(19). Examples of such additional processes are frequency partitioning and sound conditioning. These can be included in both the physical and control models, in accord with the modular approach to control modeling and implementation described in Detail 1 above. Similarly, the control models herein described can also be improved by accounting for other effects and terms within the electromechanical physical model, such as the terms that are not present in equations (18)-(19) but are present in equations (6) through (16).

### Detailed Description 3

### Justification of Approximations

A simplified physical model of a general speaker transducer, together with a modular collection of control models designed to implement linearization filters for sub-processes within he physical model, were presented in Detail 2 above. There are two ways in which these mathematical models are used in the context of the present invention: in actual physical implementation, and in simulation.

In physical implementation, the chosen collection of one or more of the four basic control laws (spring, motor factor, BEMF and inductive compensation) is implemented within DSP hardware and software, which control the transducer in order to linearize sound.

In simulation, both the physical models and the control model are simulated on a computer in order to investigate the strength and relative importance of the various audio distortions; to evaluate the justification for various simplifying approximations in the physical model; and to test the efficacy of different possible correction algorithms. Furthermore, simulations have been used to assess the importance of effects outside the physical model of the transducer itself, such as noise and delays due to the electronics.

Simulation has proven a useful guide for both hardware and software development in the context of the present invention.

As explained in Detail 1 above, there are many nonlinearities in the physical processes governing transducer operation, such as nonlinear elastic restoring force (i.e. nonlinear effective spring “constant”); nonlinear motor factor; nonlinear effective voice coil inductance; and motor BEMF, to name the most important ones. Computer simulations based upon the transducer-plus-controller model (and thus incorporating the leading nonlinear processes listed above) were used in the present work to study the effect of all of these nonlinearities, thereby elucidating the merits of implementing partial correction for a subset of the nonlinearities. For instance, it was found via simulation that transconductance nonlinearities (BEMF and inductive) are responsible for significant audio distortions at various important frequency ranges, which led to the inclusion of corrections for these effects in the control law (equations (20) and (22) above). In fact, dependent on program material, correcting for non-linear spring effects can have the consequence of increasing the excursions of the transducer coil/diaphragm assembly and thus increase the non-linear effects of BEMF and Lₑ(x). Nevertheless, it is still possible to achieve improved audio performance, especially at he low end of the audio spectrum, by correcting only for the nonlinearities in effective spring stiffness and in the motor factor. This, fact, as well, had been predicted by simulations of the model, and corroborated by experiment.

We present several few key simulation results relevant to the invention herein disclosed.

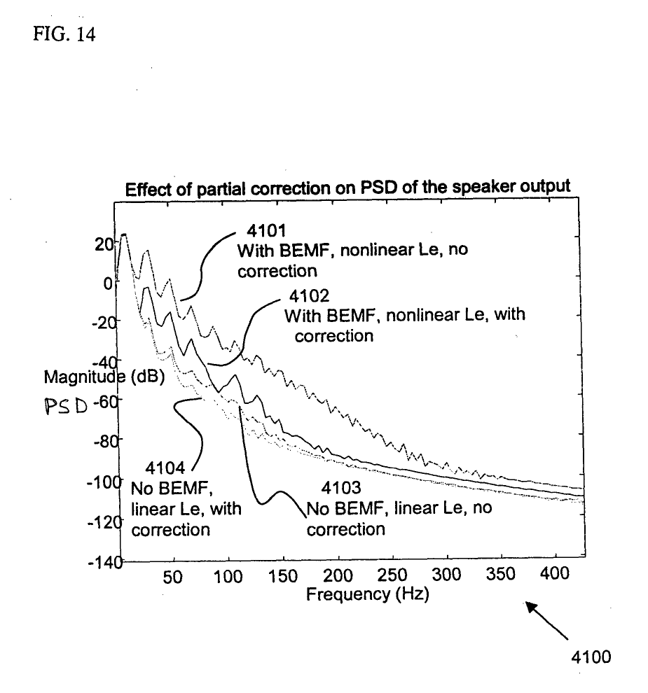

FIG. 14 shows curves 4100 of simulated Power Spectral Density (PSD) which illustrate the effect of the transduction corrections alone (spring stiffness and motor factor correction, equation (34)) both with and without BEMF and nonlinear inductance in the system. In FIG. 14 the vertical axis is a measure of PSD in relative dB units. The curves of FIG. 14 were generated by simulating the performance of a particular transducer (that of the Labtec Spin 70 speaker) using a single 100 Hz tone; each curve clearly shown that the highest power is in the fundamental 100 Hz tone, but that significant power is also present in the various harmonics of this tone. Overall, the curves of FIG. 14 shows that even at frequencies where BEMF is significant, introduction of corrections for spring and force constant greatly improve the system performance. Curve 4103 depicts the simulated PSD with no BEMF voltage term modelled, with linear (i.e. position independent) inductive EMF voltage term modelled, and with no correction incorporated in the modelling; the harmonics, and power present at non-harmonic frequencies, are an artifact of the finite time windowing used to perform the FFT (Fast Fourier Transform) in the simulation. Curve 4101 shows the PSD when the position-dependent (nonlinear) BEMF and position-dependent inductive EMF voltage terms both modelled, but still with no correction; the harmonics, as well as the general diffuse high-frequency content of the power spectrum, are seen to be enhanced by nonlinearity-caused distortions. Curve 4102, again depicting the PSD with nonlinear BEMF and nonlinear inductive EMF, but this time with transduction corrections, shows a marked decrease in harmonics and other, diffuse high-power spectral content. Finally, curve 4104 depicts the PSD with no BEMF and with linear inductive EMF, as in curve 4103, but with the difference that the transduction correction is applied.

It is inevitable that there will be some delay between measuring and reading the sensor output, and sending out the command to compensate for the position-dependent nonlinear spring stiffness and motor factor (and for any other nonlinearities for which terms are included in the controller). Using model-based simulation, it was possible to determine that the existence of this delay, while somewhat degrading the performance of the control algorithm, did not cause a significant problem, nor did it render the algorithm ineffective.

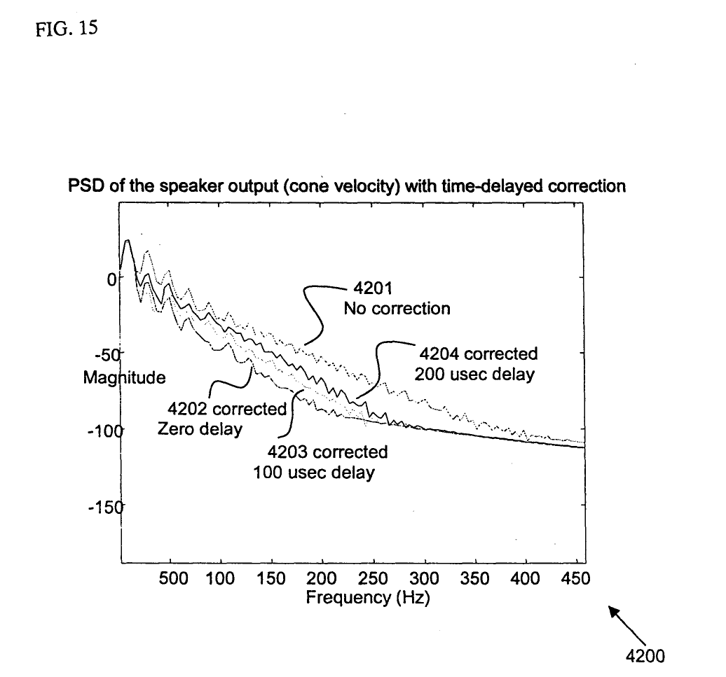

The curves of FIG. 15 illustrate the reduction in distortion as a function of the delay in the correction loop 4200. As in FIG. 14, the vertical axis is a measure of relative PSD magnitudes in dB. The curves of FIG. 15 depict the simulated PSD of the transducer-cone velocity, again for a 100 Hz audio input tone. In obtaining these simulation results, it was important to keep the amount of the nonlinearities the same for all the cases that were considered. This was achieved by suitably scaling the driving force as the time delay was varied. It is clear, from the curves of FIG. 15, that longer delays in the correction loop will increase distortion. However, for a 100 Hz tone, even at 200 μsec delay, the distortion is seen to be less than that of the uncorrected system. Curve 4201 depicts the PSD with no correction; curve 4202 depicts the PSD with (transduction) but for the ideal case of no delay; while curves 4203 and 4204 show the PSD curves with correction modelled and with simulated delays in the amounts of 100 μsec and 200 μsec, respectively.

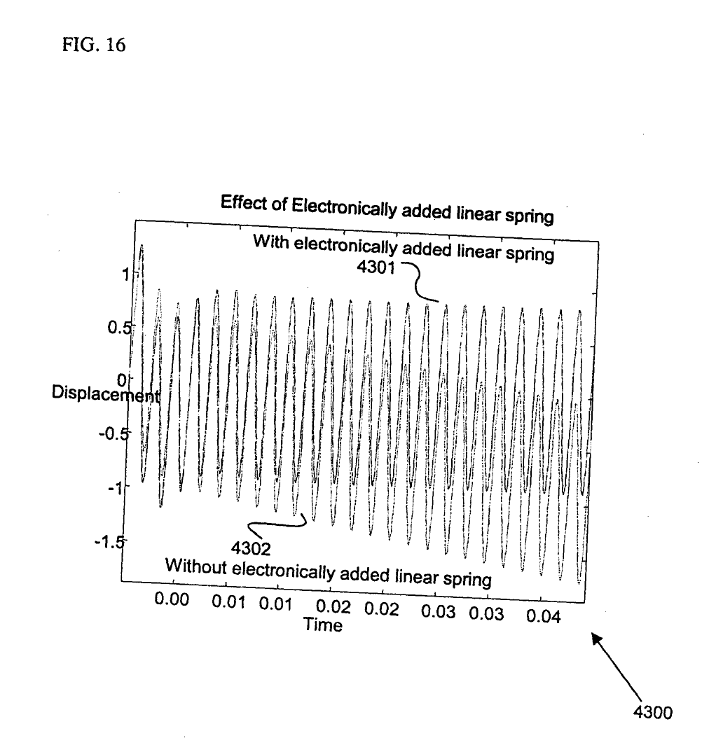

While a complete nonlinear spring cancellation will reduce the distortion in speaker's acoustic output, it will also remove the restoring force that was provided by the mechanical spring in the uncorrected speaker transducer, as discussed in Detail 2 above. In order to keep the speaker cone centered near its equilibrium position and place the mechanical resonance of the speaker at the desirable frequency, linear stiffness can be added electronically, as seen in Detail 2 above. FIG. 16 displays a plot 4300 depicting the position of cone (i.e. the axial position of the coil/diaphragm assembly) in the presence of a single-tone excitation. Without the added electronic contribution to the effective spring stiffness, the cone may drift from its equilibrium position, and may reach its limit of excursion; this is illustrated in the simulation shown in curve 4302. Curve 4301 shows the corresponding simulated time-dependent cone excursion when an electronically-added linear spring constant (suspension stiffness) is incorporated in the model.

It should be noted that the force generated by the transducer, for a given command signal, depends on the transducer motor factor. In implementing the “electronic spring” it is important to take into consideration the effect of the transducer motor constant, as explained in Detail 5.

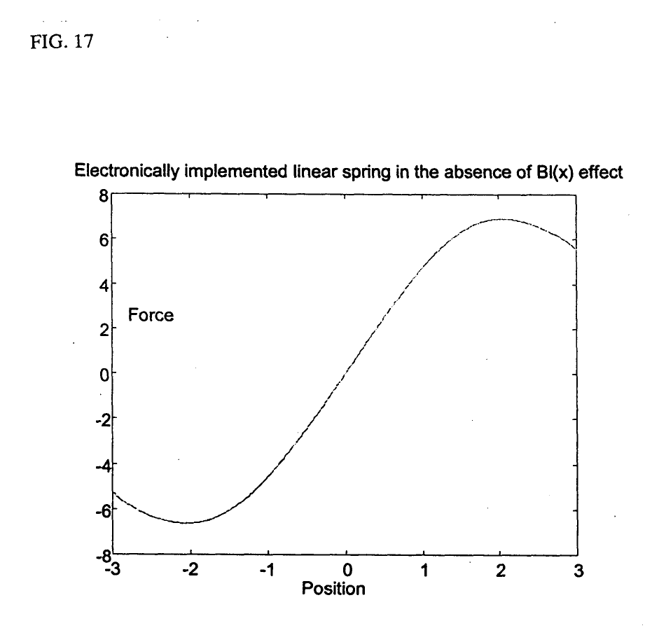

FIG. 17 shows the spring force due to an electronically implemented linear spring without including the effect of the transducer motor-factor, Bl(x).

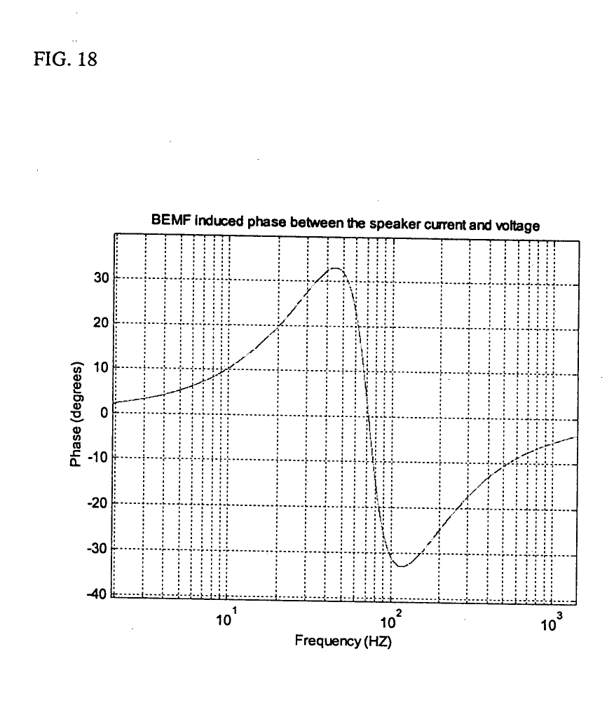

FIG. 18 depicts the simulated phase lag between coil voltage and coil current at low audio frequencies, which is almost entirely due to BEMF. At high frequencies this phase lag would be mainly due to the inductive term in the electrical circuit equation (18).

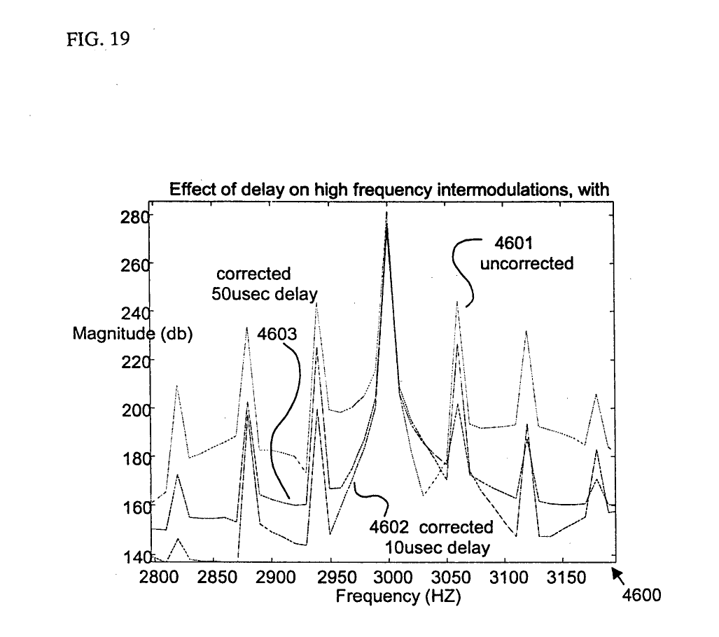

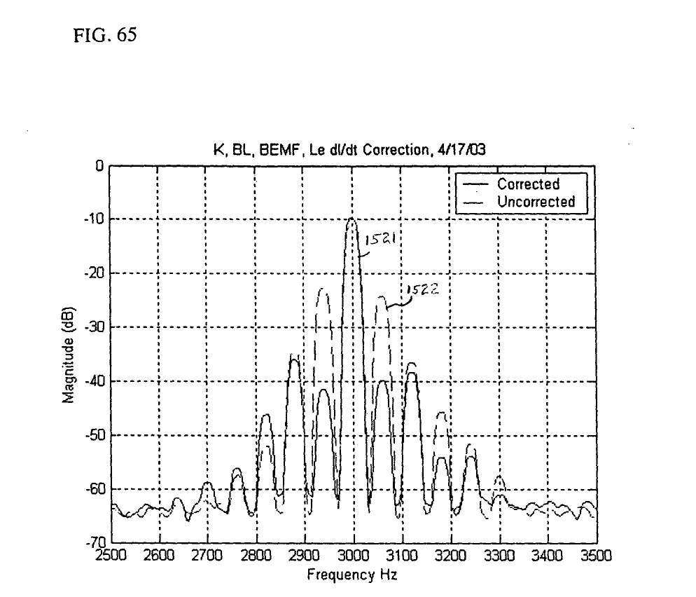

FIG. 19 is a simulated version of spectral plot results 4600 of the two-tone intermodulation and harmonic distortion test for which actual, physical implementation results are reported in Detail 14 below. The two input tones are at 60 Hz and 3 kHz, and the portion of the simulated power spectrum distributions (PSDs) shown in the curves of FIG. 19 are in the vicinity of the 3 kHz. The curves (4601 through 4603) clearly show the forest of intermodulation peaks, spaced uniformly 60 Hz apart and with decreasing power level away from the 3 kHz main peak. As is the case for the real spectrum in this frequency region (FIG. 65), the simulation shows the intermodulation peaks to be significantly suppressed when all four linearizing-filter corrections are applied (i.e. with the combined correction law given by equations (36)-(37)). But unlike in the physical implementation, it is possible to select arbitrary time delays in the simulation. Two different delay values were chosen for this simulation: 10 μsec and 50 μsec. And delays were only applied for the corrected runs. Curve 4601 shows the simulated uncorrected PSD; curve 4602 shows the dramatic intermodulation reduction when the corrections are applied, with 10 μsec simulated delay. Finally, curve 4603 shows the simulated PSD with corrections and with the longer simulated delay of 50 μsec.

It is seen that while the larger delay increases distortions, even the corrected spectrum with the higher simulated delay value is still less distorted than the uncorrected spectrum with no delay at all.

It will be clear to those skilled in the art that simulation of any particular implementation of the linearization and control methods described in this disclosure provides valuable information for practically implementing such systems for any particular application; and, furthermore, that the simulations developed here can be greatly expanded to cover many such systems and applications.

### DETAILED DESCRIPTION 4

### State Measurement Theory

The present invention is described in the context of controlling an audio reproduction system, in part, by a model requiring real time measurement of at least one position-dependent state variable of the speaker transducer. In particular, one such state variable is the axial position x of the coil/diaphragm assembly. Real-time values of the state variable x are needed during transducer operation in order to effect the linearization of the transconductance and transduction processes, as set out in Detail 2. According to the present invention, it is unnecessary to have a direct measurement of x; it suffices to measure, instead, a position-indicator state variable, i.e. a variable which varies monotonically (but, in general, nonlinearly) with x within the range of possible diaphragm excursions. Once this position-indicator nonlinear state variable ƒ(x) is calibrated against x, real time measurements of the state variable ƒ(x) can be used by the controller to effect linearization.

The position-indicating state variable ƒ(x) can be chosen from a wide range of possibilities, and to a large extent the method chosen will depend on the application, or implementation, of the audio reproduction system and the desired quality and economics.

This disclosure discusses in detail three main choices of ƒ(x) measurement techniques: an optical method using IR detection; a method using the effective impedance, or inductance, of the voice coil; and a method that uses the parasitic capacitance between the voice coil and the magnet assembly of the transducer. The above-mentioned three methods are referred to as the IR method, the Zₑ (or Lₑ) method and the C method, respectively. Again, other choices of position-indicator state variables could be made, depending on the application.

The IR method is fully described in Details 8 and 13. The Zₑ method is fully described in Details 6 and 11. The C method is fully described in Details 7 and 12. The position information derived by Zₑ and C methods is generated using internal electronic parameters of the transducer. In contrast, the IR method is based on an external measurement of position. In all cases, to be useful as stand alone position indicators the respective variables must be monotonic, but not necessarily linear, with position. It will be appreciated that there are other possible position indicators according to the present invention, which are measurable from internal electronic circuit parameters of the transducer that are not constant during transducer operation, but instead vary monotonically with x. One of ordinary skill in the art will readily recognize that there are many measurements that can be made on an audio transducer, but that K(x), Bl(x), and Lₑ(x) are commonly presented as the parameters most responsible for the nonlinearities in the operation of such a transducer. The relationship of these parameters to these nonlinearities was explained in detail in previous sections, as was the fact that Lₑ(x) also varies somewhat with frequency and depends on temperatures in the coil and within the magnet assembly.

As an example of the use of position-indicator measurements in the controller in the context of the present invention, we consider one of the sub-process linearization laws presented in Detail 2 above; namely, the transduction-process control equation (34), where the transduction parameters S and B are non-constant functions of x. Any nonlinear position-indicator state variable ƒ(x) can be substituted for x, as long as the positional related information is monotonic with x and is well behaved over the range of interest, i.e. the range of coil/diaphragm excursions in actual audio operation over which the correction is required. In other words, a nonlinear expansion in x can be replaced by a nonlinear expansion in any measurable variable that has a monotonic relationship with x over a suitable range of values. Thus, the variables S and B can be redefined as functions of xᵢᵣ, Lₑ, Zₑ or C_{parasitic}) depending on the positional-detection method selected. The control law (34) then assumes the following different forms:
i(t)=S(xᵢᵣ)+wB(xᵢᵣ) (45)
i(t)=S(Lₑ)+wB(Lₑ) (46)
i(t)=S(Zₑ)+wB(Zₑ) (47)
i(t)=S(C_{parasitic})+wB(C_{parasitic}) (48)

Thus by measuring the position-indicating parameter or state variable of choice (xᵢᵣ, Lₑ, or C_{parasitic}) during the operation of the audio transducer, and knowing the functional dependence of S and B upon that position-indicator variable, suitable correction can be effected to remove or greatly reduce the audio distortions caused by the variation of the transducer's suspension stiffness K(x) and its motor factor Bl(x) with position.

It will be appreciated that any internal electronic circuit parameter or state variable which varies monotonically with coil/diaphragm position over the operating range of excursions, can be used in the definition and determination of the S and B functions.

In accordance with the present invention, the transduction control law, equation (34), has been used to illustrate the use of nonlinear position indicators for linearization corrections. However, the same indicators can be used for some of the other corrections that can be added in a modular fashion to any particular implementation. These combinations of the modular control laws, described in the context of the present invention, are given by the control equations (20), (22), and (36)-(37) in Detail 2 above. In the case of the BEMF correction (equation (20)), the motor factor Bl(x) can be stored in the controller as a function of the nonlinear state variable ƒ(x), while the instantaneous velocity \dot{x} can be obtained not by measuring a motional state variable, but rather via numerical differentiation of the position, which in turn is obtained from ƒ(x) via the stored inverse functional relation ƒ⁻¹. All controller-stored functions, whether having the form of polynomials, look-up tables or splines, or some combination of the these, will be computed, based upon calibration or characterization of the transducer, ‘offline’; i.e. before actual transducer operation.

Similarly, for implementation of the inductive control law of equation (22), Lₑ(x) can be characterized as a function of the position-indicator variable ƒ(x), while the time derivative of the voltage can again be computed numerically.

Information from other external measurement apparata not utilized in the context of this invention, such as accelerometers, microphones, voltages from additional coils and/or additional transducers, can also be used to provide additional state variables, and thus can be used to add precision to, or reduce the noise, for positional or motional estimates.

### Detailed Description 5

### S and B Measurement Theory

The present invention is described in the context of extracting the positional state of the speaker transducer's coil/diaphragm assembly, in operation, using measured state variables, from either internal circuit parameters, or signal(s) from external position-sensitive device(s), that are variables with that position. Measurement of all the parameters required to estimate S and B (the transduction-process variables introduced in Detail 2 above) with commercially available test equipment is both time consuming and fruitless. For a viable control scheme, the parameters must be regularly updated as they are sensitive to both time and temperature changes.

Accordingly a method to measure S and B in a timely manner is described. The method used in this embodiment of the invention, and described in this section, to make the current value of B available to the controller DSP during operation, is also utilized for the electrodynamical transducer parameters Bl and Lₑ, as described in Detail 10 below. The values of Bl and Lₑ are needed by the controller in order to implement the transconductance corrections, namely the BEMF and inductance corrections respectively, as explained in Detail 2 above.

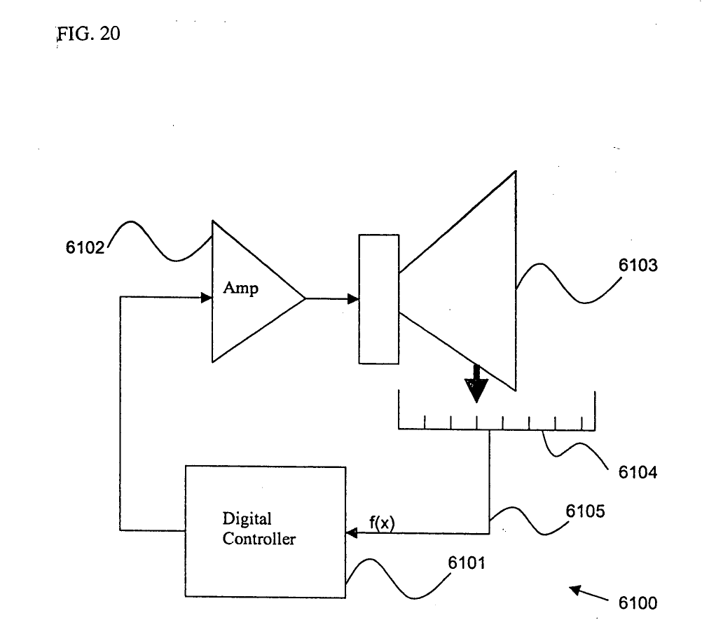

FIG. 20 shows a block diagram of a control loop 6100. The control loop 6100 includes a digital controller 6101, an amplifier 6102, and a transducer 6103 with position sensor 6104 (illustrated graphically) that outputs a measurement of a signal which is indicative of a state variable that is a monotonic, and generally nonlinear, function of position, ƒ(x) 6105. This nonlinear state variable could be an internal circuit parameter or a signal from an external position-sensing device. The nonlinear state variable serves as a measure of position in the control system according to the present invention.

Values for S can be measured directly from the control loop 6100. Considering the linearization correction equation (34) (or its subtracted version, equation (38)) for the transduction process alone with no audio information w, and hence without the B term, the spring force term S can be output independently simply by outputting a DC value—because for a DC signal, the only force in the correction equation is the static (spring-force to motor-factor ratio) term S(x), and the numerical value of S can thus be measured. And since the corresponding numerical DC value of the arbitrary measure of position ƒ(x) is also measured and fed back to the controller 6101, the approximate functional dependence of S upon ƒ can be extracted via a suitable polynomial fit, and then used by the digital controller 6101 to look up the value of S which goes into real-time linearization correction of an actual, AC audio signal.

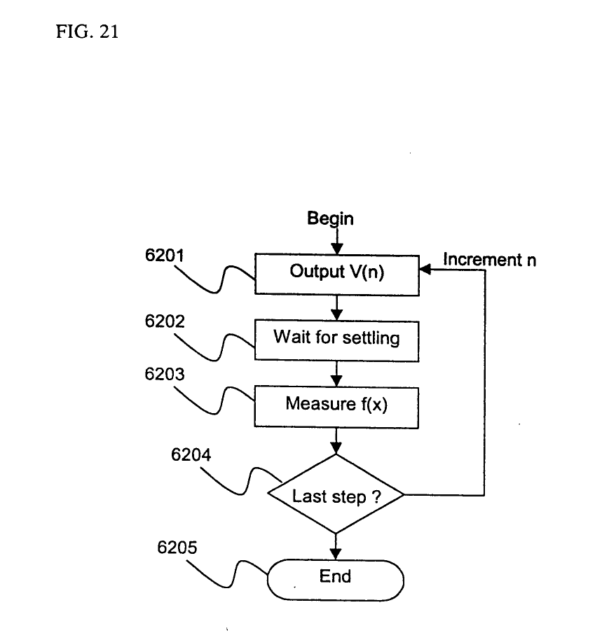

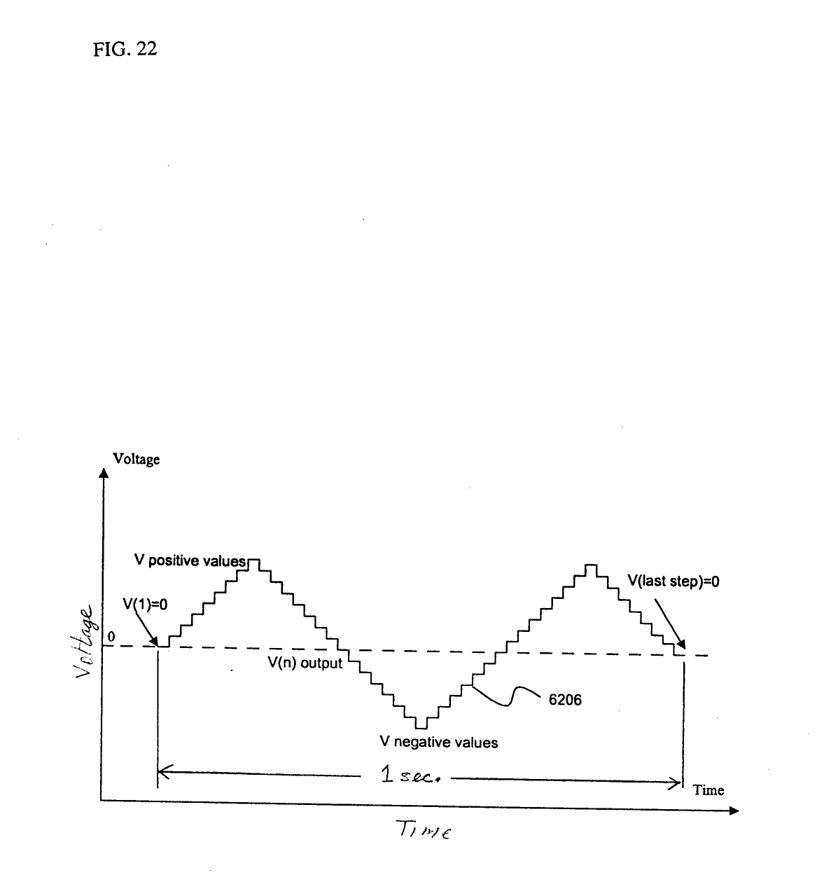

FIG. 21 is a flow diagram of a process for determining S as a function of position of a transducer. FIG. 22 shows the voltage waveform 6206, the current from which is utilized to move the cone of transducer 6103 and thus to determine and plot S as a function of x. Waveform 6206 is output in step 6201 which moves the diaphragm through positive and negative values of position x, relative to the no-drive equilibrium value x=0, over the range of the transducer's excursion. If, as is the case in the current embodiment, a voltage controlled amplifier is used, a voltage ramp 6206 is output from controller 6101 as shown. After a new discrete voltage level on the ramp is output in process step 6201, a short wait for settling is made (process step 6202). The corresponding position-indicator state variable ƒ(x) is then measured in process step 6203. The next discrete voltage level is then output in step 6201, unless a ‘last step’ decision is made in process step 6204; in which case the process ends with step 6205. Since a particular staircase signal is provided which is converted into the drive voltage V, and ƒ(x) is measured simultaneously, this in effect constitutes the outputting of S(ƒ⁻¹(ƒ(x))), i.e. the functional dependence S∘ƒ⁻¹ of S upon ƒ, where the circle symbol indicates function composition. The numerical value of the control parameter S used in the control loop 6100 is the transducer-coil current in voltage units—which is taken to be V. This procedure is approximately correct (in the case of a voltage controlled amplifier assumed here) to the extent that the non-Ohmic EMF terms in the coil circuit, including the effective coil inductance and BEMF voltage terms, are neglected. This is a justifiable approximation for sufficiently slow ramping, i.e. long ramp-times and settling times. The ramp is made slow relative to audio signal timescales, because it is undesirable to put out audio information in the ramp. Therefore, the current into the coil is proportional to voltage by Ohm's law, to a good approximation.

However, care must be taken that the ramp not be too slow, for otherwise significant heating of the coil could take place, and the coil current through the coil would then drop due to increased coil resistance. Care must also be taken to minimize the thermal and viscoelastic hysteresis effects reflected in the staircase-ramping measurements. Additionally, what unavoidable hysteretic effects do remain, should be compensated for via some averaging procedure. In preparing the curve of S as a function of x for an Audax 3″ transducer, waveform 6206 shown in FIG. 22 included thirty-two steps of equal duration per each sweep from highest to lowest or lowest to highest voltage value. During the first and last of the steps the output voltage was zero. In each of the other steps, the voltage increment or decrement was 1/16th of the zero-to-peak amplitude of the waveform 6206, which was 0.25 volt. This value was before amplification. The amplitude of the ramp-sweep voltage signal fed to the voice coil of transducer 6103 was about 20 times higher. This amplitude is determined, for each speaker transducer, by the need to cover the full excursion of the coil/diaphragm motion that is encountered in normal operation.

In the case of the 3″ Audax transducer, each thirty-two step sweep was completed over a one-second time interval, and two such full sweeps are shown in FIG. 22. Note that FIG. 22 only shows half the number of DC voltage steps per sweep as were actually used for the case of the 3″ Audax speaker transducer.

As a result of the staircase-ramped DC measurements, a table of the V(n) outputs, and the corresponding measured values of the nonlinear position-indicator state variable ƒ(xₙ), is created. This table is then polynomial-fitted to yield an approximate polynomial interpolating formula for the function S∘ƒ⁻¹, or (more generally) a new look-up table for interpolation of this function; in general both approaches could be used, for example via a polynomial spline (piecewise polynomial) and interpolation. In the case of a polynomial fit, which is used in one embodiment of the present invention, the interpolation approximation to the function S∘ƒ⁻¹ has the following form:
S∘ƒ⁻¹(ƒ(x))=s₀+s₁ƒ(x)+s₂ƒ(x)²+s₃ƒ(x)³+ . . . (43)

The values of V(n) in the table can be either actual voltage values, or values in the numerical format used by controller 6101. For example, the output values of V(n) could be fixed format digital words that are output to a digital-to-analog converter (DAC).

As for the B term in the control equation (38), measurement of the functional dependence of B(x) upon ƒ(x), denoted as B∘ƒ⁻¹(ƒ(x)), can be made by outputting a low amplitude tone, at a frequency sufficiently removed from the mechanical resonance frequency of the transducer to simplify the transducer's linear-response transfer function. The sound pressure output, or SPL, is measured at some fixed distance in front of the speaker, for example by means of a microphone, or alternately via other transducers within the speaker enclosure, or transducers in other speaker enclosures within a suitable proximity to the transducer being characterized. The off-resonance choice of tone frequency provides a relatively simple relation between the measured SPL and the motor factor Bl, which in turn is inversely related to B. The deduced values of B can then be tabulated against corresponding measurements of ƒ(x), for a stairway-ramped voltage signal 6206, in a manner similar to that used in the S measurements described above. At each DC voltage level, the low-amplitude tone is applied after that DC level has been held a sufficient time to allow electromechanical relaxation of the transducer to a steady state current and mechanical equilibrium. The frequency of the tone is fixed for each stairway-ramped voltage sweep, but can be varied from sweep to sweep. However, the foregoing approach is complicated by two factors. Firstly, the speaker's acoustic transfer function (diaphragm motion to SPL) is not a priori known for realistic speaker enclosures; and secondly, the suspension stiffness still affects the conversion of SPL values to B values, through the xₙ-dependent elastic resonance frequency, for tone frequencies low enough so that coil-inductance effects do not spoil the simple Ohmic conversion of voltage to coil current. This latter fact means that the S and B measurements are effectively entangled, as the extraction of B values requires knowledge of S values; and the converse also holds, as explained below.

Because of these complications a hybrid approach is utilized, as follows. First, a Klippel GMBH laser-based metrology system is used to find an eighth-order polynomial fit to the function Bl(x), and the ratio function

$$B ( x ) = \frac{Bl ( 0 )}{Bl ( x )} \qquad ( 44 )$$

where x=0 is the equilibrium position, is computed and replaced with a suitable lower-order polynomial fit. Note that this initial stage need only be performed once per given speaker, since drifts in the motor-factor function Bl(x) are almost entirely multiplicative, stemming from temperature dependence of the airgap magnetic field, and thus hardly affect the ratio B(x). Next, a stairway-ramped voltage sweep of the type described above is performed, in which the position-indicator nonlinear state variable ƒ(x) and the actual position x are simultaneously measured. The latter is measured via a position sensor used with a Klippel GMBH metrology system. This returns a voltage known to vary linearly with actual position to a high accuracy. And finally, the Klippel-derived polynomial fit to B(x) is combined with the interpolated function ƒ(x) to yield an approximate polynomial interpolation for the composite functional relation B∘ƒ⁻¹(ƒ(x)):
B∘ƒ⁻¹(ƒ(x))=b₀+b₁ƒ(x)+b₂ƒ(x)²+b₃ƒ(x)³+ . . . (45)

Once interpolative approximations (polynomial or other) to both the functional relations S∘ƒ⁻¹ and B∘ƒ⁻¹ (i.e. both S(x) and B(x) as functions of ƒ(x)) are determined, these interpolations are stored and integrated into the controller DSP and used, in transducer operation, to dynamically compute and output a corrected coil voltage V_{coil} from the original audio input signal w, via the control equation (38), as explained in Detail 10 below.

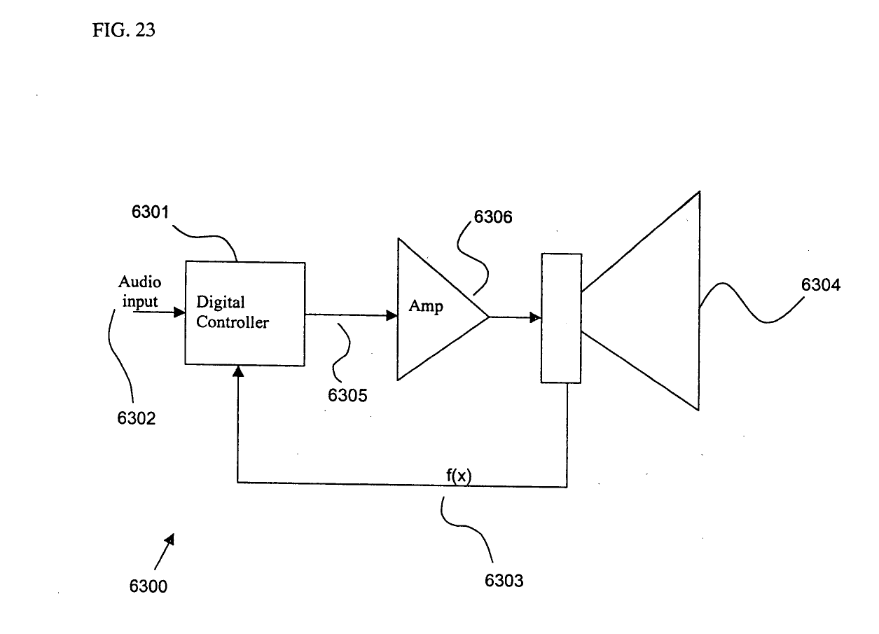

FIG. 23 is a general block diagram of a system 6300 depicting an audio transducer 6304 with the digital controller 6301. Digital controller 6301 received two inputs: the audio voltage signal w 6302 (also referred to as V_{audio}; see Detail 2), and the most recent measurement of the position-indicator nonlinear state variable, ƒ(x) 6303. This nonlinear state variable is measured in the transducer 6304. Digital controller 6301 combines the audio input with the measured value of ƒ(x) to compute the corrected V_{coil} in accordance to the control law. The control law may be that given by equation (38) in the event that only the transduction-process corrections are selected, or by other equations in Detail 2 in case the user decides to activate other combinations of control laws. The voltage V_{coil} is output in analog form 6305 by digital controller 6301, and provided the amplifier 6306. The output voltage from amplifier 6306 is provided to transducer 6304.

As discussed in Detail 2, the use of the entire spring force in the correction, thus in effect electronically subtracting away the entire elastic restoring force, would lead to dynamical instability. It is therefore necessary to add back a linear spring restoring force calculated as an adjustable fraction of the measured spring factor at equilibrium, S(0). This is done by subtracting a term linear in the estimated position ƒ⁻¹(ƒ(x)) from the ratio of the S∘ƒ⁻¹(ƒ(x)) polynomial to the B∘ƒ⁻¹(ƒ(x)) polynomial, since this ratio is the constant times an interpolating function for the suspension stiffness xK(x). The net result of this subtraction is that the numerical values of S, and the functional relation S∘ƒ⁻¹, are replaced by new quantities, denoted here as S′ and S′∘ƒ⁻¹ respectively, in the control equation (37). If the transconductance corrections are turned off, equations (36) and (37) reduce to the transduction-corrections equation (38), which is just equation (34), but with S replaced with the following subtracted value:
S′=S−kƒ⁻¹(ƒ(x))B (46)

Where a k=q K(0)/Rₘₛ is a constant multiplier, related to the adjustable parameter q of equations (37) and (38). The multiplier q can be optimized by user preference. In Equation (46), the three quantities S, B and S′are all expressed as interpolated polynomials in the measured position-indicator nonlinear state variable ƒ(x), as described above.

Beyond the need to stabilize the controlled transducer dynamics, a suitable choice of the residual linear spring coefficient k in equation (46) is also important in order to tune the resonant properties of the transducer appropriately for the given program material: a low effective spring stiffness will yield a low resonant frequency, and vice versa.

According to the present invention, there are provided parameterized linearization-filter functions characterizing the given transducer, which are measured and estimated using in-operation measurements of at least one nonlinear position-indicator state variable, augmented by preliminary (characterization) calibration runs in which this nonlinear state variable is measured simultaneously with a more linear position-indicating variable (such as the Klippel-GMBH laser metrology system). The nonlinear position-indicator variable measured in operation can be a voltage output from an optical device, as is the case in one embodiment of the present invention and as is described in Details 8 and 13 below; or it could be an output from the internal electronic parameter measurements, as described in Details 6, 7, 11 and 12. These measurements could be augmented by an external measurement of sound pressure level during characterization runs, as described above.

Accordingly an invention where the S and B parameters, needed by the controller to implement the transduction-process portion of the linearizing control law, can be matched to the program material by adjusting the parameter q governing the electronic spring force compensation, as described in equations (37), (38) and (46).

### DETAILED DESCRIPTION 6

### Zₑ Measurement Theory

An important aspect of the present invention is described in the context of a digital control system which linearizes audio reproduction using a position-indicator state variable, ƒ(x), which is monotonic in position. The inductance of a transducer voice coil provides such a position state variable. This method applies to many other classes of non-linear actuators and motors.

Although the three transducer parameters K, Bl, and Lₑ are usually considered as functions of position x, the corresponding three functional relations K(x), Bl(x), and Lₑ(x) can, whenever certain monotonicity properties hold, be combined (composed) together in various functional relationships from which x has been eliminated.

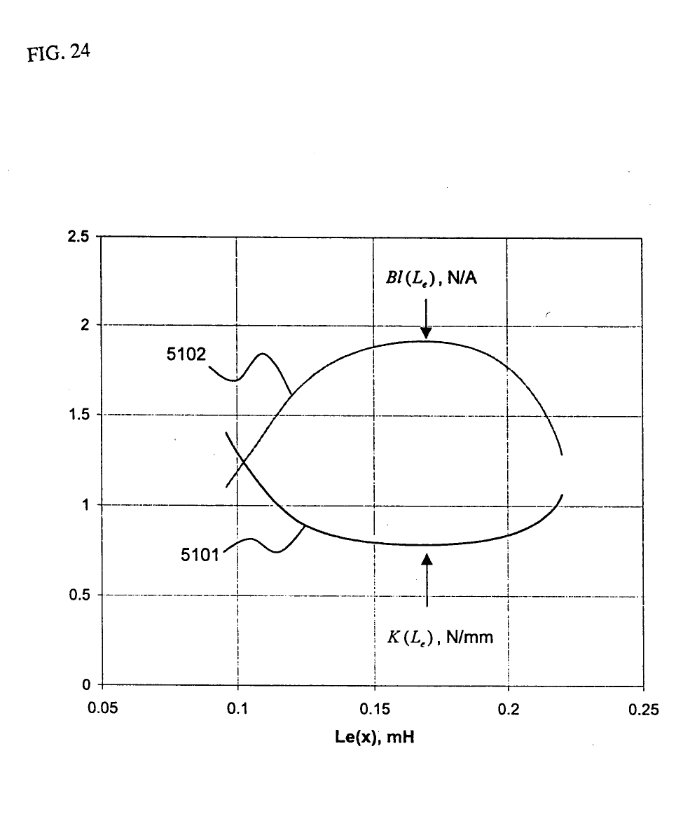

It can be seen from curve 403 in FIG. 4 that the values of Lₑ (in this case at frequencies below 1 kHz) are monotonic with x; that is to say, no two distinct x values within the range −2 mm to 2 mm correspond to the same value of Lₑ. We can thus map Bl (curve 401) and K (curve 402) onto Lₑ, and a measurement of Lₑ will uniquely predict both Bl(Lₑ) and K(Lₑ). These functional relationships are depicted in FIG. 24, in which curve 5101 is a plot of K in Newtons/mm and curve 5102 is a plot of Bl in Newtons/amp, both of which are plotted against Lₑ for the same data from FIG. 4. This new mapping provides a basis of a correction scheme. Because the inductance of the voice coil is a function of its position, by measuring the inductance the position of the voice coil is determined. Thus Lₑ provides an inductive position detector.

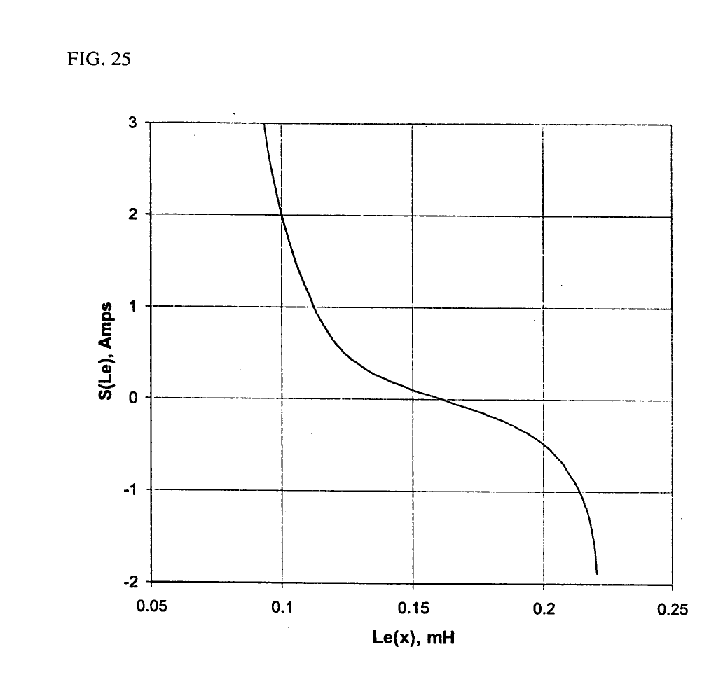

From the definition of S and B in Detail 2, it can be seen that S is a function of x(determined by the functions K(x) and Bl(x)) and can thus be expressed and plotted as a function of Lₑ, for transducers in which the function Lₑ(x) is monotonic (within suitable ranges of position, frequency and temperature). FIG. 25 displays S plotted as a function of Lₑ for the same Labtec Spin 70 transducer data as in FIG. 4. Similarly B can be plotted versus Lₑ.

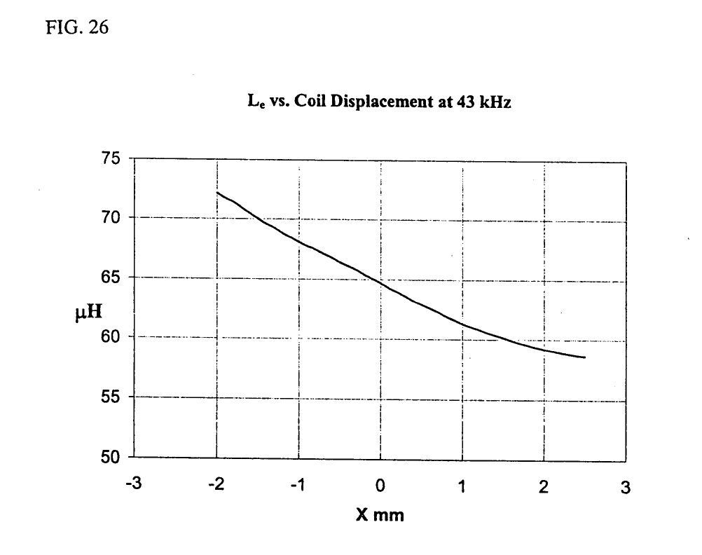

The use of the voice coil inductance, Lₑ, as a position estimator can be generalized as a method by considering that we are in fact using the effective complex voice-coil impedance Zₑ(ω,x), defined in Detail 1 above, to provide the estimate ƒ(x). In one embodiment described herein, the effective complex voice-coil impedance Zₑ(ω,x) is measured electronically at some suitably chosen supersonic probe-tone frequency. Similarly, the reactive component of Zₑ(ω,x), that is Lₑ, is also a state variable that depends monotonically upon x. The variation of Lₑ with position at 43 kHz is shown in FIG. 26 for a Labtec Spin70 transducer. The impedance Zₑ(ω,x) depends not only on coil position x and probe tone frequency ω, but also on the temperature distribution in various components of the transducer; the most significant such dependence is upon the average instantaneous voice-coil temperature, T_{coil}. This thermal dependence is primarily attributable to the variation of the copper coil's Ohmic resistance Rₑ with T_{coil}, which is about 7% per 10° C. at room temperature. This dependence can be made explicit, via the notation Zₑ(ω,x,T_{coil}). The impedance Zₑ(ω,x) has other thermal dependencies as well, such as a thermomagnetic dependence upon the temperatures in the inner and outer magnetic pole structure. These pole temperatures, in turn, are affected by eddy currents. However, it has been discovered in the present work that the dominant thermal dependence of Zₑ is upon T_{coil}, and this arises through the functional dependence Rₑ(T_{coil}).

In accordance with the present invention, a Zₑ method is provided which involves electronically measuring Zₑ(ω,x), for a range of values of coil/diaphragm position x, using a suitably chosen supersonic probe-tone frequency ω, and encoding the resulting function Zₑ(x) via a polynomial fit to the measured data. In one embodiment the polynomial fit can be used during speaker operation to dynamically calculate the current value of x(t) from the electronically measured values of Zₑ; the calculated x value is input into a correction (any of the linearizing-filter control laws described in Detail 2 above). In another embodiment the fitted function is used to generate and store a Look-Up Table (LUT).

Detail 11 below fully describes the aspect of the present invention consisting of specific methods and electronic circuits designed to implement the Zₑ method. This implementation utilizes a potential divider circuit to measure the overall (complex) effective coil impedance, Zₑ(ω,x), at the particular probe tone frequency of 43 kHz, with no attempt at either theoretical modeling of the trivariate complex function Zₑ(ω,x, T_{coil}), or at separating the real (resistive) component of Zₑ from its imaginary (reactive or inductive) component.

FIG. 4 shows a typical prior-art Lₑ(x) curve, coil inductance versus coil position, obtained by polynomial fitting of data at audio frequencies; the impedance measurements upon which FIG. 4 was based ignore the resistive component of Zₑ. As the figure indicates, the inductance changes monotonically with position, and measurement of this inductance thus yields a suitable substitute for the coil position itself in the control model of the present invention. As noted above, this dependence of Lₑ on x is also a function of frequency (and of coil temperature). For instance, at higher frequencies the Lₑ(x) curve flattens out, and additionally the maximal Lₑ value, at x=xₘᵢₙ, i.e. for a coil fully inserted into the magnetic airgap, decreases as ω increases. These two effects can be readily seen upon comparing FIG. 4 with FIG. 26; the latter figure summarizes measurements made at a probe-tone frequency of 43 kHz, for the Labtec Spin70 transducer, the characteristics of which are shown in FIG. 4 at audio frequencies.

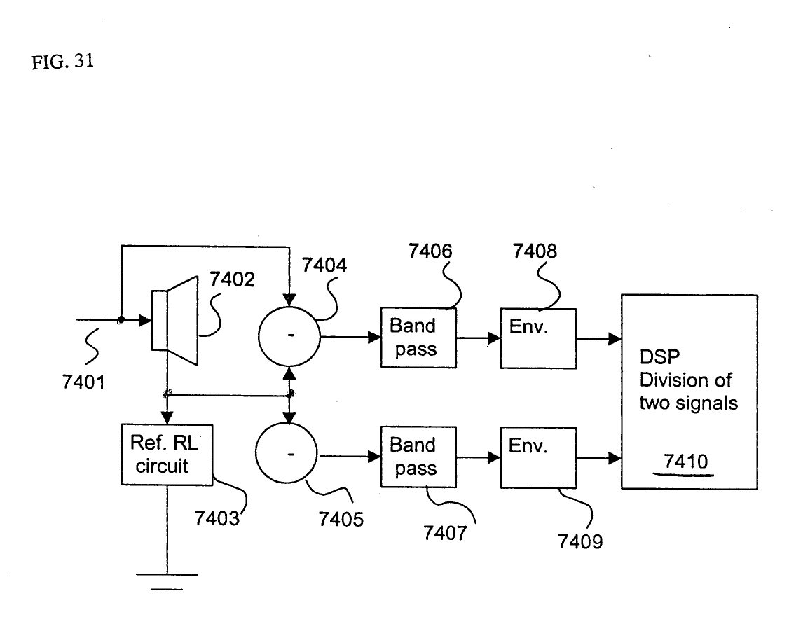

A method for measuring the coil inductance is illustrated by the block diagram in FIG. 31. A supersonic probe tone (“carrier signal”) is applied via input line 7401 to the voice coil of transducer 7402. In this approach, a reference R L circuit 7403 is placed in series with the voice coil. The supersonic signal is then injected into the voice coil of the transducer 7402 in addition to the audio signal, and the voltage across the voice coil of the transducer 7402 and the reference R L circuit 7403 is measured. Reference R L circuit 7403 may be implemented using a resistor and a coil in series. Alternatively, a coil or a resistor may be used to implement circuit 7403. The measured voltage signals are sent via summer 7404 and summer 7405 through filter 7406 and filter 7407, respectively, and the ratio of the output of the filters is then determined in either the analog or digital domain. The filter 7406 and filter 7407 are band pass filters implemented about the frequency of the carrier signal. Envelope detection via envelope detector 7408 and envelope detector 7409 is used to extract the signal due to changes in Lₑ. The ratio of the voltages coming out of the envelope detector 7408 and detector 7409 can be described in the Laplace domain as:

$${V}_{ratio} = \frac{{L}_{e} s + {R}_{e}^{′}}{{L}_{ref} s + {R}_{ref}} \qquad ( 47 )$$

Where Rₑ′ is the resistive component of coil impedance at the probe tone frequency, including both the Ohmic coil resistance Rₑ and the lossy effective coil impedance component due to eddy currents. R_{ref} and L_{ref} are the respective series resistance and inductance of the reference R L circuit 7403; and s is the Laplace variable. Because the ratio of the two voltages is taken, the signals that are close in frequency to that of the carrier, and thus cannot be rejected by the band-pass filter 7406 and filter 7407, will not introduce significant error in Lₑ determination. As long as L_{ref} and R_{ref} are chosen so that

$$\frac{{L}_{e}}{{L}_{ref}} and \frac{{R}_{e}}{{R}_{ref}}$$

are the same for frequencies near the probe tone, Vᵣₐₜᵢₒ remains a constant equal to

$$\frac{{R}_{e}}{{R}_{ref}} = \frac{{L}_{e}}{{L}_{ref}} ,$$

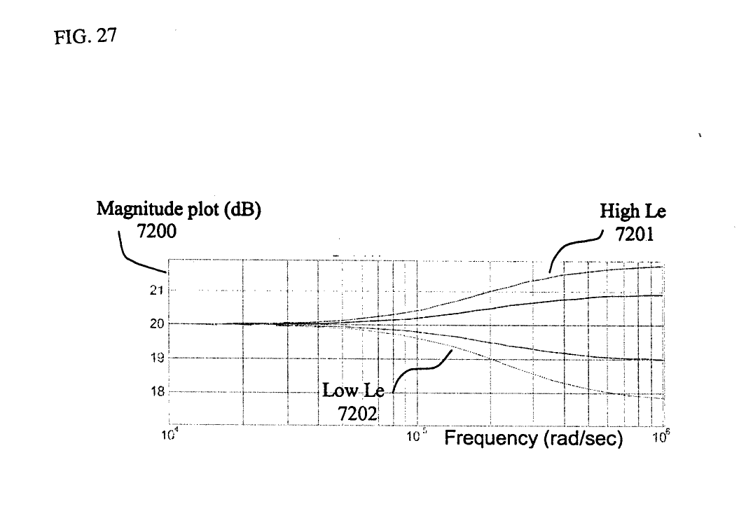

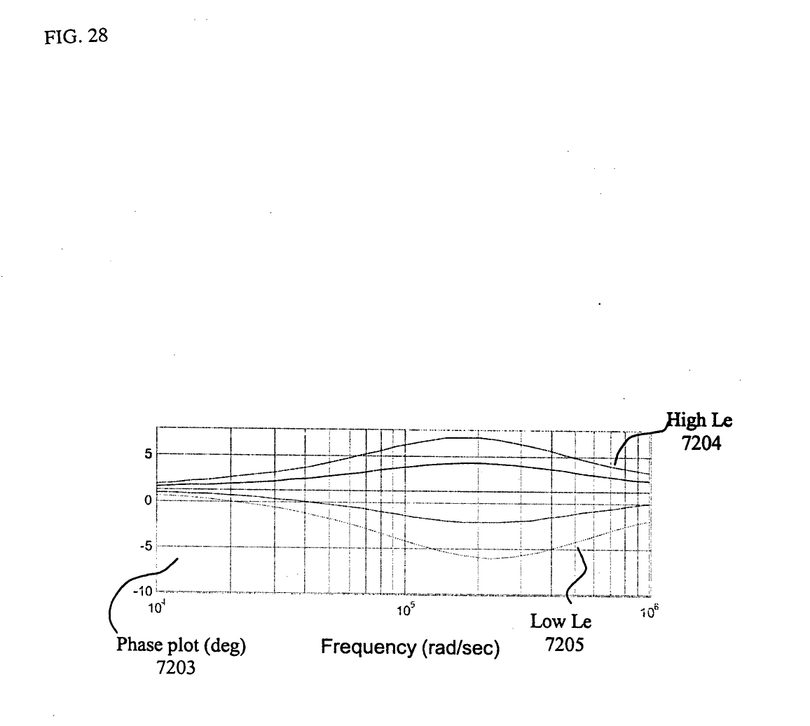

regardless of the presence of other signals in the system that are close to the frequency of the carrier signal. Since Lₑ varies with coil position x, Vᵣₐₜᵢₒ will change accordingly. FIG. 27 shows the Bode plot of the transfer function Vᵣₐₜᵢₒ given in equation (47), while FIG. 28 shows the corresponding phase Bode plots.

The ordinate in FIG. 27 is the magnitude of Vᵣₐₜᵢₒ, in dB units, while the ordinate in FIG. 28 is the phase of Vᵣₐₜᵢₒ, in degrees; in both plots, the abcissa represents angular frequency in units of radians per second. In both FIG. 27 and FIG. 28, the family of Bode plots is for progressively larger values of Lₑ, with the highest Lₑ value resulting in the curve 7201 and curve 7204, while the lowest value results in the curves 7202 and 7205. It is seen that as Lₑ increases, so does the magnitude of Vᵣₐₜᵢₒ. The sensitivity of Vᵣₐₜᵢₒ to changes in Lₑ is clearly a function of the probe tone frequency. The higher this frequency, the more sensitive Vᵣₐₜᵢₒ will be to Lₑ variations.

To reduce the effect of the common mode in-band noise, which is present in the voltage across the voice coil (i.e. (Lₑs+Rₑ′)·i) and the in the voltage across the reference R L circuit (i.e. (L_{ref}s+R_{ref})·i), upon the voltage ratio, the phase shift of

$$\frac{{L}_{e} s + {R}_{e}^{′}}{{L}_{ref} s + {R}_{ref}}$$

must be small. Thus, the choice of probe tone frequency may have an impact on the effectiveness of noise cancellation within the above-described approach. Furthermore, to insure the noise cancellation advantage of this algorithm, the band pass filters, mentioned above, must be matched as closely as possible.

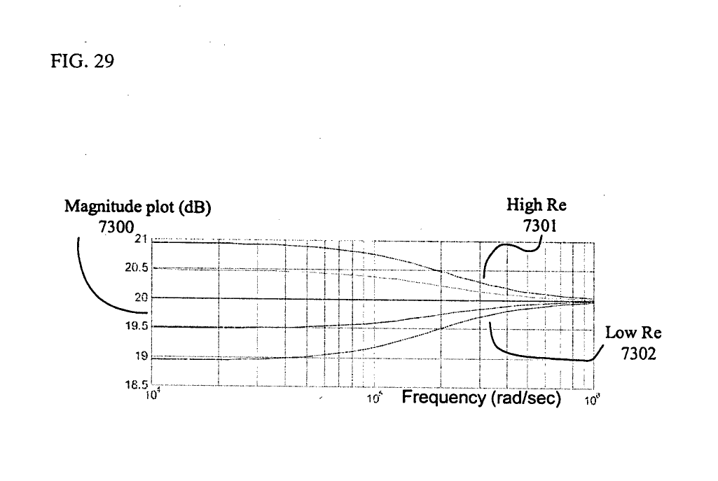

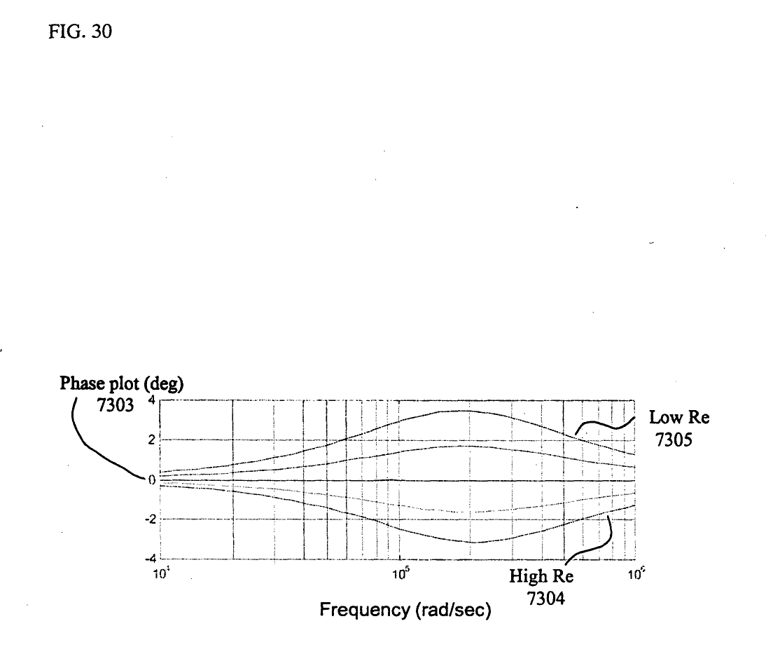

The other factor that will adversely affect the Lₑ measurement is the above-mentioned change of Rₑ due to variations of the voice-coil temperature. Such a change in Rₑ (and therefore also in Rₑ′) is likely to be misinterpreted as a change in Lₑ, as seen upon comparison of FIG. 29 and FIG. 30 with FIG. 27 and FIG. 28. FIG. 29 shows a series of Bode plots for the magnitude 7300 of Vᵣₐₜᵢₒ, and FIG. 30 shows the corresponding plots for the phase of Vᵣₐₜᵢₒ 7303. Each plot-pair is for one of a decreasing sequence of Rₑ values, and thus corresponds to a sequence of decreasing voice-coil temperatures, for example, the magnitude plot for the highest Rₑ value 7301; the magnitude plot for lowest Rₑ 7302; the phase plot for highest Rₑ 7304; and finally, the phase plot for lowest Rₑ 7305.

Because FIG. 27, FIG. 28, FIG. 29 and FIG. 30 illustrate that a thermal change in Rₑ is likely to be misinterpreted as a change in Lₑ, a modification in the algorithm is needed to separate this thermal effect from actual changes in Lₑ that are caused by changes in the voice coil position. From FIG. 29 and FIG. 30, it is clear that the effect of variations in Rₑ upon the ratio Vᵣₐₜᵢₒ is minimized at the higher probe tone frequencies. This characteristic of Vᵣₐₜᵢₒ can be utilized to accurately determine Lₑ in the presence of thermal changes to Rₑ. For instance, for the Labtec Spin 70 speaker transducer for which the curves in FIG. 27, FIG. 28, FIG. 29 and FIG. 30 were generated, the use of a carrier signal at 150 kHz will significantly reduce the thermal effects upon Lₑ measurement.

### Detailed Description 7

### C Theory—Parasitic Capacitance and Cant Dynamics

An important aspect of the present invention is described in the context of a digital control system which linearizes audio reproduction using a position-indicator state variable, ƒ(x), which is monotonic in position. The parasitic capacitance C_{parasitic} between the voice coil and the body of a transducer can be used to give such a position state variable. This method applies to many other classes of non-linear actuators and motors.

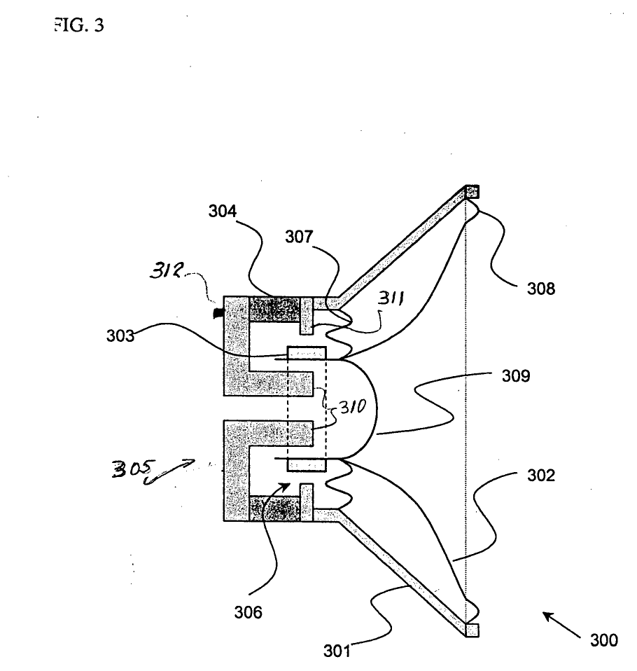

The parasitic capacitance C_{parasitic} between the voice coil of a transducer and the body of the transducer is largely determined by the relative positions of the voice coil and the magnetic pole pieces and central core. The variation of this capacitance with position is relatively straightforward and robust (reproducible). As illustrated, for example in FIG. 3, typically the voice coil 303 fits about a central core 310 which is part of the iron assembly 305. The variation in the parasitic capacitance depends largely on the overlap of the voice coil 303 with the central core 310, and, to some extent, with the outer pole piece 311 as well.

More precisely, the parasitic capacitance is between the voice coil-copper wire and the entire magnetic circuit, each regarded as a single, equipotential, electrical conductor. C_{parasitic} is determined primarily by the geometries of the coil's solenoid, which is typically wound with copper wire; of the voice-coil former, if it is metallic (if so it is typically made of aluminum); and of those portions of the magnetic circuit adjacent to the airgap in which the coil rides (i.e. the central core and outer pole, both usually made of low-carbon steel). The dielectric constant of the coil wire's insulation also has some effect on the value of C_{parasitic}.

Importantly for the purpose of the present C method, C_{parasitic} is an easily measurable internal circuit parameter of the transducer which is, at the same time, a state variable which depends monotonically upon axial coil position x. As the coil moves deeper into the magnetic airgap, the capacitative contact areas between the metallic surfaces of coil and poles on the one hand, and between former and poles on the other hand, increases; and thus so does the value of the parasitic capacitance.

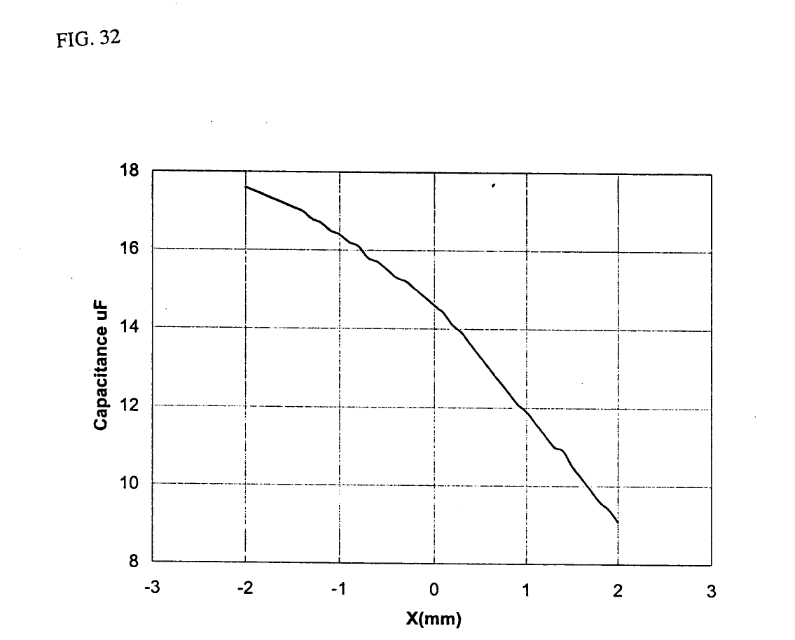

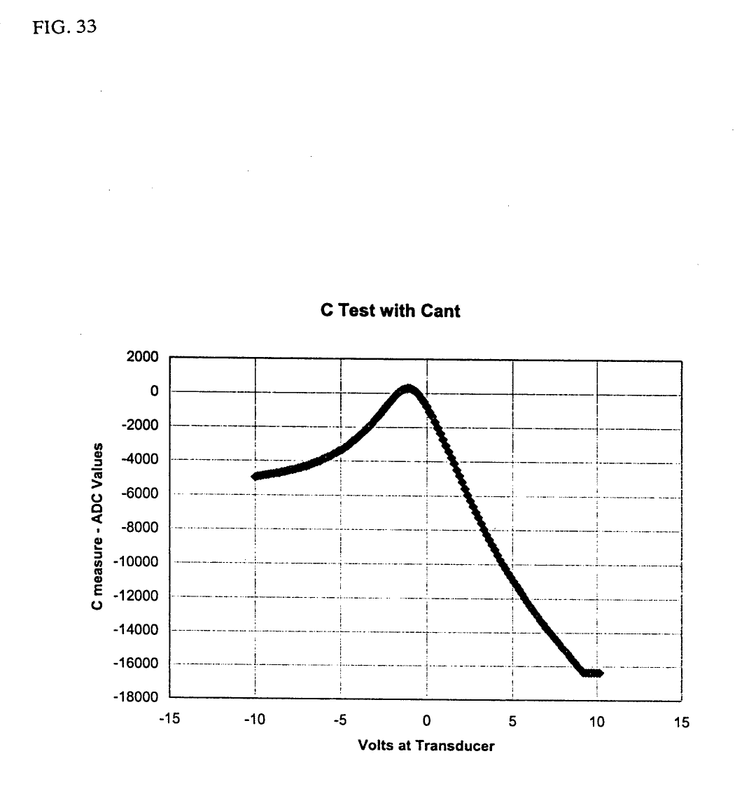

Detailed measurements of C_{parasitic} have been made as a function of x for the transducer of the Labtec Spin70 speaker, the large signal parameters of which are given by the curves depicted in FIG. 4. This transducer is of the type shown in cross-section in FIG. 3. The C_{parasitic} measurements made were of two types: driven and non-driven. In the non-driven class of measurements, the voice coil was not driven, i.e. no current was sent through it; x was controlled and varied manually by means of a mechanical device, and C_{parasitic} was measured for each x value. In the driven-coil type of measurements, the voltage level V_{coil} driving the coil was swept through a range of values corresponding to realistic coil/diaphragm excursions, and C_{parasitic} was measured electronically. Simultaneously, a Klippel GMBH laser metrology system was used to measure the corresponding value of x. This provided two measured curves, C_{parasitic} as a function of V_{coil}, and x as function of V_{coil}. FIG. 32 shows the functional relation C_{parasitic}(x) for the mechanically moved, non-driven set of measurements. FIG. 33 shows the variation of C_{parasitic} with V_{coil}. Positive voltage values correspond to coil positions displaced from no-drive equilibrium outward, toward a listener, while negative voltage values correspond to coil positions displaced from no-drive equilibrium inward, away from the listener.

In FIG. 33 C_{parasitic} is measured in arbitrary units obtained using the method described in Detail 12. While it is not possible to directly compare FIG. 32 and FIG. 33, it is known that V_{coil} is monotonic with x. It will be appreciated that the qualitative behaviors of the two curves agree for x values corresponding to a coil displaced outward from its equilibrium position. For the lower portion of the x range, however, the voltage driven variation in C_{parasitic}(x) function is no longer monotonic. As illustrated in FIG. 33, it turns down, diverging dramatically from the monotonic variation clearly exhibited by the non-driven C_{parasitic}(x) curve displayed in FIG. 32. This lower portion of the position range corresponds to a coil/diaphragm assembly at mechanical equilibrium or displaced inward from equilibrium.

The non-monotonicity in C_{parasitic}(x) displayed in FIG. 33 is understood as resulting from canting of the coil/diaphragm assembly as it moves into the airgap; the canting, in turn, results from magnetic torques on the incomplete wire-turns that terminate the coil solenoid on its outward end. This cant effect limits the operating range of the parasitic-capacitance technique for the Labtec transducer, and other similar transducers, but not for some other speaker transducers, such as those found in cell phones and tweeters.

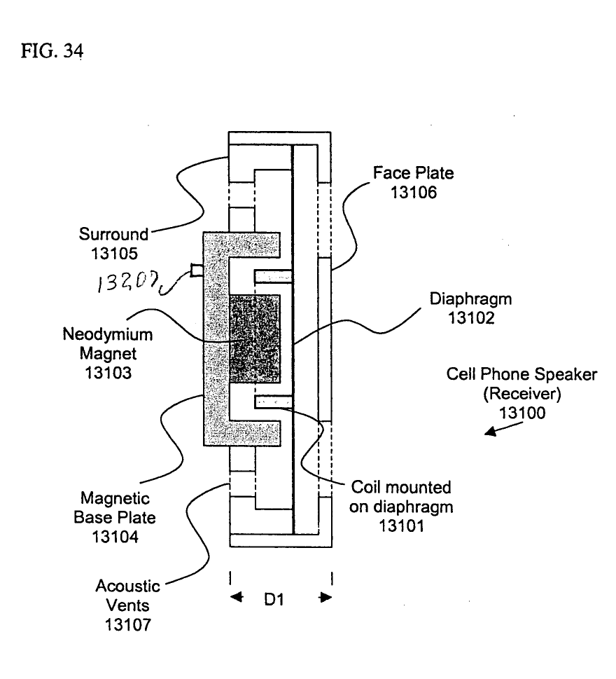

Measurements of the C_{parasitic} state variable for smaller cell-phone speaker transducers, for example the type illustrated in FIG. 34, have been made and have been used to implement the spring portion of the control (linearizing-filter) according to the present invention. This implementation used a parameterization of the monotonic function C_{parasitic}(S), and in it both the parasitic capacitance C_{parasitic}(x) and the spring-factor variable S(x) were measured electronically using the methods described in Details 5 and 12.

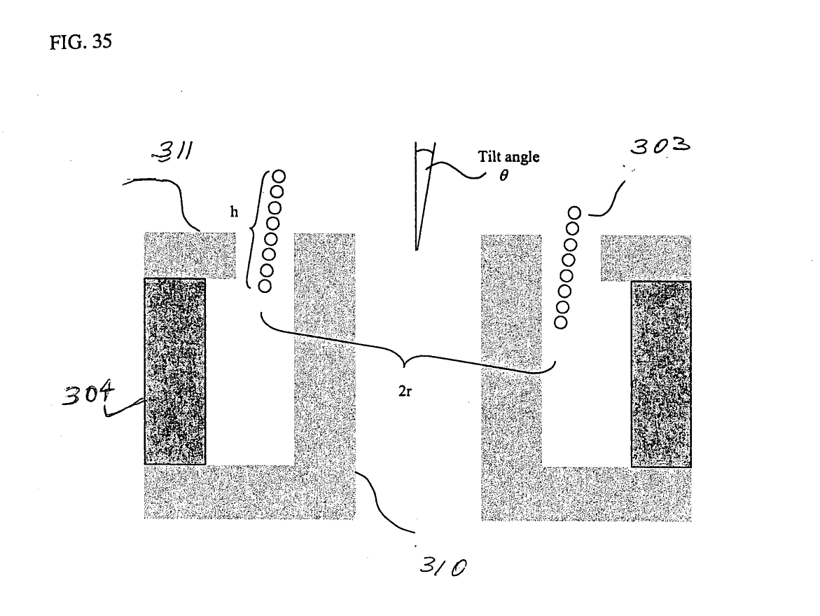

It is possible to understand the results from FIG. 32 and FIG. 33 using simple semi-quantitive models. Although some fairly involved modeling is required to obtain an accurate prediction of C_{parasitic}(x) for a given transducer, it is quite easy to estimate its order of magnitude. Thus, referring to FIG. 35, assume a coil of height h and radius r. In the modeling described below, it is assumed that the coil former is to be non-conducting; thus only the coil-slug contribution to the capacitance is considered. Furthermore, we ignore the capacitance between coil and outer pole (as the capacitive overlap area for that pair of conductors is assumed smaller than between coil and core). For simplicity the wire indentations and insulation are likewise ignored. The maximal value of C_{parasitic}(x) occurs when x is smallest, that is to say, when the coil is farthest into the magnetic airgap, x=xₘᵢₙ. Assuming that at this coil position the capacitative contact area between coil and slug equals the total area of the coil's cylinder, the following estimate results:
C_{parasitic}(xₘᵢₙ)≈ε₀2πr h/gᵢₙₜₑᵣᵢₒᵣ (48)

Where ε₀ is the permittivity of air and gᵢₙₜₑᵣᵢₒᵣ is an estimate of the average distance between the steel of the central pole, and the copper surface of a typical wire belonging to the coil's innermost winding layer. For instance, in the case of the LabTec speaker transducer discussed above, the geometrical parameters are estimated to be r=7.5 mm, h=5 mm, and gᵢₙₜₑᵣᵢₒᵣ≈0.2 mm Substitution of these three values into equation (48) yields:

Where r denotes torque; i(t) is the coil current, time
C_{parasitic}(xₘᵢₙ)≈10 pF (49)

the value measured electronically was found to be about 18 pF for this transducer. The discrepancy is reasonable given the parameter estimates.

For transducers of smaller speakers, such as those utilized in cell phone receivers smaller capacitance values, for example several picoFarads, were measured. This decreased magnitude can readily be understood from the way in which the right-hand side of equation (48) scales down with the linear dimensions of speaker's transducer.

The transducer models used in this disclosure typically assume perfect azimuthal symmetry (i.e. invariance under rotations about the axis of symmetry) of both the transducer's geometry and its dynamics; this assumption is also made in most prior art models. However, there do exist deviations from azimuthal symmetry, which result in cant (tilt) of the voice coil and diaphragm assembly during operation; this fact is well recognized in prior art [J. Vanderkooy, J. Audio Eng. Soc., Vol. 37, March 1989, pp.119-128.]

Since canting effects have been shown to pose problems for implementation of the C-method of the present invention for some types of speaker transducers, a detailed discussion of the causes and effects of coil/diaphragm cant is provided below.

When an aluminum former is used as a heat sink for the voice coil, which is often the case in transducers of woofer speakers due to the high power levels dissipated in their coils, unwanted circumferential eddy currents are induced in the former. These eddy currents result from two effects: one is the EMF induced in the former due to the its axial motion through the radial magnetic field in the airgap; and the other is the EMF induced by the time dependence of the coil-current's contribution to the axial magnetic field through the former's interior. In order to suppress these eddy currents, it is standard practice to interrupt them by introducing a slot along the axial length of the former's surface. This practice does not, however, completely eliminate the former eddy currents, but instead has the effect of distributing them nonuniformly around the former's circumference. These nonuniform currents, in conjunction with the static radial magnetic field in the airgap, cause magnetic Lorentz forces on the coil/diaphragm assembly which lack azimuthal symmetry. These non-uniform forces lead to a non-vanishing torque, and therefore to canting. This former-caused canting effect is discussed in J. Vanderkooy, J. Audio Eng. Soc., Vol. 37, March 1989, pp.119-128.

Even for transducers in which the voice coil's former is non-conducting, azimuthal symmetry is broken, primarily by the incomplete number of coil-wire turns. This is because the coil-circuit copper wire enters and leaves the coil solenoid tangentially, and these two tangent points are at different azimuth angles. As a result, the number of wires turns is fractional—again resulting in an asymmetry in the axial-direction magnetic (Lorentz) forces exerted on different sides of the coil by the airgap radial magnetic field, thus leading to torque and canting.

For the Labtec Spin70 transducer, canting due to fractional turns, in addition to exacerbating audio distortions, makes correction using the C method less desirable in some ranges of cone movement, by causing the function C_{parasitic}(x) to become non-monotonic when in operation. As the voice coil moves towards the back of the speaker through the airgap to, or beyond, its mechanical equilibrium point, the fractional wire-turns approach the region of high-magnetic-field in the airgap sufficiently to cause significant torque and canting; the cant, in turn, causes some parts of the coil wire's conducting surface to recede further from one or the other of the magnetic pole structures, increasing the value of the effective capacitive gap gᵢₙₜₑᵣᵢₒᵣ in equation (43) and thereby decreasing the values of C_{parasitic}.

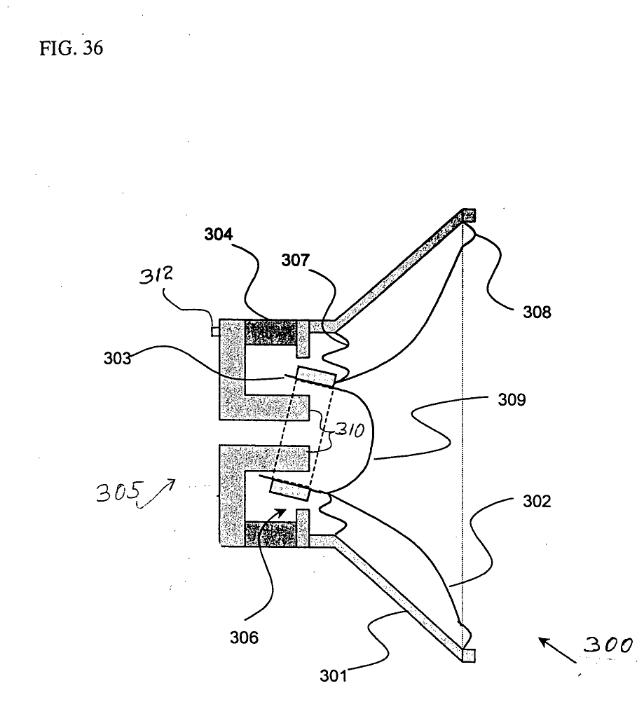

A simple theory explaining the fractional-winding-caused canting, and its effect upon C_{parasitic}(x), can be suggested. FIG. 36, which is identical to FIG. 3 except that the coil/diaphragm assembly exhibits cant, shows a cross-sectional view of the canting in the context of the entire transducer. FIG. 35 shows the voice-coil and magnetic assembly for a canting transducer 300 in more detail. FIG. 35 illustrates the tilted voice coil 303, showing its dimensions h and r and variable tilt-angle θ (mechanical connection of the coil to former and diaphragm assembly not shown), the core pole 310, and outer pole 311, both made of low-carbon steel in the case of the Labtec and similar speakers (typically 1008 or 1010 steel), and a permanent magnet 304 (sometimes one of several permanent magnets in the magnetic assembly). For simplicity's sake, azimuthal asymmetries resulting from the magnetization induced in the magnetic pole structure are ignored, as are eddy-currents induced in the pole structure. These ignored induced effects exhibit an asymmetry mirroring that of the coil-wire current distribution, but are not expected to change the order of magnitude of the effects in question—neither of the canting effect itself, nor of the cant-induced non-monotonic effect in C_{parasitic}(x).

It is assumed that the fractional part of the number of coil-wire windings is ½, and the above notation for coil dimensions is retained. A further simplification is made, in that the radial magnetic field at the position of the half-winding is replaced with the same field component averaged over all the coil's windings. The canting torque on the coil/diaphragm due to the magnetic Lorentz force, is then approximately:

$${τ}_{magnetic} \approx \frac{r}{2 N} Bl ( x ) i ( t ) \qquad ( 50 )$$

Where τ denotes torque; i(t) is the coil current, time independent in the DC case; Bl(x) is the transducer motor factor, and N the total number of windings in the voice coil.

This magnetic torque is opposed by an elastic torque, caused by the elastic restoring forces acting to counter the canting. We denote by

$$\frac{1}{4} {h}^{2} {ρ}_{elastic} ( x ) K ( x )$$

the relevant torsional spring constant—i.e. the elastic torque, per radian of tilt, exerted by the speaker's spider and surround upon the coil, diaphragm and cone; here h is the coil's height (defined above equation (48)), K(x) is the coil/diaphragm suspension stiffness recognized in prior art, while ρ_{plastic}(x) is a dimensionless elastic ratio modulus characteristic of the coil/diaphragm assembly. The ρ_{elastic} ratio modulus is expected to be significantly larger than unity, as speaker diaphragms are designed to resist canting while allowing axial motion.

With the above definitions, the elastic restoring torque is simply:

$${τ}_{elastic} \approx \frac{{h}^{2}}{4} {ρ}_{elastic} ( x ) K ( x ) θ ( t ) \qquad ( 51 )$$

where θ(t) represents the canting (or tilt) angle, in radian units, as a function of time.

When the coil is driven with a DC or quasi-DC current, mechanical equilibrium is attained when the magnetic and elastic torques balance: this occurs at a tilt angle of

$$θ ( t ) \approx \frac{2 r}{{Nh}^{2}} \frac{Bl ( x )}{{ρ}_{elastic} K ( x )} i ( t ) \qquad ( 52 )$$

Ignoring the coil-wire insulation, this tilt results in an increase in the parasitic capacitance, roughly estimated at:

$$\frac{1}{{C}_{parasitic} ( x , θ )} \approx \frac{1}{{C}_{parasitic} ( x )} + \frac{\vert θ ( t ) \vert}{16 {ɛ}_{0} π r} \qquad ( 53 )$$

Where |θ(t)| is the absolute value of the tilt angle, and C_{parasitic}(x) is the capacitance for the case of no canting.

Since the driven-coil measurements for the LabTec speaker transducer were quantified in terms of coil-circuit voltage rather than coil current, we set i(t)=V_{coil}(t)/Rₑ in the above equations, where Rₑ is the coil's Ohmic resistance (this relationship requires corrections in the AC case, as detailed elsewhere in this document). Thus, for the DC case, equations (52)-(53) now yield the predicted fractional increase in parasitic capacitance due to canting:

$$- \frac{δ {C}_{parasitic}}{{C}_{parasitic}} \approx {C}_{parasitic} ( x ) {V}_{coil} \frac{1}{8 π {h}^{2} {ɛ}_{0} {R}_{e} N} \frac{Bl ( x )}{{ρ}_{elastic} ( x ) K ( x )} \qquad ( 54 )$$

Note that equation (54) only holds when the voltage V_{coil} is of the sign corresponding to an inward magnetic Lorentz force acting on the coil; when V_{coil} has the opposite sign, the fractional winding is too far from the airgap's magnetic field to result in significant canting, and δC_{parasitic} becomes approximately zero.

Putting in values for the case of the Labtec speaker transducer: the maximum voltage was +10 volts; the elastic ratio modulus ρ_{elastic} is estimated at about 10 (although it could actually be higher); the no-drive value for the parasitic capacitance for a fully-inserted coil is C_{parasitic}(xₘᵢₙ)≈18 pF; and the other relevant physical and geometrical parameters for this transducer are.
N≈60, Bl≈1.5 N/Amp, K(xᵢₙ)≈1.3 N/mm, h≈5 mm, Rₑ≈4Ω (55)

Substitution of all these parameters into equation (54) yields the following estimates:

$${θ}_{max} \approx 0.0043 rad , - ( \frac{δ {C}_{stray}}{{C}_{stray}} ) \approx 1.3 \qquad ( 56 )$$

This tilt angle would only result in a maximal lateral displacement of order 0.02 mm for parts of the coil—too small to cause the coil to be physically blocked by the pole structure, but enough to result in discernible audio distortions. However, the estimate for the fractional change in stray capacitance is quite dramatic, and in agreement with the measurements made for this speaker transducer.

### Detailed Description 8

### IR Diode Measurement Theory

An important aspect of the present invention is described in the context of a digital control system which linearizes audio reproduction using a position-indicator state variable, ƒ(x), which is monotonic in position. A variety of optical methods can be used to give such a positional measurement.

One measurement technique known to the art uses a semiconductor red-light laser diode to illuminate a spot on the transducer cone. Scattered light from the illuminated spot is then detected by a PIN diode, and converted to a voltage. This laser measurement of position can be highly linear with true coil/diaphragm position, but there are drawbacks to this method. Laser light, being highly coherent, produces a great deal of granular specular reflections (speckle) from the irregularities in the illuminated cone spot, in addition to the diffuse, i.e. Lambertian, scattering. These speckle reflections appear as noise in the output of the PIN diode detector circuit, which therefore needs to be heavily filtered. The speckle-removing filters create signal delay. For example, the bandwidth of the Klippel GMBH laser-based metrology system is on the order 1 kHz, which is too low for controlling a mid-range audio transducer.

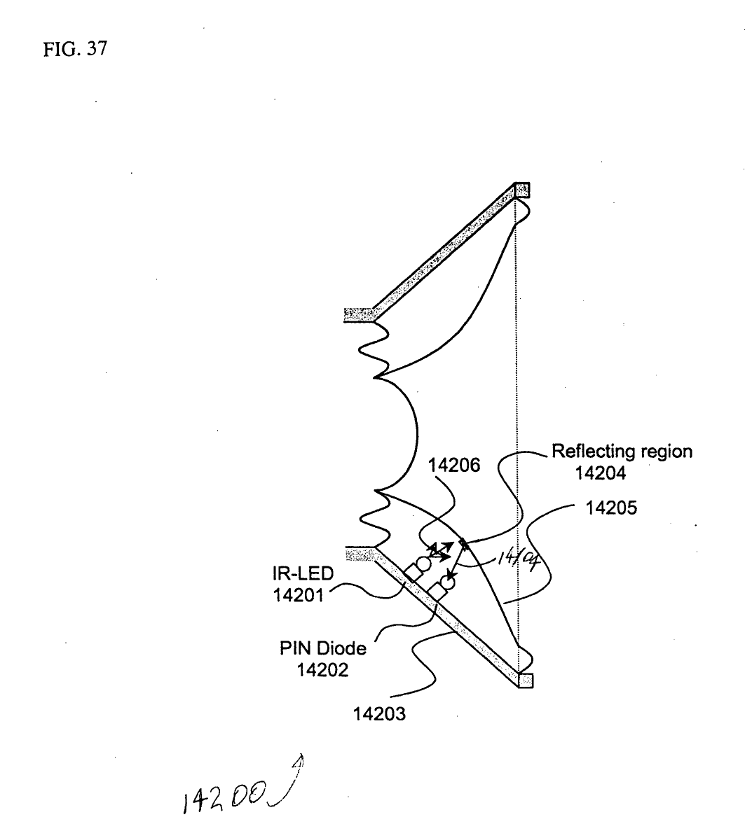

To eliminate these problems, a much simpler external optical position-detection system, utilizing an infrared light emitting diode (IR-LED) in conjunction with a PIN diode detector, is provided according to the present invention. FIG. 37 illustrates the detection system 14200. An IR-LED 14201, and a PIN diode detector 14202 are secured to a transducer frame 14203. A region 14204, consisting of reflective material or coating, such as white paint, is sprayed or placed on the back side of the transducer cone 14205. The IR-LED 14201 illuminates reflecting region 14204 with infrared light 14206. The electrical resistance of PIN diode detector 14202 changes with the position-dependent intensity variations of infrared light scattered from reflecting region 14204 on the back side of cone 14205. Due to the use of an area illuminator with finite emittance, a relatively widely illuminated region, and a finite-area detector with finite acceptance angle, the position information derived via this IR-LED method is quite linear with x over most of the cone's excursion. The IR-LED derived positional measure ƒ(x) can be calibrated by comparing LED measurements against the laser output from a metrology instrument such as Klippel GMBH.

Although the IR-LED position indicator state variable xᵢᵣ=ƒ(x) is less linear with x than the laser measurement, there is also less noise in the IR-LED position indicator measurement than there is in the case for a corresponding laser measurement. This is because LED light is much less coherent that laser light, and thus LED illumination results in far less speckle noise than is the case with a laser-based measurement.

### Detailed Description 9

### System Block Diagram

The present invention is described in the context of controlling an audio transducer system in part by system consisting of hardware and software.

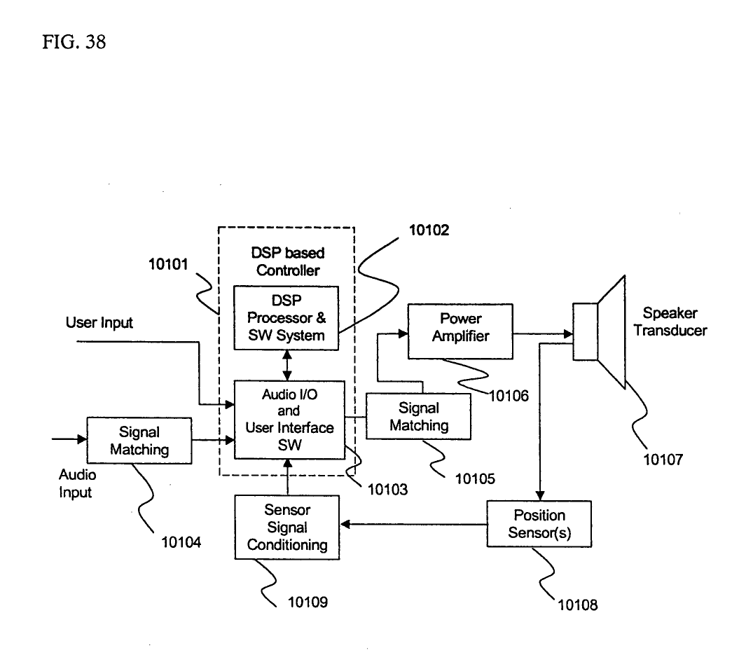

FIG. 38 shows a block diagram of a more specific embodiment of the generalized control system shown in FIG. 8.

A DSP based controller 10101 consists of a DPS processor and software system 10102 and an interface system 10103 consisting of analog input/output and user interface software. Audio input is provided to DSP based controller 10101 through a signal matching network 10104 which filters the audio input and provides the correct level of input to the interface system 10103. The audio input is acted on by the control routines in the DSP based controller 10101 and is output to a second signal matching network 10105. The signal from the signal matching network 10105 is provided to a power amplifier 10106. The output of power amplifier 10106 drives a speaker transducer 10107. A position sensor 10108, or sensors, is used to provide a position indication signal, indicating the position of the coil/diaphragm assembly of the speaker transducer 10107 to sensor signal conditioner 10109. Such position sensors could be, for example, the Zₑ detector of Detail 6, or IR detector described in Details 8 and 13, or C detector described in Details 7 and 12. Sensor signal conditioning system 10109 is used to amplify and filter the positional signal and match it to the level required for the interface system 10103.

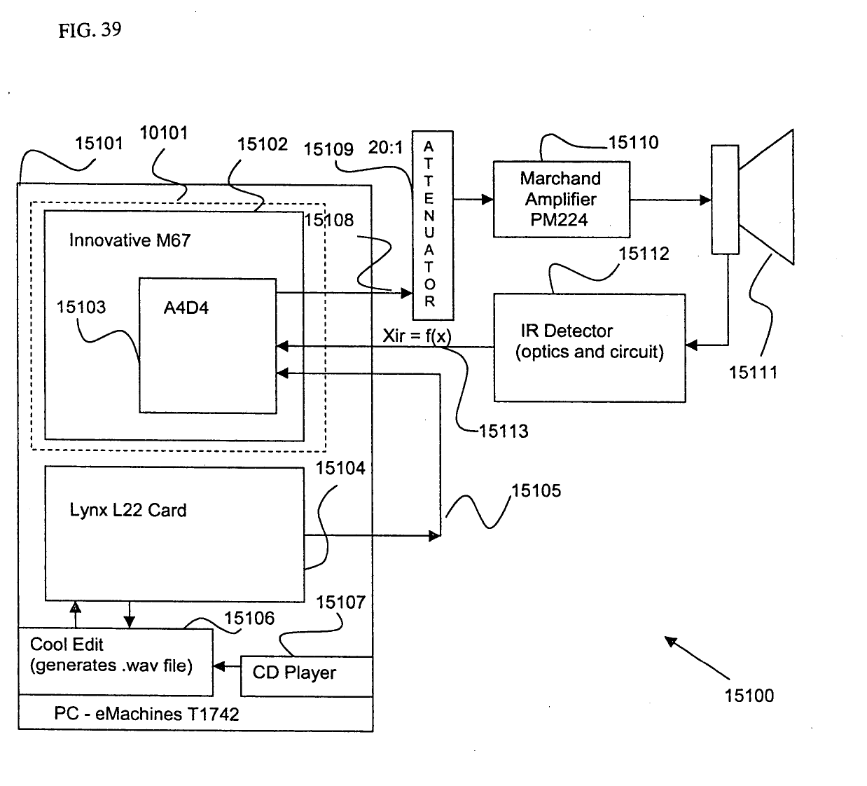

FIG. 39 is a block diagram of a particular embodiment of an audio reproduction system 15100 that includes a DSP based controller 10101. A Personal Computer (PC) 15101, which could be an eMachines T1742, is used as a control and user input environment for the DSP based controller 10101. The DSP based controller 10101 is implemented using a M67 DSP board 15102 and a A4D4 I/O board 15103 both manufactured by Innovative Integration Inc. (Simi Valley, Calif.). The M67 DSP board 15102 is a mother board for the A4D4 I/O board 15103. The M67 DSP board 15102 contains a 106 MHz TMS320C6701 floating point DSP manufactured by Texas Instruments and has been modified to add an inverter (74LS14) between JP14 pin 34 to JP23 pin 29. The A4D4 I/O board 15103 consists of four 16 bit analog-to-digital converters (ADC) and four 16 bit digital-to-analog converters (DAC) with interface circuitry to the M67 DSP board 15102. A Lynx L22 card 15104 manufactured by Lynx Studio Technology, Inc (Newport Beach, Calif.) installed on the PC 15101 provides an audio signal 15105 which is input to the A4D4 I/O board 15103. The Lynx L22 card 15104 receives input via Cool Edit Pro software 15106 (version 2) installed on PC 15101. The Cool Edit Pro software 15106 generates a ‘.wav’ type digital sound file from a music source, which could be a CD player 15107 also installed on the PC 15101. After processing by the DSP based controller 10101, the corrected analog audio signal 15108 is output from the A4D4 I/O board 15103, and provided as an input to a 20:1 attenuator 15109. Output from the attenuator 15109 is provided as input to a Marchand PM224 amplifier 15110 with internal jumpers set to give a DC coupled amplifier. The Marchand PM224 amplifier 15110 is manufactured by Marchand Electronics Inc (Webster N.Y.). The Marchand PM224 amplifier 15110 is used to drive a 3″ transducer 15111 manufactured by Audax (Westlake Village, Calif.). The embodiment of audio reproduction system shown in FIG. 39 uses the IR method of position sensing. An IR detector 15112, the operation of which is described in Details 8 and 13, is used both to measure the position of the coil/diaphragm assembly of the 3″ transducer 15111 and to match the signal to the input stage of the A4D4 I/O board 15103. The output 15113 of the IR detector 15112 is an input to the A4D4 I/O board 15103.

### Detailed Description 10

### Software and Process Flow

The present invention is described in the context of controlling an audio transducer system in part by a software process run on a digital signal processor, or equivalent.

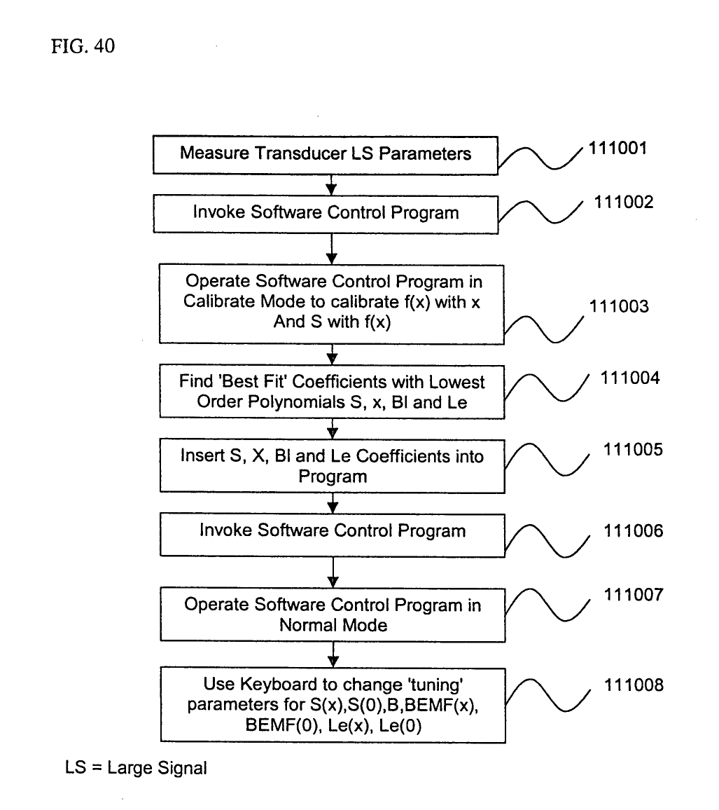

FIG. 40 shows the process flow used to linearize the transconductance component of the signal conditioning process and the transduction process of a given audio transducer, based upon the control model given by equations (36)-(37) in Detail 2 above. FIG. 40 applies also for the case that only a subset of these corrections applied.

In the process illustrated by FIG. 40, the first step 111001 entails measuring large signal (LS) transducer parameters. This step yields coefficients of polynomial interpolations for the functions Bl(x) and Lₑ(x). The measurements are performed using a Klippel GMBH laser metrology system, with procedure as detailed in Klippel System Manual dated May 2, 2002.

In a second step 111002, a software control program is invoked, for example the software control program in file 071119.txt included in the computer program listing appendix provided by the compact disks included with this application. In a third step 111003, the invoked software control program is run in ‘Calibrate’ mode in order to calibrate the functional relation between coil/diaphragm position x and the position-indicator nonlinear state variable, ƒ(x), which in one embodiment of the present invention is the voltage output of the IR circuitry: xᵢᵣ=ƒ(x). During this calibration, the software control program collects corresponding values of x as measured to an approximation by the Klippel laser, and ƒ(x), in relation to the corresponding values of voltage outputs as described in Detail 5 so that the dependence of ƒ(x) with x and the dependence of S with ƒ(x) can be determined.

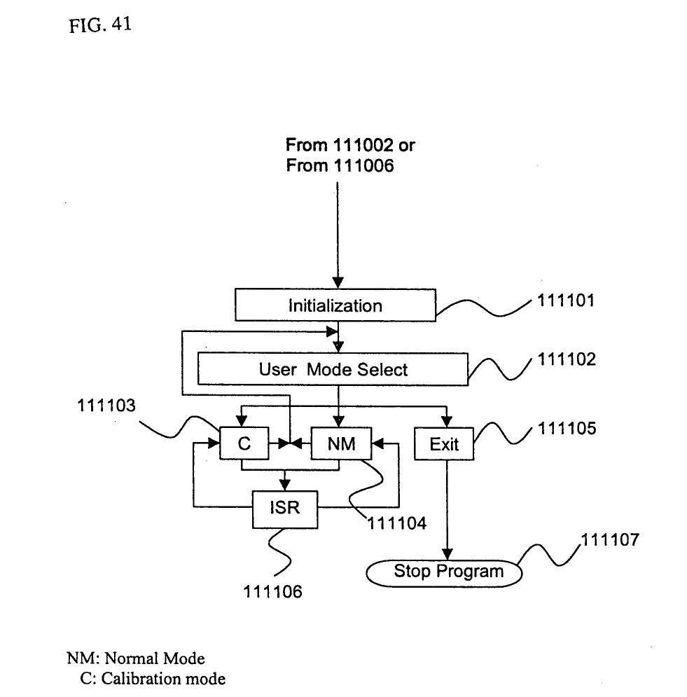

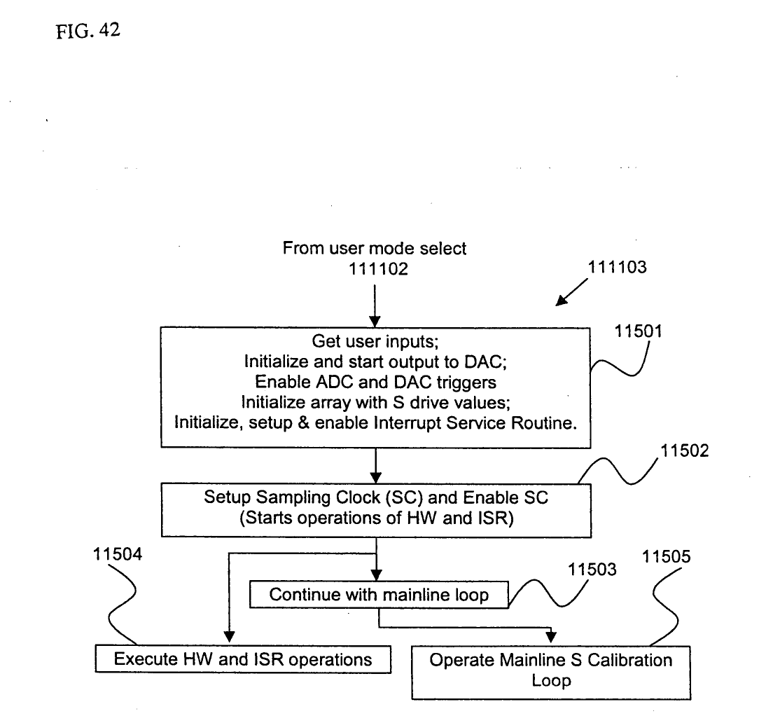

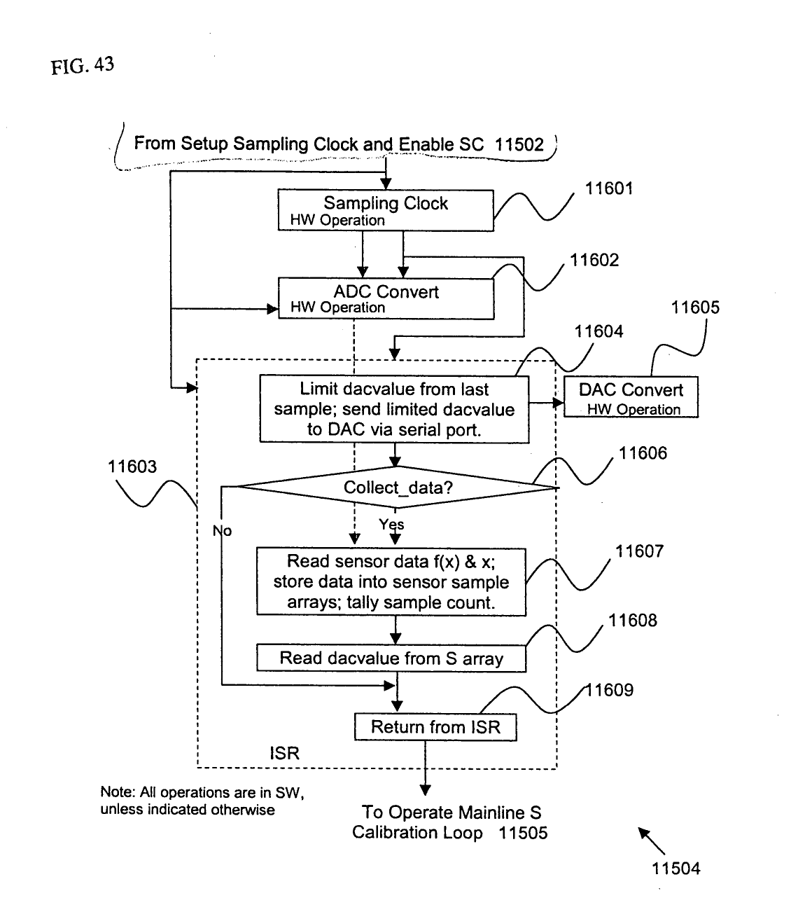

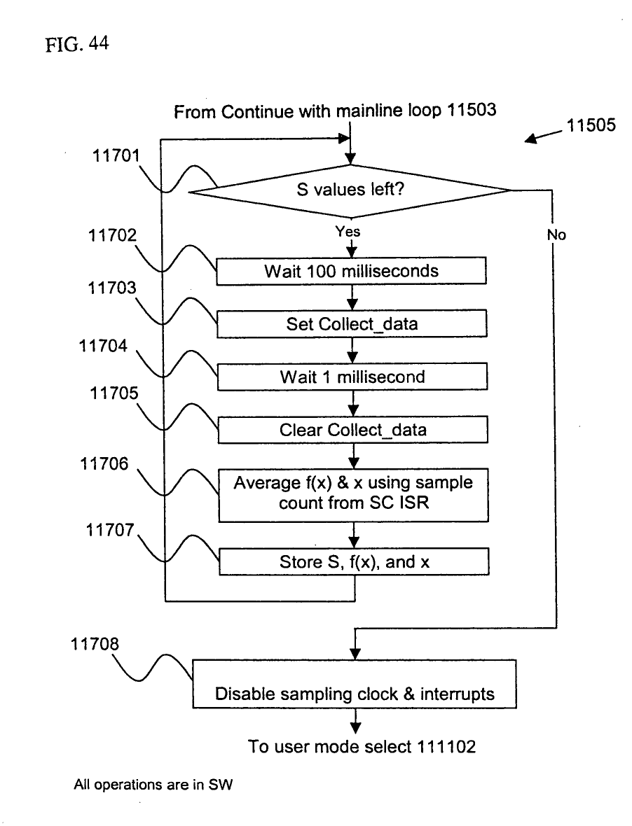

An example of the software control program used in step 111003 is provided by FIG. 41, FIG. 42, FIG. 43, and FIG. 44. The data obtained from steps 111001 and 111003 are used to find Best Fit coefficients for lowest order polynomials of S, x, Bl and Lₑ as functions of xᵢᵣ, as indicated by step 111004. Here ‘Best Fit’ is defined as that curve which is of the lowest order and which does not exceed specified rms and maximum errors, subject to substantial weighting in the mid section of the range of the ƒ(x) variable. More details and specifics on ‘Best Fit’ are provided later in this section. The user then inserts the polynomial coefficients obtained from step 111004 into the Software Control Program—step 111005. Next, user invokes the Software Control Program for Normal operation—step 111006—and operates the program in Normal mode 111007.

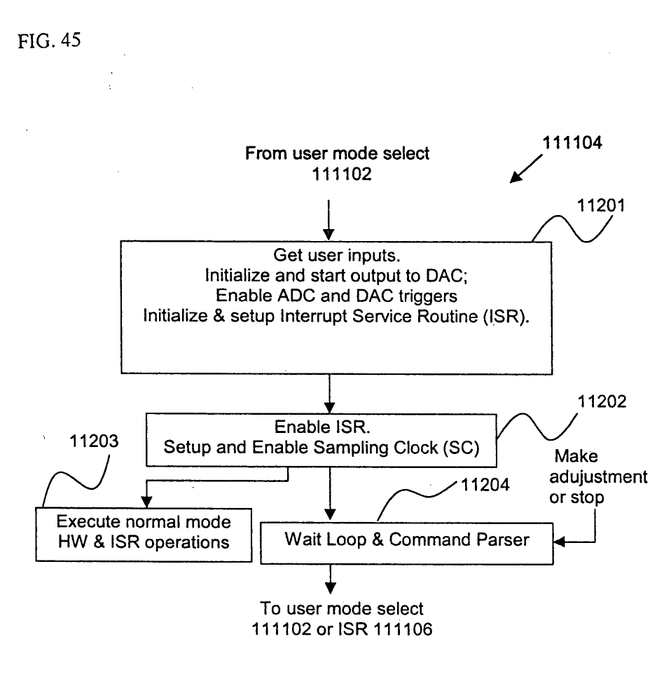

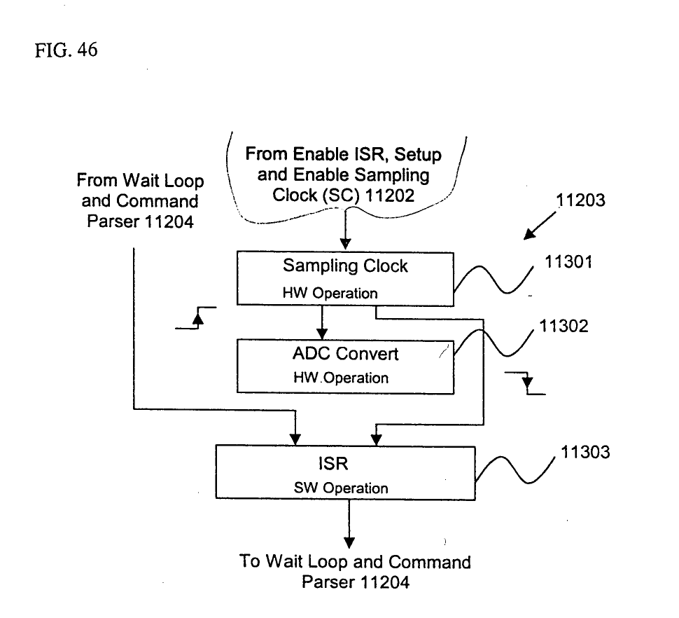

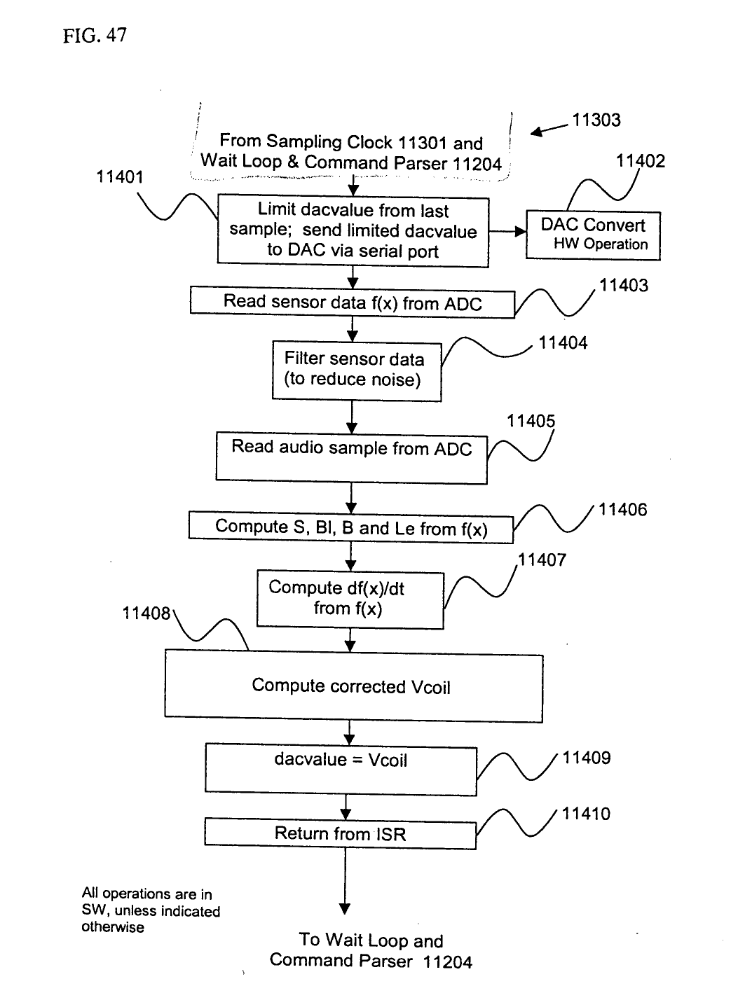

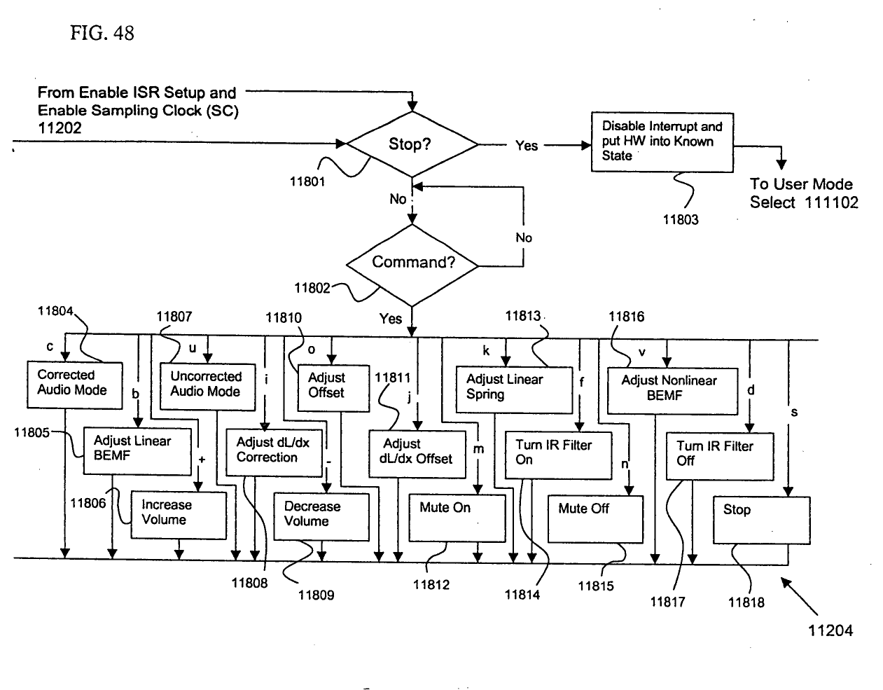

FIG. 41 shows the structure of one embodiment of the Software Control Program that is used both for obtaining data during calibration 111003, and for operating in normal mode 111007 in which linearized sound is produced. The initialization process 111101 places the system in a known state. The software control system can then be selected to operate in calibration mode 111103, which consist of an S and an x calibration process, or to operate in the normal mode 111104. Typically, the first time around the user needs to select the calibration mode 111103, as indicated in 111003. After completion of calibration mode 111103, the system can be selected for normal operating mode 111104, in which the software controls the sound reproduction process through an Interrupt Service Routine (ISR) 111106. Note that the ISR functionality 111106 is also used in calibration mode. On an exit event 111105 prompted by user, the system stops the program 111107. FIG. 45, FIG. 46, FIG. 47 and FIG. 48 cover the normal operation in detail, while FIG. 42, FIG. 43 and FIG. 44 cover the calibration mode in detail; all these figures are described later in this section.

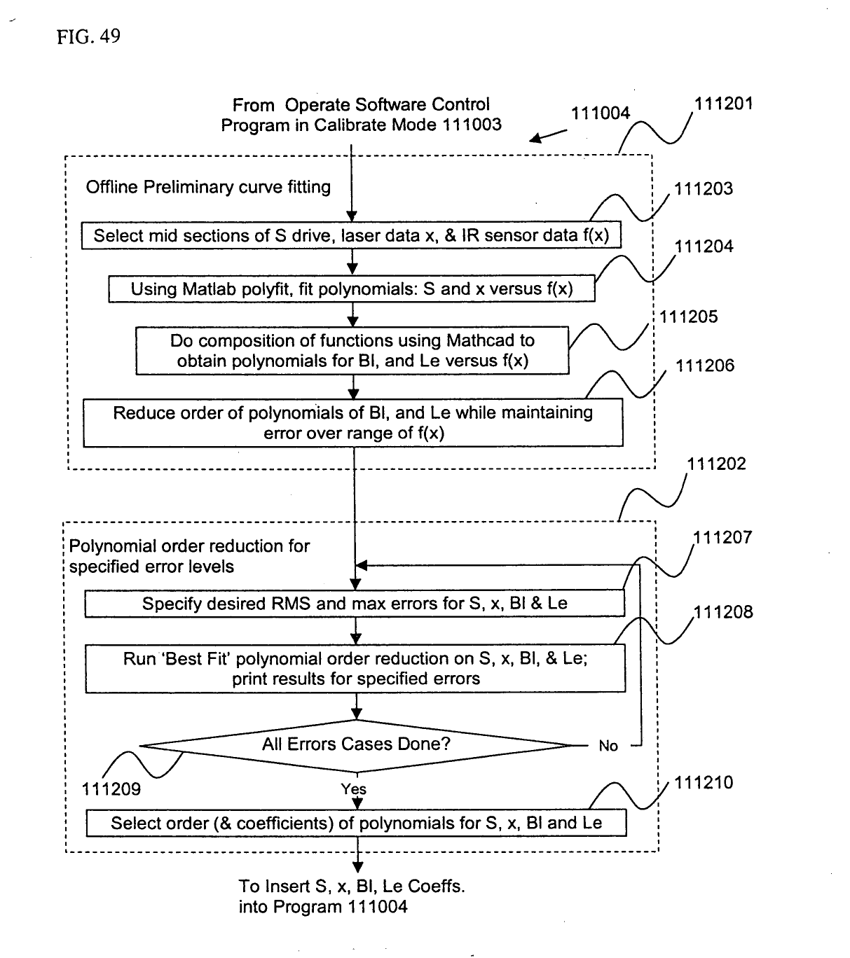

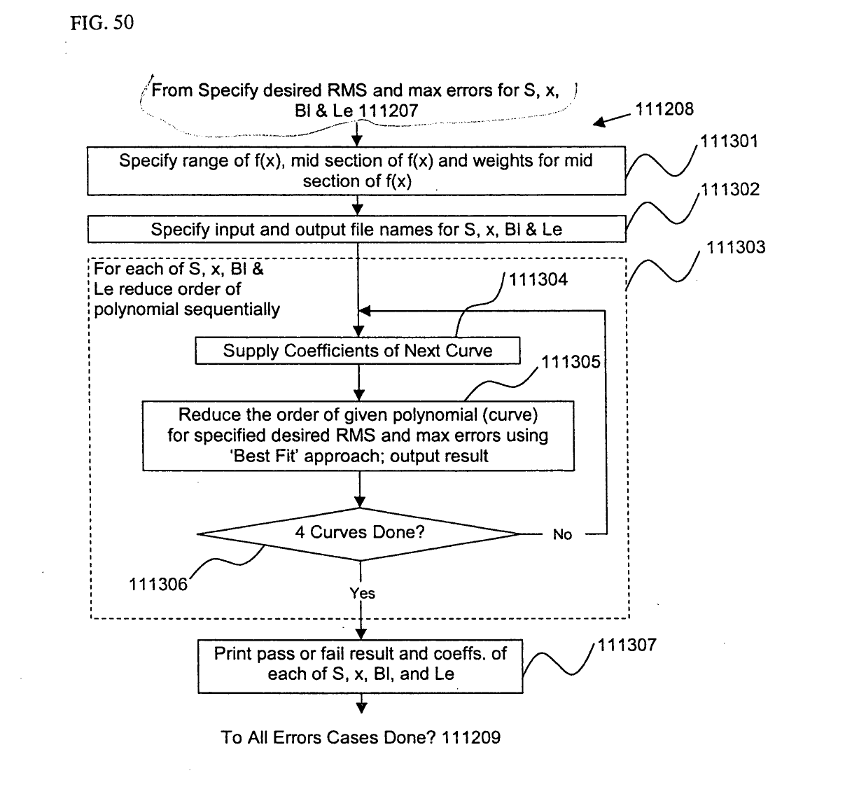

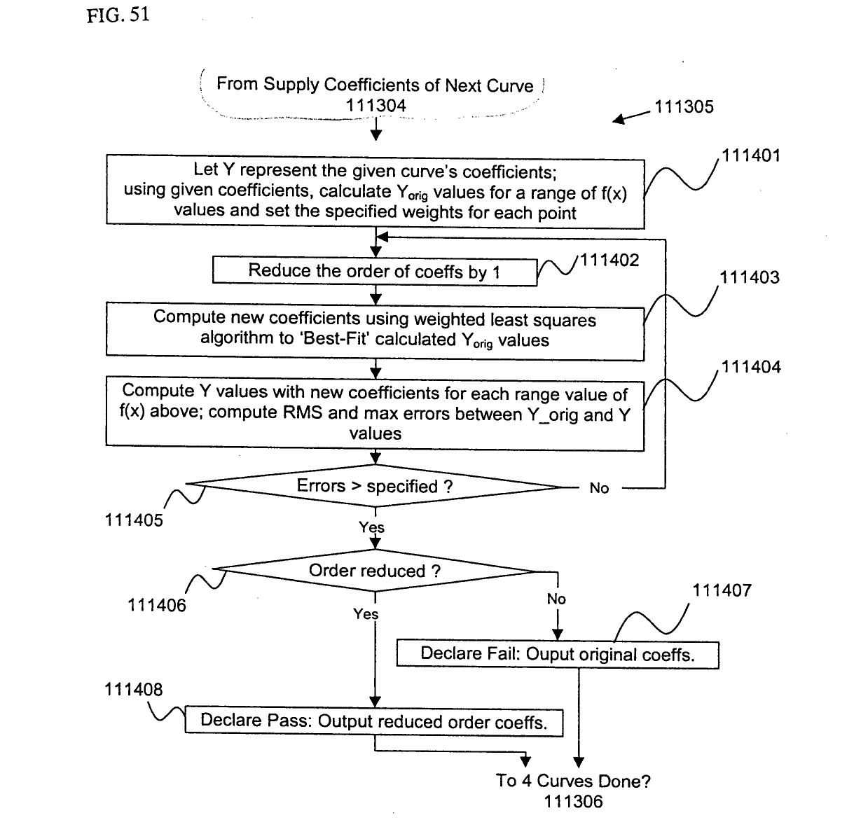

FIG. 49, FIG. 50 and FIG. 51 show the process of obtaining Best Fit Coefficients for S, x, Bl, and Lₑ. FIG. 49 shows offline preliminary curve fitting 111201, and a subsequent reduction of the order of the polynomials 111202 for S, x, Bl, and Lₑ as functions of xᵢᵣ=ƒ(x). As implied by the title of operation 111203, the initial and terminal portions of the ramped-DC-drive values of S (see Detail 5) are discarded, and only the midsection of the S drive values are retained. The purpose of using the midsection is to eliminate transient values, and to obtain a nearly complete hysteresis curve of S versus ƒ(x). Corresponding midsection values of x(the laser output) and ƒ(x) (the IR output) are retained, to be used in operation 111204. As indicated by the title of operation 111204, the ‘polyfit’ function supplied with Matlab is utilized in order to fit two polynomials: S and x, each a different polynomial function of the corresponding position-indicator variable, ƒ(x). Since Bl and Lₑ are provided from step 111001 as functions of the corresponding laser measurement x rather than as functions of xᵢᵣ, operation 111205 entails composing the functional relationships Bl and Lₑ with the function ƒ⁻¹ to yield the functions Bl∘ƒ⁻¹ and Lₑ∘ƒ⁻¹ respectively, in accordance with the notation introduced in Detail 5 above. In other words, namely, Bl and Lₑ are approximated as interpolated functions (polynomials) of xᵢᵣ=ƒ(x). However, these functional compositions result in polynomials that are of high orders, such as 24. Thus, it is advisable to reduce the orders of these polynomials in order to save memory and MIPS resources. Such a reduction is accomplished in operation 111206.

This is done by setting a certain error tolerance (such as 2 or 3 percent), as well as setting a range for xᵢᵣ (based on the maximum and minimum values attained by the monotonic function ƒ(x) as the true position, x, ranges over the maximal coil/diaphragm excursion encountered during normal operation of the given transducer). Once the error tolerance for the given parameter (Bl or Lₑ) is set, each of the monomial terms in the high-order polynomial approximant for that parameter is checked to see whether its maximal absolute value can exceed the tolerance divided by a significance factor such as ten. Those monomial terms which can exceed this bound in absolute value, are retained; while those that cannot exceed it, are discarded. This procedure results in a significant reduction in the order of the polynomial approximations to Bl∘ƒ⁻¹ and Lₑ∘ƒ⁻¹ especially for the former function.
Next, as shown in step 111202, an attempt is made, using the ‘Best Fit’ approach, to reduce the orders of all 4 polynomials: S, x, Bl, and Lₑ. Here the approach is to specify a given amount of root mean square (rms) error, and a corresponding maximum amount of error 111207, and then to run the ‘Best Fit’ polynomial order reduction program 111208 so as to fit polynomials of the lowest order possible without exceeding the specified errors. Before the order reduction program 111208 is put into operation, the polynomial coefficients are initialized to those obtained from the operation 111206. The order reduction algorithm in program 111208, to be described in detail below, is repeated for progressively increasing specified limits upon both rms and maximum error, until values as high as 3% for rms and 15% for the maximum values are reached. Lastly, as indicated by step 111210, coefficients are chosen from one of the following sets. Six rms error values were run: 0.1%, 0.3%, 0.5%, 1.0%, 3.0% and 5.0%. And for each of these rms error values, the maximum desired value was set at 5 times the rms value. The results for the case with rms error 1.0% was chosen as a compromise between low error magnitude and low online computation requirements: smaller values of errors yield higher orders of coefficients, which require a higher amount of online computation.
FIG. 50 provides details of the operations performed by the DSP software in program 111208 in order to reduce the order of the approximate polynomial interpolating functions for S, x, Bl, and Lₑ as functions of xᵢᵣ for the specified rms and maximum error values, while maintaining ‘Best Fit’. In the operation 111301, the user specifies the range of ƒ(x), the midsection of ƒ(x), and a weight for this midsection. For the embodiment described in this section, the following set was chosen, in units of volts for the IR circuit output voltage: a range of [−0.8 to 0.8]; midsection [−0.3 to 0.3]; and a weight of 10 for the midsection, with the rest of the range being assigned the weight of 1. The high weight value (10) chosen for the midsection was motivated by the need to accommodate three requirements: (a) to emphasize a better fit in this predominantly linear section; (b) to account for the fact that the outer section is much larger; and (c) to account for the fact that there are more points in the outer sections than indicated by mere proportion, due to more predominant nonlinearity of S in the outer section (since coil DC voltage, rather than position x, was ramped in equal step-sizes, as shown e.g. in FIG. 22). This weighting results in a better fit in the linear region compared with the fit obtained by a non-weighted approach. Someone skilled in the art will recognize that other choices for range, midsection and weights are possible within the framework of this invention.
Step 111302 is a programming maintenance function (file name specifications). In step 111303, the operations for polynomial order reduction are repeated for S(xᵢᵣ), x(xᵢᵣ), Bl(xᵢᵣ) and Lₑ(xᵢᵣ), with a reduced set of coefficients determined one curve at a time. The process starts with S as the first curve for polynomial reduction, although the process could have equally well began with x, Bl, or Lₑ with identical overall results. Once the order reduction is complete for one curve, the coefficients for the next curve are supplied 111304.
The operations within step 111305 are detailed in FIG. 51. In step 111401, for the given set of coefficients, for example, c₀, c₁, . . . C₉ for a polynomial Y—values of Y_{orig} are calculated as follows:
   Y_{orig}(p)=c₀+c₁p+c₂p²+ . . . +c₉p⁹
For each of several points p in the range given above. The above Y_{orig}(p) values are then used in step 111403 to compute new coefficients, and in module 111404 to compute errors. Here Y_{orig} values: Y_{orig1}, Y_{orig2}, . . . Y_{orig33} are calculated for 33 points p1, . . . , p33 distributed uniformly over the above range. It will be readily recognized that that the number of points used can be changed within the framework of this invention.

In module 111404, the ‘Best Fit’ coefficients are computed as described here and based on a weighted least-squares curve fitting approach used in signal processing [P. M. Embree and Damon Danieli, C++ Algorithms for Digital Signal Processing, Second Ed., 1999, Prentice Hall]. Define a matrix A whose i th row and k th column element is given by Aⱼₖ=wⱼ*pⱼ^{k}, where i is the data point index, k is the power index, and wⱼ is the weight for the point pⱼ. Note that i ranges from 1 to N, where N is the number of data points chosen over the range above, while k ranges from 0 through M, with M being the reduced order for which best fit coefficients are being derived. Note that the data point index starts with 1, while the power or order index starts with 0.

Let zⱼ=wⱼ(Y_{orig})ⱼ, j=1, . . . , N, be the weighted desired output vector, and bₖ, k=0, . . . , M be the reduced order vector of coefficients which needs to be determined. Then the weighted output vector for the points pⱼ for the coefficient column vector b is given by the new column vector Ab. The total weighted squared error between the two weighted vectors is given by:
E=(z−Ab)^{T}(z−Ab)

Taking partial derivatives of E with respect to each of the desired coefficients bₖ and equating to 0 to minimize the error yields, after some linear algebra:
b=(A^{T}A)⁻¹A^{T}z

For module 111403, a Matlab utility has been written that utilizes Matlab's matrix multiplication and matrix inversion functions to compute the b column vector via the above equation. This Matlab program is described in detail below.

Using the above coefficients as the ‘Best Fit’ in the sense of minimizing the above total error, new values of Y_{orig} are calculated as indicated in step 111404. Then, the error between Y_{orig} and Y_{new} is computed, squared, and weighted by corresponding weights. The total is divided by a weighted divisor, i.e a number obtained by taking the total points in the mid section, multiplying it by 10, and adding to it the number of data points outside of the mid section. Taking the square root of the divided result yields the rms value. The maximum magnitude of error between points of Y_{orig} and Y_{new}, is also determined in step 111404.

For the error test in step 111405, if either the rms error or the maximum magnitude error exceeds corresponding specified value, the control goes to the ‘Yes’ branch; else it goes to the ‘No’ branch, to reduce the order further (step 111402) by repeating the above process.

On ‘Yes’, step 111406 checks whether the polynomial order has been reduced; only if the answer is ‘Yes’ on this latter test, does the program declare ‘Pass’ and output the lowest order b vector that had both the rms and maximum magnitude not exceeding corresponding specified values. Otherwise, it declares ‘Fail’ and outputs the original coefficients. The program passes control to the calling program 111306 which tests if any more curves need to be processed for reduction of order while obtaining ‘Best Fit’.

The steps of FIG. 50 and FIG. 51 have been implemented in a program, written in Matlab, which uses the function developed by Tymphany Corporation for module 111403. For a desired error of 1%, and desired maximum error of 5%, the S coefficients could not be reduced from 5^{th} order, and x coefficients could not be reduced from the given 4^{th} order, while Bl and Lₑ were reduced from 9^{th} order to 3^{rd} order. The error for Bl was 0.28% rms and 1.6% maximum, and the error for Lₑ was 0.32% rms and 2.02% maximum. This completes the description of the ‘Best Fit’ approach of step 111004.

The Matlab program developed by Tymphany Corporation to implement module 111403, is named ‘reduce_order_of_XlsrSB_Lcoeffs’. The code is included in the computer program listing appendix on the compact disks included with this application in files: 071115A.txt; 0711115B.txt; 0711115C.txt; 0711115D.txt; 0711115E.txt; 0711115F.txt; and 0711115G.txt. File 071115A.txt lists the main program itself, which calls the filenaming utility function ‘fNmsInOutXlsrSB_Lcoeffs’ (listed in file 0711115B.txt) for the purpose of letting user specify input and output filenames. Next, the main program calls the function ‘reduce_order_of_coeffs’, (file 0711115C.txt) for each of the 4 curves whose order is to be reduced. This function in turn calls ‘WtdLstSqPolyCoeffs’ (file 0711115D.txt), a subfunction that calculates the coefficients according to the weighted least squares approach described above in order to provide the best fit coefficients. In turn, the subfunction ‘WtdLstSqPolyCoeffs’ of file 0711115D.txt calls ‘cnstrct_A_mat_a_z_col’ (listed in file 0711115E.txt) to construct the weighted A matrix and the weighted z column vector needed for calculating the coefficients. The function ‘reduce_order_of_coeffs’ of file 0711115C.txt also calls a plotting routine, ‘plt_data_sup_y3’ (file 0711115F.txt), which plots curves if requested by user. Finally, the program calls the function ‘wr1setRdcdCoeffToOpenFile’ (listed in file 0711115G.txt) four times, in order to write one set of coefficients for each of the four curves.

FIG. 45, FIG. 46, FIG. 47 and FIG. 48 cover the normal mode of operation 111104. FIG. 45 shows an overall flow diagram of normal mode of operation 111104. It shows that upon entry into normal mode 111104, an initialization process 11201 receives the user inputs such as the sampling frequency and the initial audio volume level. Step 11201 initializes the Digital-to-Analog converter (DAC), enables Analog-to-Digital converter (ADC) and DAC triggers, and initializes and sets up the ISR 11203. Step 11202 enables the ISR, sets the sampling rate of the real time clock, and enables it. The enabling of the sampling clock spawns the process: execute normal mode HW & ISR operations 11203. The software then enters a wait loop and command parser 11204, where it waits until an interrupt occurs, or the user issues an adjustment or stop command.

FIG. 46 shows the operations of process 11203 that are spawned as a result of enabling the sampling clock and ISR in 11202. These elements are spawned in parallel with the mainline operation. Note that the three processes: Sampling Clock 11301, ADC Convert 11302, and the ISR 11303 are activated essentially in parallel. However, ADC convert 11302 starts on the rising edge of sampling clock 11301, while ISR 11303 starts on the falling edge of the sampling clock 11301. Moreover, when the falling edge of sampling clock 11301 occurs, the ISR 11303 uses the most recently converted sample from ADC convert 11302. The Sampling Clock 11301 is typically set at 48 kHz, although any frequency above the Nyquist frequency for audio (typically above 40 kHz) can be chosen. The sampling clock 11301 runs as an autonomous hardware loop, operating until powered down, or disabled by the software control program. In every period the ADC Convert module 11302 samples and converts an analog stream representing the sensor measurement of the position-indicator state variable and the audio source. The ISR 11303 operates on the converted data provided by ADC convert 11302.

FIG. 47 shows a flow diagram of the ISR 11303. When the negative edge of the sampling clock occurs, the software control passes from the wait loop and command parser 11204 to step 11401. Step 11401 limits the value of the word to be sent to the DAC 11402, so that it does not exceed the input range of the DAC 11402. The DAC can be an onboard DAC as it is with the Innovative Integration A4D4, or a serial port based off board DAC. The analog signal that is created is the corrected audio signal V_{coil}, and is fed to a power amplifier 10106. To create the corrected audio sample, the ISR module 11303 uses IR sensor data ƒ(x) from module 11403 and audio data from module 11405. A digital filter 11404 is used to minimize sensor noise in the measurement of ƒ(x). Module 11406 computes S, B, and Lₑ corrections from the filtered value of ƒ(x) 11404, as described below.

In the above description, before module 11406 computes S, B, and Lₑ, the input ƒ(x) read from ADC in module 11403 is scaled to volts by dividing the value of ƒ(x) by 3,276.7. The divisor 3,276.7 was chosen because of the DAC resolution. The onboard DACs of the Innovative Integration M67 are 32767 counts/10 volts. If an off board 1V DAC is used, the divisor would be 32,767 (32767 counts/1V). This approach also facilitates computation of the total correction such that the accuracy of correction is maintained at large values of audio input without exceeding the input requirements on DAC. However, the magnitudes of the coefficients of S, B, Lₑ may exceed 1; all polynomial coefficients are floating-point numbers.

The corrected audio signal V_{coil}, calculated by a combination of actions by modules 11406, 11407 and 11408, is derived from input audio signal and the value of filtered ƒ(x) using the following eight equations:
Bl=Bl₀+Bl₁ƒ(x)+Bl₂(ƒ(x))²+Bl₃(ƒ(x))³ (52)
S=S₀+S₁ƒ(x)+S₂(ƒ(x))²+ . . . +S₅(ƒ(x))⁵−kƒ⁻¹(ƒ(x))/Bl (53)
x_{c}=(x_{c})₀+(x_{c})₁ƒ(x)+(x_{c})₂(ƒ(x))²+(x_{c})₃(ƒ(x))³ (54)
Lₑ=L₀+L₁ƒ(x)+L₂(ƒ(x))²+L₃(ƒ(x))³ (55)

$$\begin{matrix}{x}^{\hat{•}} ( t ) = α {x}^{\hat{•}} ( t - τ ) + β ( {f}^{- 1} ( f ( {x}_{c} ( t ) ) ) - {f}^{- 1} ( f ( {x}_{c} ( t - τ ) ) ) ) & ( 56 ) \\ BEMF = ( {K}_{V1} Bl - {K}_{V2} / Bl ) {x}^{\hat{•}} ( t ) & ( 57 )\end{matrix}$$

V₁(t)=S+V_{audio}(t)/Bl+BEMF (58)
V_{coil}(t)=V₁(t)+(K_{I1}Lₑ−K_{I2}L₀)(V₁(t)−V₁(t−τ)) (59)

where: V_{coil}, is the corrected voltage signal applied across the voice coil and including all four corrections (S, B, BEMF and Lₑ); V₁ is the corrected voltage without the inductive correction; V_{audio} is the audio input voltage signal, suitably normalized; t and τ denote the current time-step and the sampling time, respectively; and the constant k in the subtraction term in the polynomial expansion for S (last term on right-hand side of equation (53)) is the electronic linear spring stiffness remaining after the linearizing filter (see Details 2 and 5 above). It is used in the calculation of S in order to maintain an appropriate level of restoring force in a transducer (see Detail 5 above); without this restoring term, the transducer would become unstable.

Equation (54) is a correction applied to linearize the IR position indicator state variable xᵢᵣ=ƒ(x) if necessary. Equation (55) is the correction for nonlinear inductance Lₑ.

Equation (56) is a digital filter designed to estimate the velocity of the transducer needed for the BEMF correction. Equation (57) calculates the required BEMF correction. The BEMF correction comprises two components: the removal of the nonlinear BEMF and the replacement with a linear BEMF. The equations incorporate a multiplier for each term to allow for fine adjustment of the correction. Equation (58) and (59) implements the above components of the audio correction.

It will be appreciated that there are many different ways of discretizing the numerical differentiation operation of the control diagrams FIG. 11 and FIG. 12, and that the implementation of these numerical differentiations used in one embodiment of the invention, and shown in equations (56) and (59), represent but one possible choice.

Digital filters may be added to equation (59) for smoothing, equalizing and noise reduction. The polynomial coefficients as well as the powers of filtered ƒ(x) are stored in arrays, so that the needed sum of products can be easily computed. Moreover, the array for powers of filtered ƒ(x) may be constructed recursively, again reducing the computational cost.

Finally, module 11410 executes a return from ISR, which passes the software control to the wait loop 11204; and the process then repeats, unless stopped by a ‘Stop’ command to the wait loop 11204 which resides in the normal mode 111104.

FIG. 42, FIG. 43 and FIG. 44 show flow diagrams of S and x versus ƒ(x) calibration 111103.

For calibration, the mainline loop is finite (while that in normal mode is infinite) and results in a tabulated output, from which a polynomial curve is fitted and polynomial coefficients extracted for use in the Normal Mode 111104.

FIG. 42, FIG. 43 and FIG. 44 illustrate S and x calibration 111103. FIG. 42 shows the overall flow diagram of S and x versus ƒ(x) calibration. An array is initialized with S values that will be used as S drive for calibration. The magnitude of the S drive should be large enough to drive the transducer close to its maximal and minimal x excursions. The operations in FIG. 42 are similar to those in FIG. 45. Here, instead of a wait loop and command parser 11204, the diagram shows the mainline S calibration loop 11505. The rest of the corresponding description applies, and is thus not repeated.

FIG. 43 shows the details of HW and ISR operations for S calibration 11504. It depicts Sampling Clock 11601 and ADC Convert 11602, which are similar to corresponding modules in FIG. 113; the same description applies, and is thus not repeated. Modules 11604 and 11605 limit and convert the digital values to analog waveform. Module 11606 tests whether the data is to be collected. During calibration mode, the mainline S calibration loop 11505, detailed below in FIG. 44, sets and clears the flag ‘Collect_data’. If this flag is set, the data collection proceeds as done by the module 11607, and a sample count is tallied. Also, module 11608 reads S value from the array, to be used in the variable ‘dacvalue’. If the flag is not set, these two modules are bypassed. Module 11609 executes the return from ISR.

FIG. 44 shows the details of mainline S calibration loop 11505. Module 11701 checks whether any value of S is left with which to operate the loop. If there is one, it executes the path comprising modules 11702 through 11707 to send out the S value via the ISR 11603, and to collect the corresponding value of ƒ(x) and x as follows. Module 11702 executes a wait of 100 milliseconds to allow the transients in the transducer to attenuate. Module 11703 sets the ‘Collect_data’ flag which signals the ISR 11603 to collect data. Module 11704 allows 1 millisecond to collect samples, which at 48 kSPS collects 48 samples. These samples suffice to give a good reading of ƒ(x), the IR data and x, the laser data. Module 11706 performs averaging, and the module 11707 stores S, ƒ(x) and x for offline curve fitting. As long as there is an S value to be covered, the process continues.

To ensure reliable calibration, the values in the arrays are such that each point of S is covered at least twice, each at very different instances of time. In one approach used, the calibration of S is started at 0, and increased in steps until an upper limit is reached, and then decreased in steps until a lower (negative) limit is reached. Again it is increased until the top limit is reached. From the top limit, it is decreased in steps until the negative limit is reached. From the negative value, S is increased in steps until it returns to 0. Thus it forms a W pattern.

When all the values stored in an S array are covered, the mainline loop for S commences a termination procedure, as shown in the module 11708. Here the sampling clock is disabled, which stops the operations of ADC convert 11602 and the ISR 11603.

FIG. 48 illustrates the details of the Wait Loop and Command Parser 11204, shown in FIG. 45, which is abbreviated below as WLCP. The system enters into the 11801 step of WLCP from Enable ISR Setup and Enable Sampling Clock 11202; in step 11801 it is determined whether Normal Mode operation should stop. If ‘Yes’, system enters into step 11803, in which Interrupt is disabled and the HW is put into a known state; then system is passed out of WLCP and into User Mode Select 111102. But if the answer to the ‘Stop?’ query (step 11801) is ‘No’, the DSP passes to step ‘Command?’ 11802, in which the WLCP checks to see whether User has entered a keyboard command since the last check (checks are spaced several microseconds apart during the Wait Loop). If no new keyboard command has been entered during the most recent such time interval, this is interpreted as a ‘No’ response to the ‘Command?’ query , and the system is looped back to this ‘Command?’ query 11802. But if and when WLCP finds that a new keyboard command has been entered during the most recent time interval, each of the following optional keyboard responses are interpreted by WLCP as a ‘Yes’ and acted upon. User keyboard response ‘c’ causes the DSP to begin implementing corrections: ‘Corrected Audio Mode’ 11804; after this mode is entered, the system is passed back to the ‘Stop?’ query 11801. User keyboard response ‘b’. causes the DSP to enter the mode ‘Adjust Linear BEMF’ 11805, from which it is again returned to ‘Stop?’ query 11801. The following are the remainder of the allowed keyboard responses, and their effects. Response ‘+’ puts the DSP into mode ‘Increase Volume’ 11806, from which it returns to ‘Stop?’ query 11801; similarly, response ‘−’ puts DSP into mode ‘Decrease Volume’ 11809, and thence to ‘Stop?’ query 11801. Response ‘u’ puts DSP into ‘Uncorrected Audio Mode’ 11807, and thence to ‘Stop?’ query 11801. Response ‘i’ puts DSP into mode ‘Adjust dL/dx Correction’ 11808, and thence to ‘Stop?’ query 11801. Response ‘o’ puts DSP into mode ‘Adjust Offset’ 11810, and thence to ‘Stop?’ query 11801. Response ‘j’ puts DSP into mode ‘Adjust dL/dx Offset’ 11811, and thence to ‘Stop?’ query 11801. Response ‘m’ puts DSP into mode ‘Mute On’ 11812, and thence to ‘Stop?’ query 11801. Response ‘k’ puts DSP into mode ‘Adjust Linear Spring’ 11813, and thence to ‘Stop?’ query 11801. Response ‘f’ puts DSP into mode ‘Turn IR Filter On’ 11814, and thence to ‘Stop?’ query 11801. Response ‘n’ puts DSP into mode ‘Mute Off’ 11815, and thence to ‘Stop?’ query 11801. Response ‘v’ puts the DSP into mode ‘Adjust Nonlinear BEMF’ 11816, and thence to ‘Stop?’ query 11801. Response ‘d’ puts DSP into mode ‘Turn IR Filter Off’ 11817, and thence to ‘Stop?’ query 11801. And finally, a User response ‘s’ puts the DSP into ‘Stop’ mode 11818, from whence the system is returned to ‘Stop?’ query 11801. It should be noted that all processes within the Wait Loop and Command Parser, are interruptible by ISR 11303. The C programming language code implemented in the DSP is provided in file 071119.txt on the compact disks of the computer program listing which is a part of this application.

### DETAILED DESCRIPTION 11

### Zₑ Methods and Circuits

The present invention is described, in one aspect, in the context of controlling an audio reproduction system, in part by a system, consisting of methods and electronic circuits, which provide at least one position-indicator transducer state variable derived from effective circuit parameters of the transducer during operation.

In particular the position-indicator state variable, ƒ(x), utilized in this embodiment of the invention is an output voltage derived from the functional dependence of the effective complex coil impedance Zₑ(ω,x) upon coil/diaphragm position x, at some fixed supersonic probe frequency ω. The physical effects which give rise to this functional dependence, along with a mathematical model developed to simulate them, in accordance with the present invention, are described in Details 1 and 6. This embodiment is called the Zₑ method, in this section we elaborate on the methods and circuits used to implement the Zₑ method.

In the description below, the o dependence of Zₑ(ω,x) is suppressed, and this function is denoted simply as Zₑ(x).

One method of detecting and measuring the dependence of impedance Zₑ(x) upon x is to place the transducer voice coil within a potential divider circuit. Changes in the magnitude of Zₑ(x) due to variation in coil/diaphragm position x cause corresponding relative changes of voltages in the potential divider circuit, which are measured electronically.

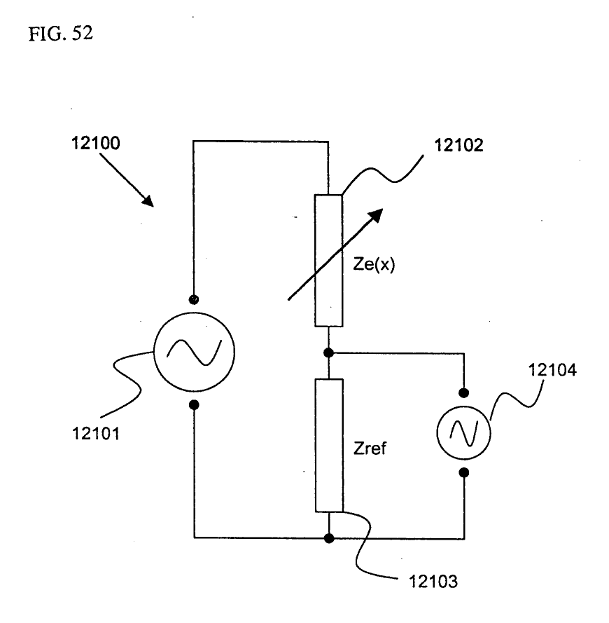

FIG. 52 shows a block diagram of a potential divider circuit 12100. An exciting signal, a probe tone 12101 at a fixed frequency and fixed amplitude, is connected across a potential divider consisting of the transducer voice coil 12102 and a reference impedance Z_{ref} 12103.

The magnitude of the output voltage 12104 across the reference impedance 12103 is a fraction of the magnitude of probe tone voltage 12101, depending on the relative impedances of the transducer voice coil 12102 and the reference impedance 12103. As the impedance of the voice coil 12102 changes with position, so does the magnitude of the output signal 12104.

In the context of an audio transducer, the input signal to the voice coil will include audio information (program material) together with the probe tone. It is therefore necessary to separate the probe tone and program material in frequency, so that the probe tone measurement is not interfered with by the audio drive signal. The Nyquist criteria suggests that the probe tone 12101 should have a frequency of at least twice the audio frequency bandwidth, to avoid aliasing with the program material. A probe tone having a frequency of 43 kHz has been found to be particularly desirable. However, many other frequency values could be used.

In summary, a desirable implementation utilizes a potential divider measurement system that is filtered to separate out the contributions of the audio program material and of the ultrasonic probe tone frequency. The filtered probe tone 12101 is then envelope-detected and reduced to an audio frequency signal, which varies as Zₑ(x) changes due to the voice-coil motion created by the transducer in response to the audio input signal.

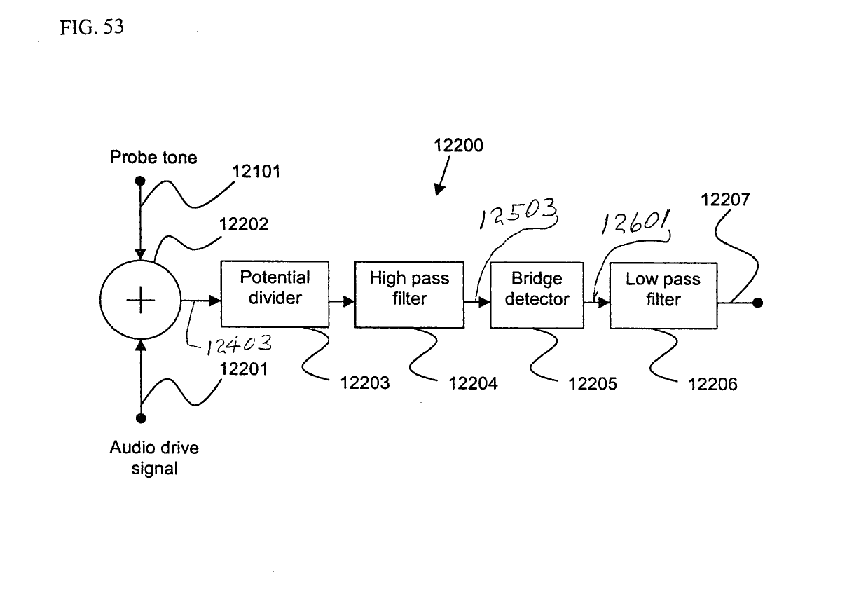

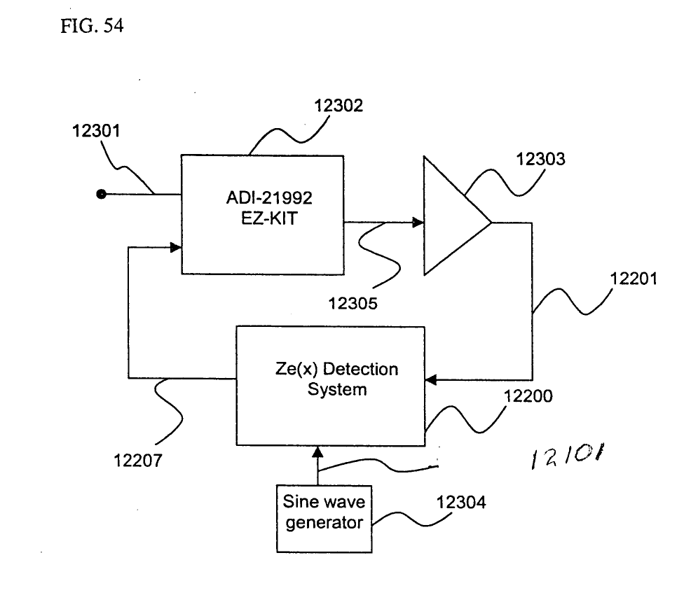

FIG. 53 shows a block diagram of the Zₑ(x) detection system 12200. The probe tone 12101 is added to the audio drive signal 12201 in a summing circuit 12202. The summed signal excites a potential divider 12203, which includes the transducer voice coil 12102. The output signal from the potential divider 12203 is input into a high pass filter 12204, that removes the audio signal, leaving the 43 kHz probe tone signal. The output signal from the high pass filter 12204 is provided as an input signal to a full wave bridge detection circuit 12205. The output signal from the full wave bridge detection circuit 12205 is in turn smoothed by a low pass filter 12206, the output of which is a signal 12207 which contains positional information based on the change of the voice coil effective impedance. FIG. 54 shows a block diagram of a control circuit for transducer linearization, which includes the Zₑ(x) detection circuit 12200 (FIG. 53). An incoming audio signal 12301 is converted into digital form and input to a DSP, for example, using the mixed signal device 12302 which may be, for example, implemented by an Analog Devices ADI-21992 EZ-KIT; this includes analog-to-digital inputs, a DSP core, and digital-to-analog outputs. The Zₑ(x) signal 12207 is also provided as an input to and converted by the mixed signal device 12302. The DSP core runs the linearization algorithm, with the Zₑ(x) signal 12207 as the positional signal. The corrected audio signal 12305 is an input signal to amplifier 12303, which produces the audio drive signal 12201, which is in turn provided to the Zₑ(x) detection system 12200. The probe tone 12101 is input to the Zₑ(x) detection system 12200 from a sine wave generator 12304. The sine wave generator 12304 preferably has a low impedance output, for example below 1.0 Ohm.

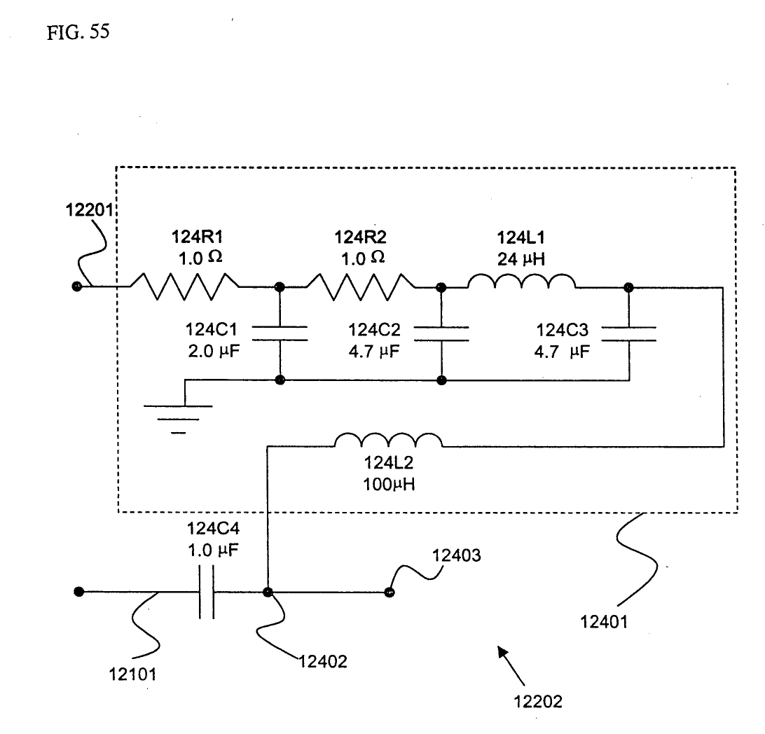

FIG. 55 shows a circuit diagram of the summing circuit 12202. The audio drive signal 12201 is provided as an input to filter 12401 which isolates the probe tone 12101 from the low impedance of the audio amplifier output. The filter 12401 is composed of resistive, capacitative, and inductive elements, as indicated in FIG. 55. The probe tone 12101 is provided to a capacitor 124C4, which in turn is connected to the summing point 12402. Capacitor 124C4 decouples the audio drive signal at the summing point 12402 from the low impedance output of the sine wave generator 12304. The signal at the summing point 12402 is provided at output terminal 12403 which is connected to an input of the potential divider circuit 12203.

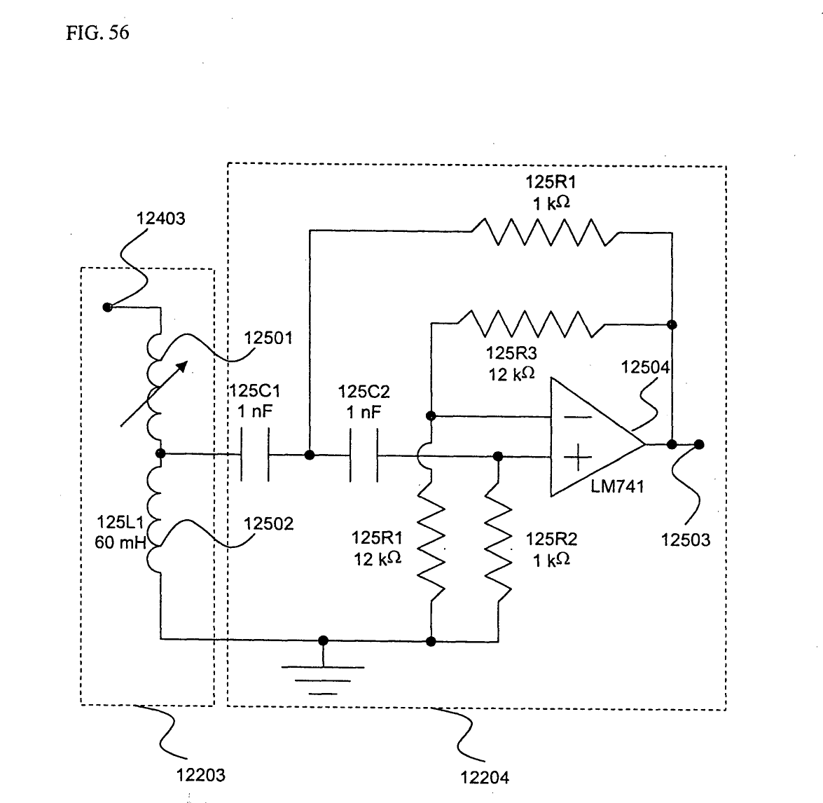

FIG. 56 shows the circuits of the potential divider 12203 and the high pass filter 12204. The summed output 12403 excites the potential divider 12203, which includes the voice coil 12501 of the transducer being used in the audio system, and a reference inductor 12502. The proportional excitation across the reference inductor 12502 is input to the capacitor 125C1 of the high pass filter 12204. The high pass filter 12204 may be, for example, a standard 2nd order Butterworth filter, designed to discriminate against the audio signal and pass the 43 kHz probe tone. Operational amplifier 12504 may be, for example, a National Semiconductor part LM741. The filter has as its output the filtered 43 kHz signal 12503. One skilled in the art will recognize that many different circuit arrangements could be used for the high pass filter 12204, and that the standard circuit shown here is only one example.

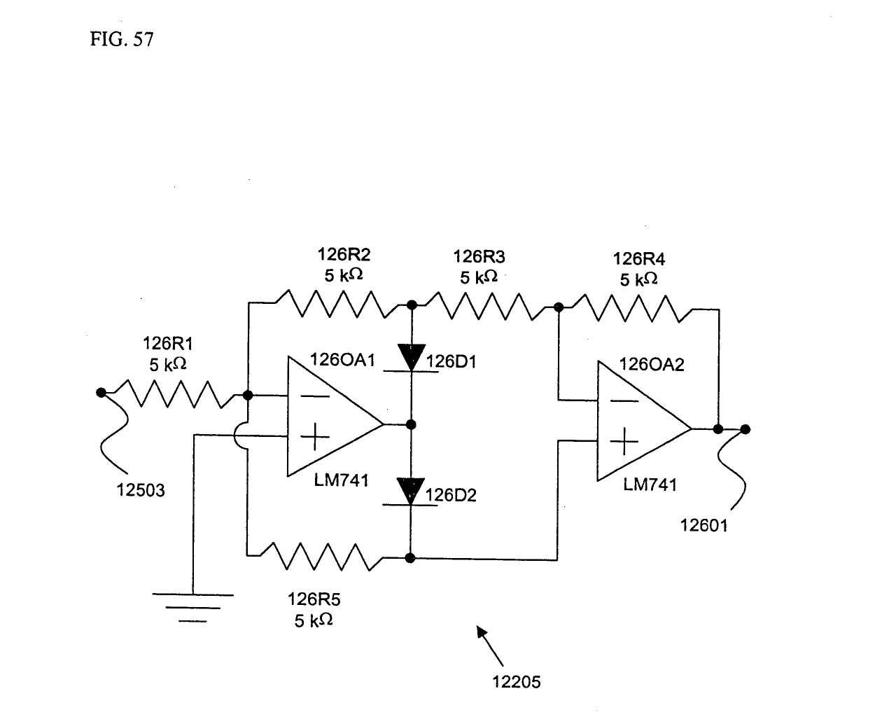

FIG. 57 shows the circuit of the full wave bridge detector circuit 12205. This is a standard circuit that rectifies the filtered 43 kHz signal 12503 and outputs a full wave rectified signal 12601. Operational amplifiers 1260A1 and 1260A2 may be implemented by National Semiconductor part LM741 devices. One skilled in the art will recognize that many different circuit arrangements could be used for the full wave bridge detection circuit 12205 and that the standard circuit shown here is only one example.

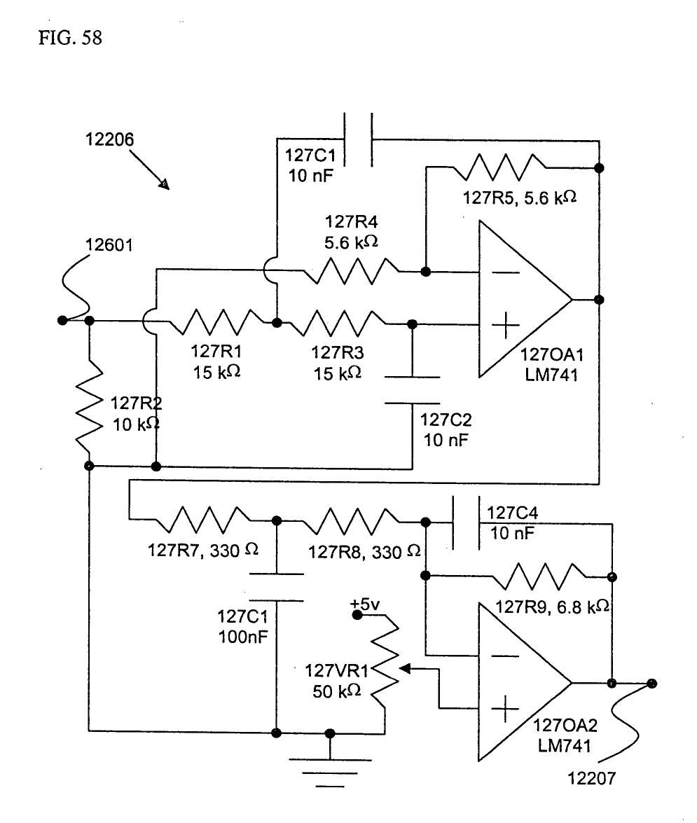

FIG. 58 shows the circuit of the low pass filter 12206. The first part of the low pass filter, incorporating the operational amplifier 1270A1, is a standard 2nd order Butterworth low pass filter. The second part of the filter is an inverting amplifying stage which includes operational amplifier 1270A2 and a variable resistance 127VR1 that produces a DC offset in the output signal. This offset is set to reduce the DC offset in the magnitude of the probe tone that has been detected. The gain of the inverting amplifying stage is set to enhance the signal significance when it is converted to digital form. One skilled in the art will recognize that many different circuit arrangements could be used for the filter, gain and offset circuit, and that the rather straightforward circuit shown in FIG. 58 can be modified without changing the essence of the design. Operational amplifiers 1270A1 and 1270A2 may be National Semiconductor part number LM741.

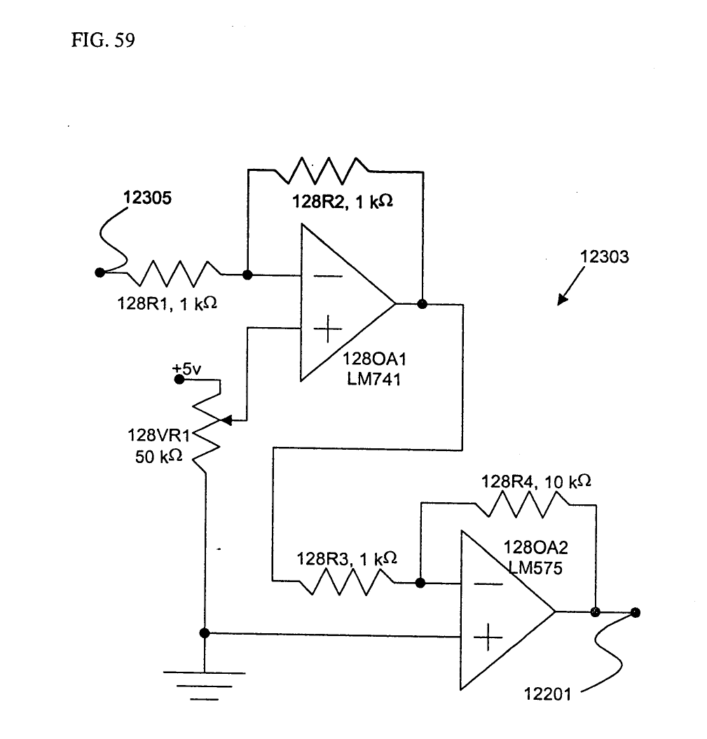

FIG. 59 shows the circuit of the audio amplifier 12303 of FIG. 54 in more detail. The corrected audio signal 12305 received from the ADI-21992 EZ-KIT 12302 is a positive unipolar signal and must be offset to a signal oscillating about zero for output as audio. The requisite offset is achieved by utilizing an inverting operational amplifier 1280A1, which may be, for example, a National Semiconductor part LM741, in a unity gain stage, with offset provided by a variable resistor 128VR1 connected to a positive voltage. A power operational amplifier 128OA2, for example a National Semiconductor part LM575, is used to amplify the corrected audio signal 12305 and drive the speaker 10108 with the audio drive signal 12201. One skilled in the art will recognize that many different circuit arrangements could be used for the offset circuit and audio amplifier, and that the rather straightforward circuit shown in FIG. 59 can be modified without changing the essence of the design.

The filter based method used in the Zₑ(x) detection circuit 12200 and shown in FIG. 54, is sensitive to changes in output impedance of the audio amplifier 12303. For example, with a low impedance load, some types of amplifiers exhibit large crossover distortion effects, which in effect are a change in output impedance. This change in output impedance can cause noise in the Zₑ(x) measurement. Furthermore, in transducers driven with large currents there can be considerable heating effects in the coil. This produces a change in the Ohmic resistance Rₑ which is misinterpreted by the Zₑ(x) detection circuit 12200 as a change in position (this is discussed in Detail 6 above). Someone skilled in the art would recognize that a more complex circuit is required to separate out these two effects for the full range of transducers, but that this would not materially change the invention detailed here.

It will be apparent to those skilled in the art that the particular position-indicator state variable ƒ(x) described in this section and in Detail 6, which is derived from the functional dependence of the effective complex coil impedance Zₑ(ω,x) upon coil/diaphragm position x at some fixed supersonic probe frequency ω, can be used within various embodiments of a feedback linearization control system according to the present invention, in which the positional information ƒ(x) is used in various different ways, including but not limited to one or more of the control laws presented in Details 2 and 10 above.

### DETAILED DESCRIPTION 12

### C Methods and Circuits

The present invention is described, in one aspect, in the context of controlling an audio reproduction system, in part by a system, consisting of methods and electronic circuits, which provide at least one position-indicator transducer state variable derived from effective circuit parameters of the transducer during operation.

In particular the position-indicator state variable, ƒ(x), utilized in this embodiment of the invention is an output voltage derived from the internal parasitic capacitance C_{parasitic} between the transducer voice-coil and the transducer magnetic pole structure. The method utilizes the functional dependence C_{parasitic}(x) of this capacitance upon the axial position of the transducer's coil/diaphragm assembly as a positional sensor. The measurement theory for C_{parasitic}(x) was described, quantified and explained in Detail 7. This embodiment is called the C method. In this section we elaborate on the methods and circuits used to implement the C method.

FIG. 34 shows a schematic cross section of a typical cell phone speaker or receiver 13100; actual three-dimensional speaker geometry is a figure of revolution about the central horizontal axis of symmetry (not shown). Speaker 13100 consists of a transducer and integral acoustic venting. A voice coil 13101 is mounted on the diaphragm 13102. Coil 13101 is positioned in the gap between a neodymium magnet 13103 and a magnetic base plate 13104. A plastic surround 13105 supports the diaphragm 13102 and a face plate 13106. The surround and face plate have acoustic vents 13107 which tune the frequency response of the speaker 13100. The depth, indicated in FIG. 34 by D1, is typically 2 mm. The main difference between this type of transducer assembly and the transducer shown in FIG. 3 is the single surrounding support of the relatively flat diaphragm 13102. This means that the system is resistant to the tilt (“canting”) which can complicate capacitance position-sensing methods in other transducers as described in Detail 7.

The preferred method of detecting the variation of capacitance with coil/diaphragm axial position, C_{parasitic}(x), is to place the capacitance within an oscillator circuit. Changes in C_{parasitic}(x) due to changes in coil position are then the cause of changes in the oscillator frequency. A frequency-to-voltage converter is then used to yield a varying signal which is a function of the parasitic capacitance. The varying signal can be identified with C_{parasitic}(x) in suitable units. Thus as defined C_{parasitic}(x) can be identified with the position-indicator state variable, ƒ(x),

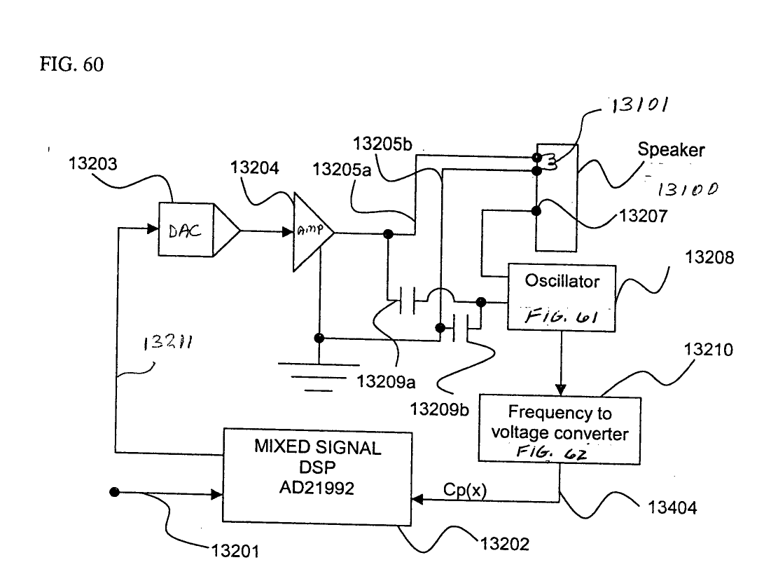

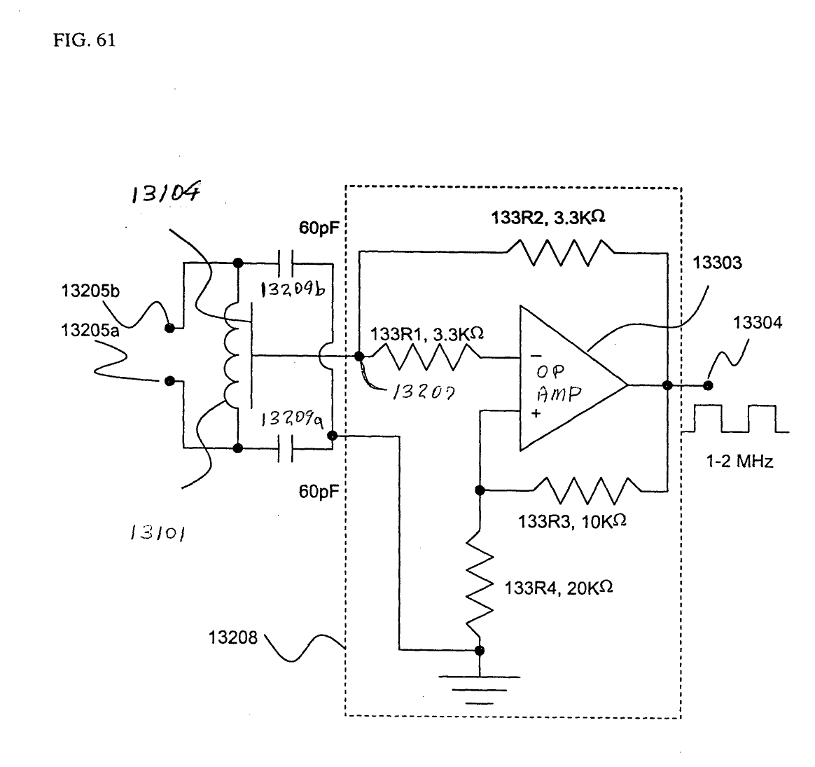

FIG. 60 shows a schematic of the capacitance detector and speaker arrangement, together with the DSP used for correction. An analog audio signal, provided over input line 13201, is digitized by DSP based mixed-signal controller 13202. Mixed-signal controller 13202 is embodied by a AD21992 chip which includes an ADC (analog voltage to digital) converter. The output of the DSP based controller 13202 is connected to a standard DAC (digital to analog voltage) converter 13203. The output of the DAC 13203 is amplified by a DC- connected audio amplifier 13204. The output of amplifier 13204 has a drive connection 13205a to one terminal of the voice coil 13101 of the speaker 13100. The magnetic base plate 13104 of the speaker 13100 has a connection 13207 to one input of an oscillator circuit 13208 (detailed in FIG. 61). Another input to the oscillator circuit 13208 is connected to the drive connections 13205a and 13205b of the coil 13101 through blocking capacitors 13209a and 13209b, respectively. The output of oscillator circuit 13208 is connected to a frequency to voltage converter 13210, which converts the variable frequency received from the oscillator circuit 13208, and also amplifies and level shifts the varying voltage output. The output 13404 from the frequency to voltage converter 13210, which is a measure of C_{parasitic}(x) (abbreviated as Cₚ(x) in the Figure), and hence the position-indicator state variable, ƒ(x), is input into the mixed signal DSP controller 13202. Inside DSP 13202, both the analog output voltage from 13210 and the analog input audio signal 13201 are converted into digital signals, and combined by the DSP 13202 to yield the digital output 13211 of the DSP 13202. The purpose of the DSP functionality within the controller 13202 is to furnish the DAC 13203 with a digital signal such that the output of DAC 13203, after amplification by amplifier 13204, will feed the speaker-transducer voice coil with a voltage signal including both the audio program and a pre-distortion calculated to cancel out a significant portion of the nonlinearities introduced by the transducer in the course of its normal uncorrected operation. This effect of the position-sensor analog signal 13404 fed by frequency to voltage converter 13210 into the mixed signal controller 13202, is termed feedback linearization.

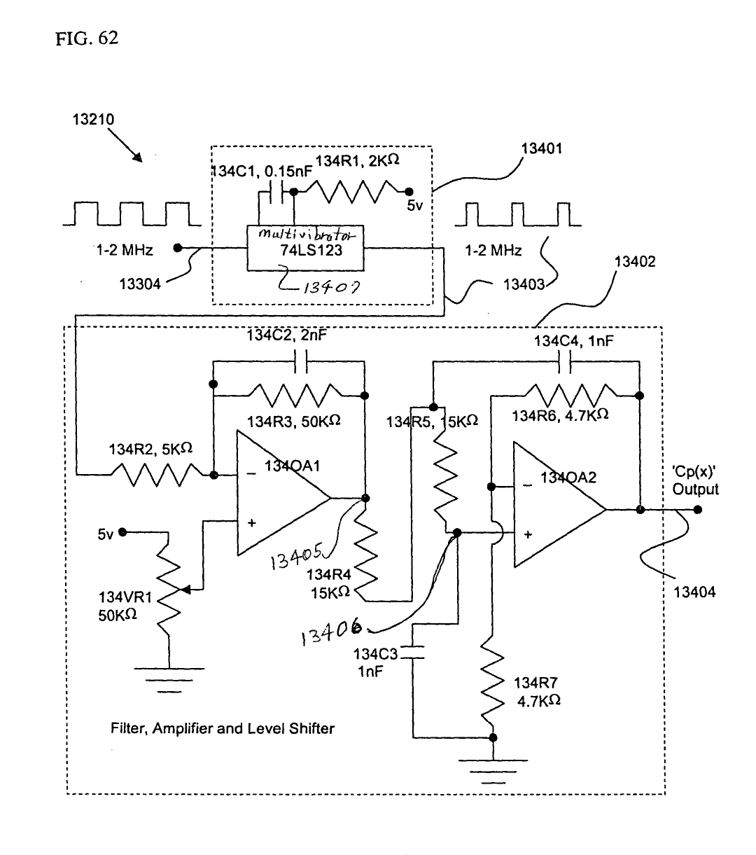

FIG. 61 shows the input from speaker 13100 and the detail of the oscillator circuit 13208. The audio amplifier drive signal connections 13205a and 13205b are decoupled using 60 pF capacitors 13209a and 13209b connected to the ground of the oscillator circuit 13208. The parasitic capacitance between the voice coil 13101 and the base plate 13104 is part of the R C oscillator created by the circuit, with the resistance values shown and an LF411 operational amplifier 13303 (available, for example, from National Semiconductor). The parasitic capacitance between the voice coil 13101 (FIG. 60) and the base plate 13104 is part of the R C oscillator created by the circuit, with the resistance values shown and an LF411 operational amplifier 13303 (available, for example, from National Semiconductor). The electrical connection to magnetic base plate is indicated by reference character 13207. The values of the variable parasitic capacitance Cₚ(x), denoted Cₚ in FIG. 60 and FIG. 62, typically ranges between 2 pF and 10 pF for the above-mentioned type of speaker, and thus the oscillator circuit must be physically close to the speaker to avoid the effects of environmental sources of further stray capacitance. Such further stray capacitance would reduce the sensitivity of the system. In an experimental implementation of the circuit, and for the Cₚ values discussed, the oscillator output signal (at terminal 13304) is a square wave of varying frequency between 1 MHz and 2 MHz.

FIG. 62 shows the detailed circuitry of the frequency to voltage converter 13210. Frequency to voltage converter 13210 consists of two parts: a frequency to pulse converter circuit 13401, and a low pass filter, amplifier and level shifter circuit 13402. The frequency to pulse converter 13401 consists of a mono-stable multivibrator circuit 13407 which includes an industry standard multivibrator which may be, for example, a 74LS123 as used in this embodiment. The mono-stable multivibrator circuit 13407 takes the square wave output signal 13304 received from the oscillator circuit 13208, which has a constant rms value, and converts it to a pulse train which is provided on line 13403. The pulse train 13403 has an rms value varying with frequency, which is a function of the transducer coil/core capacitance Cₚ, which in turn varies with coil/diaphragm position x. The low pass filter, amplifier and level shifter circuit 13402 converts the pulse train on line 13403 to a varying analog voltage output provided on line 13404. This varying analog voltage on line 13404 represents the varying capacitance Cₚ(x). The low pass filter, amplifier and level shifter circuit 13402 includes an operational amplifier 1340A1, which receives the output signal on line 13403 and, using a gain of 10 as determined by resistor values, low-pass-filters and offsets the signal 13403; and operational amplifier 1340A2, which has a gain of unity and implements a second-order Butterworth filter. These operational amplifiers may be embodied, for example, as National Semiconductor part number LM741, or equivalent. Resistor 134VR1 is adjusted such that the coil/diaphragm equilibrium position produces a zero output voltage. Operational amplifier 1340A2 receives, at its input terminal 13406, the output signal provided at output terminal 13405 of operational amplifier 1340A1, and then converts that signal to a voltage which is provided on line 13404 to mixed signal DSP 13202.

In operation, the capacitance dependent voltage output 13404 is also a position sensitive signal (since Cₚ depends on x). For the cell phone type of transducer, as well as for other transducers that have no significant cant (such as those of various tweeter speakers), the functional dependence Cₚ(x) is monotonic, and Cₚ can thus be used as a position-indicator nonlinear state variable in lieu of the position variable x itself in a feedback linearization control law.

It will be apparent to those skilled in the art that many methods are available for measuring the variation in capacitance C_{parasitic}(x). These methods will include the use of a counter over a sample time, in order to convert frequency from an oscillator directly to a digital number.

The particular position-indicator state variable ƒ(x) described in Detail 7 and in this section, which is derived from the internal parasitic capacitance C_{parasitic} between the transducer voice coil and the transducer magnetic pole structure, can be used with various embodiments of a feedback linearization control system according to the present invention, in which the positional information ƒ(x) is used in various different ways, including but not limited to one or more of the control laws presented in Details 2 and 10 above.

### Detailed Description 13

### IR Methods and Circuits

The present invention is described, in one aspect, in the context of controlling an audio reproduction system, in part by a system, consisting of methods and electronic circuits, which provide at least one position-indicator transducer state variable.

In particular the position-indicator state variable, ƒ(x), utilized in this embodiment of the invention is an output voltage from an optical IR-LED system, as discussed in Detail 8. This embodiment is called the IR method. In this section we elaborate on the methods and circuits used to implement the IR method.

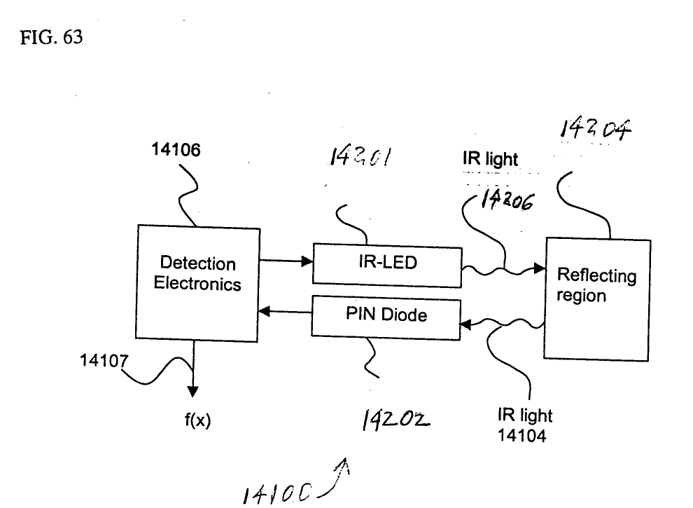

FIG. 63 shows an overall block diagram of a system 14100 for implementing the IR-LED method for detecting a position-indicator state variable. IR light 14206 is emitted by an IR-LED 14201. The IR light 14106 is scattered off a reflecting region 14204 on the back side of the transducer cone. The scattered IR light 14104 is detected by a PIN diode detector 14202. A detection circuit 14106 supplies current to the IR-LED 14201 and detects the photo-current flowing in the PIN diode 14202. The electronic circuit 14106 converts the photo-current flowing in the PIN diode 14202 to a positional signal, the present value of the position-indicator transducer state variable ƒ(x) 14107.

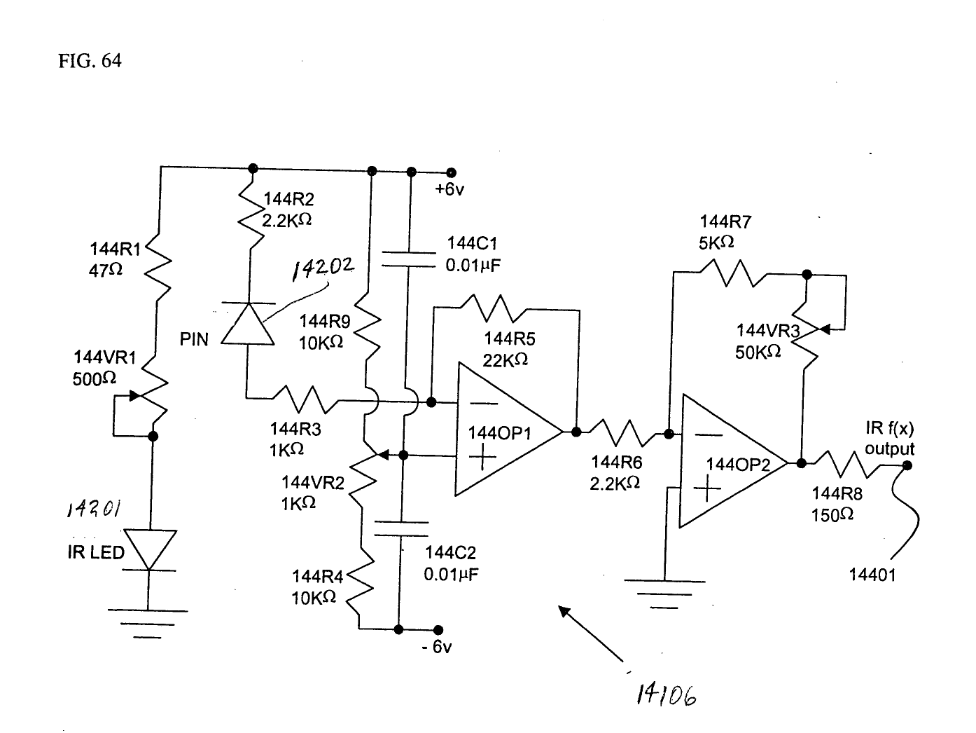

FIG. 64 shows an embodiment of the circuit schematic of IR-LED detection circuit 14106 of FIG. 63. The IR-LED 14201 and PIN diode 14202 are both connected into the circuit with a short (less than 1 meter) shielded cable (not shown) that extends from the circuit board which includes the remaining electronics to the frame 14203 of the transducer on which the IR-LED 14201 and PIN diode 14202 are supported. The IR-LED 14201 may be implemented by a SLI-0308CP purchased from Jameco Electronics in Belmont, Calif. and PIN diode 14202 may be implemented by a IRD500 purchased from Jameco Electronics in Belmont, Calif.

The detector configuration used in the IR-LED detection circuit 14106 is operated in the “reversed biased” mode of operation. In this mode the PIN diode 14202 is biased by an external direct voltage. In the present embodiment this voltage is 6 V, though it may be as high as 40 V to 60 V. When so biased, the PIN diode 14202 operates as a leaky diode, with the leakage current depending upon the intensity of the light striking the device's active area. When detecting infrared light near its 900 nm peak response wavelength, a silicon PIN diode of the type described above will typically leak nearly 1 mA of current per 2 mW of light striking it, which constitutes a high quantum efficiency. Low cost IR LEDs, of which the one mentioned above is an example, will produce sufficient power for this application. It should be noted that a PIN photodiode has both the speed and the sensitivity required for the position detection described herein, and is available at a low cost. PIN photodiodes exhibit response times that are typically measured in nanoseconds. Since we are interested in response times of the order of 10 microseconds or less, most PIN diodes will be useful for this purpose.

The IR-LED detection circuit 14106 is configured as a transimpedance amplifier. Resistor 144R5 which converts the PIN diode 14202 current into a voltage is connected from the output to the input of an inverting operational amplifier 144OP1. The amplifier 144OP1 thus acts as a buffer, and produces an output voltage proportional to the PIN diode current. The zero balance, meaning that the cone of the transducer is at the rest position, is set by a variable resistor 144VR2. The transimpedance amplifier 144OP1 is followed by another high gain amplifier 144OP2. A variable resistor 144VR3 is used to set the gain of the amplifier in order to match the input range of the A/D converter which receives the voltage ƒ(x), which in one embodiment was ±1.00 volt.

There are several steps and cautions for setting up the above-described detection circuit and in positioning the diodes.

The IR-LED 14201 and PIN diode 14202 are epoxied side-by-side onto the transducer frame 14203, with both diodes pointing at a reflecting region 14204 on the transducer cone 14205. Reflecting region 14204 should subtend a sufficient angle such that, as the transducer cone moves, the PIN diode 14202 detector admittance cone is always pointed within the region. The diodes are preferably inclined towards each other and pointed towards the axis of the transducer at approximately a right angle to the direction of motion, or towards the curve of the cone. As was noted in Detail 8 above, the PIN diode output is not completely linear with cone position and therefor requires calibration by comparison with a metrology system. The position-indicator variable, ƒ(x), and the degree of its non-linearity, can be varied by changing the positions and orientations of the two diodes relative to each other and to the transducer cone. Thus, there is some variation from one implementation to another and some adjustment by trial and error may be necessary.

The circuit 14400 is prone to saturation and interference from ambient light. Hence prior to operation the diodes must be shielded from external light, either by masking or by the speaker cabinet. All adjustable resistors in the circuit are put at the center of their resistive ranges. The circuit board is connected to the diodes with a shielded cable, and powered. The IR LED current resistor 144VR1 is adjusted until the output is approximately at ground potential.

During calibration, the transducer voice coil (not shown) is connected to a low power, low frequency AC source (for example, 20-60 kHz), and the power to the voice coil is adjusted to give maximal Peak-to-Peak motion, while avoiding excursions large enough to cause the cone to hit its encasement.

The following sequence of adjustments is iterated five to seven times, until the output waveform 14401 is about 90% of peak A/D limit:
(a) Increase IR-LED current by adjusting variable resistor 144VR1, and thus output power, until the magnitude of output signal 14401 is at the limit on one excursion;
(b) Adjust the balance by changing variable resistor 144VR2 until there is no output signal at terminal 14401;
(c) Adjust the gain of amplifier 1440P2 using variable resistor 144VR3 for desired peak-to-peak voltage corresponding to full motion of the transducer cone;
(d) Turn off the coil current, readjust the balance using variable resistor 144VR2, and zero the signal 14401 when the transducer cone is at the equilibrium point.

### Detailed Description 14

### IR Results

A DSP based controller using the control model described in Detail 2 above, was used to implement a linearizing filter which corrects for nonlinearities generated within the signal conditioning and transduction processes of a 3″ Audax speaker, with the result that the audio distortions caused by this transducer were significantly reduced.

Audio distortions were measured, both with and without the correction, by applying an industry-standard two-tone SMPTE test, with audio input consisting (instead of the CD player) of a 60 Hz tone in conjunction with a 3 kHz tone. All four corrections described in Detail 2 were applied by the DSP based controller: transducer correction (spring correction S and motor factor correction B), the BEMF correction, and the position dependent inductive correction.

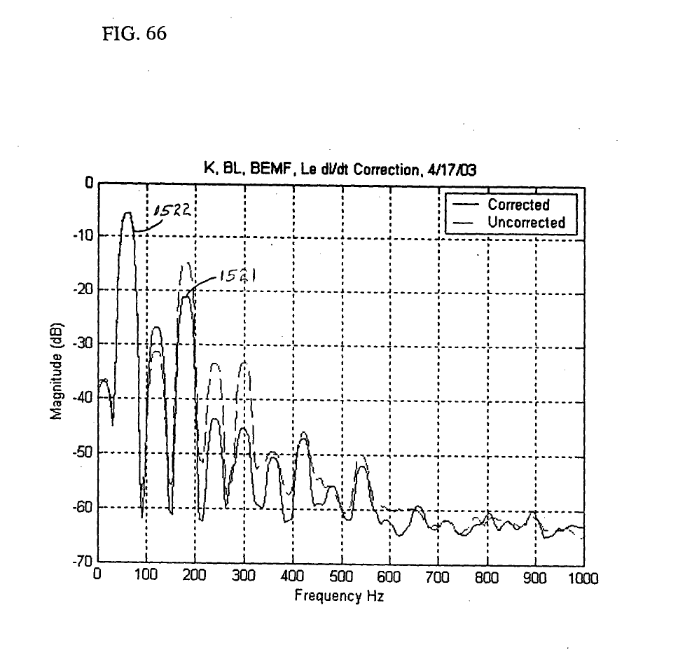

FIG. 65 shows a portion near 3 kHz of the FFT power spectrum distribution of the SPL (sound pressure level) wave-pattern picked up by a microphone in the acoustic near-field; both corrected spectra which is indicated by reference character 1521, and uncorrected spectra which is indicated by reference character 1522 are shown, and it is clearly seen that the powers in the 60 Hz-spaced lattice of intermodulaton frequency peaks, are significantly reduced when the correction is applied. FIG. 66 shows the low-frequency portion of the same power spectrum distribution, showing multiple harmonics of the 60 Hz tone; again, spectra are depicted both with and without correction, and again, significant reduction in the magnitude of the harmonic distortion peaks can be seen.

1. A process for characterizing a control-model parameter of a voice coil audio transducer, the process comprising:
applying to the voice coil drive voltages having a plurality of magnitudes;
generating data from measurements performed during the application of the drive voltages; and
converting the generated data into estimates of the functional dependence of the control-model parameter upon one or more position-indicator transducer generalized coordinates, where the generalized coordinates depend upon a position of a first portion of the transducer with respect to a second portion of the transducer.

2. A process for characterizing of a transducer-model parameter of a voice coil audio transducer, the process comprising:
applying to the voice coil drive voltages having a plurality of magnitudes;
generating data from measurements performed during the application of the drive voltages; and
converting the generated data into estimates of the functional dependence of the transducer-model parameter upon one or more position-indicator transducer generalized coordinates, where the generalized coordinates depend upon a position of a first portion of the transducer with respect to a second portion of the transducer.

3. A process for calibration of metrology-system measurements of a position of a first portion of a voice coil audio transducer with respect to a second portion of the voice coil audio transducer with respect to corresponding measurements of a co-varying position-indicator transducer generalized coordinate, the process comprising:
applying to the voice coil drive voltages having a plurality of magnitudes;
making first and second measurements for each of the applied drive voltages, wherein one measurement is made by the metrology system and the other measurement is of the position-indicator generalized coordinate;
generating data from the first and second measurements; and
converting the generated data into estimates of functional dependencies between the position-indicating generalized coordinate and a corresponding relative position value measured by the metrology system.

4. A process for calibrating large-signal transducer-model and control-model parameters of an audio transducer, the process comprising:
providing a first function encoding a dependence of a large-signal parameter upon a metrology-system measurement of a position of a first portion of the audio transducer with respect to a second portion of the audio transducer;
providing a second function encoding a metrology-system measurement of the position of the first portion of the audio transducer with respect to the second portion of the audio transducer as a function of a position-indicator transducer generalized coordinate; and
deriving from the first and second functions a calibration of the large-signal parameter against the position-indicator generalized coordinate.

5. A process for detection and estimation of a canting of a voice coil of an audio transducer, the process comprising:
applying to the voice coil drive voltages having a plurality of magnitudes;
generating data comprising estimates of a capacitance between the voice coil and an associated metallic structure, and measuring values of one or more transducer generalized coordinates which vary with a position of a first portion of the audio transducer with respect to a second portion of the audio transducer for a plurality of drive voltages applied to the voice coil;
detecting if a non-monotonicity occurs in the dependence of the capacitance upon a drive value; and
using a physical transducer model, in conjunction with the generated data, to estimate the canting.

6. A process for calibrating an external infrared optical position-indicating detector device for an audio transducer having a diaphragm, the process comprising:
illuminating a region of the diaphragm with infrared light;
detecting and measuring a portion of the infrared light scattered from the diaphragm;
converting the detected infrared light into a signal; and
calibrating the value of the signal as a function of a position of the diaphragm with respect to another portion of the audio transducer.

7. A process for generating polynomials encoding the approximate interpolated functional dependencies of large signal transducer-model and control-model parameters upon position-indicator generalized coordinates for an audio transducer having a voice coil, the process comprising:
providing data generated in one or more voice-coil drive sweeps; and
converting the data into said polynomials, where the independent variables of each polynomial are generalized coordinates which vary with a position of a first portion of the audio transducer with respect to a second portion of the audio transducer.

8. A process for characterization of a control-model parameter of a voice coil driven audio transducer, where the parameter is a ratio of a restoring force acting on a transducer element of the voice coil audio transducer with respect to a motor factor of the voice coil, the process comprising:
applying to the voice coil drive voltages having a plurality of magnitudes;
generating data from measurements performed during the application of the drive voltages; and
converting the generated data into estimates of the functional dependence of the control-model parameter upon one or more position-indicator transducer generalized coordinates, where the generalized coordinates depend upon a position of a first portion of the transducer with respect to a second portion of the transducer.

9. A process for calibrating a spring factor of an actuator, the process comprising:
applying a drive voltage having a first magnitude to the actuator;
determining a value of a parameter which is indicative of a position of the actuator after application of the voltage of the first magnitude;
applying a drive voltage of a second, different magnitude to the actuator;
determining a value of a parameter which is indicative of a position of the actuator after application of the voltage of the second, different magnitude.

10. The process according to claim 9, further comprising:
generating a table of values of applied voltages and corresponding parameter values.

11. The process according to claim 9, wherein determining a value of a parameter comprises determining an impedance value of a circuit parameter of the actuator.

12. The process according to claim 11, wherein the impedance measured is an impedance of a coil associated with the actuator.

13. The process according to claim 9, wherein determining a value of a parameter indicative of a position of the actuator comprises measuring a capacitance value of a movable portion of the actuator with respect to an associated stationary portion of the actuator.

14. The process according to claim 9, wherein determining a value of a parameter indicative of a position of the actuator comprises determining a position of the actuator optically.

15. The process according to claim 14, wherein determining a position of the actuator optically comprises using an infrared light.

16. The process according to claim 9, further comprising:
creating a curve which is fitted based on the parameter values.

17. The process according to claim 9, further comprising:
polynomial fitting the values to provide a formula.

18. The process according to claim 9, further comprising:
creating a polynomial spline using the values.

19. A process for calibrating a spring factor of an actuator, the process comprising:
applying a plurality of individual drive voltages to the actuator; and
determining for each of the individual drive voltages a value of a parameter which is indicative of a position of the actuator.

20. The process of claim 19, wherein applying a plurality of individual drive voltages comprises applying a stair-step voltage waveform to the actuator.

21. The process according to claim 19, further comprising generating a table of values of applied voltages and associated parameter values.

22. The process according to claim 19, wherein determining a value of a parameter comprises determining an impedance value of a circuit parameter of the actuator.

23. The process according to claim 22, wherein the impedance measured is an impedance of a coil associated with the actuator.

24. The process according to claim 19, wherein determining a value of a parameter indicative of a position of the actuator comprises:
measuring a capacitance value of a movable portion of the actuator with respect to an associated portion of the actuator.

25. The process according to claim 9, wherein determining a value of a parameter indicative of a position of the actuator comprises determining a position of the actuator optically.

26. The process according to claim 25, wherein determining a position of the actuator optically comprises using an infrared light.

27. The process according to claim 19, further comprising creating a curve which is fitted based on the parameter values.

28. The process according to claim 19, further comprising:
polynomial fitting the parameter values to provide a formula.

29. The process according to claim 19, further comprising:
creating a polynomial spline based on the parameter values.

30. A process for calibrating a motor factor of an actuator, the process comprising:
applying an alternating current signal having a frequency to the actuator;
simultaneously applying a direct current signal having a first magnitude to the actuator;
determining a value of a parameter which is indicative of a position of the actuator;
measuring a response of the actuator;
simultaneously applying to the actuator a direct current signal having a different magnitude, and an alternating current signal;
determining a value of a parameter which is indicative of a position of the actuator; and
measuring a response of the actuator.

31. A process for calibrating a motor factor of an actuator, the process comprising:
generating a polynomial fit of the motor factor function for a range of movement of the actuator;
generating a ratio function of the motor factor of a rest position of the actuator and at a plurality of other positions of the actuator;
generating a polynomial fit of the results of the ratio function; applying a plurality of voltages of differing magnitudes to the actuator;
determining for each of the voltages a value of a parameter which is indicative of a position of the actuator, and simultaneously measuring a position of the actuator.
